(19) United States
(12) Patent Application Publication
(10) Pub. No.: US 2009/0232977 A1
(43) Pub. Date: Sep. 17, 2009

(54) Optical Film Treating Method, Optical Film Treating Apparatus, and Optical Film Producing Method

(75) Inventors: Yoshiaki Morinaga, Shizuoka (JP); Takeshi Tanaka, Hyogo (JP); Koji Nakashima, Hyogo (JP); Takanobu Komura, Hyogo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MONOLTA OPTO, INC., Hachioji-shi, Tokyo (JP)

(21) Appl. No.: 12/085,098

(22) PCT Filed: Nov. 8, 2006
(86) PCT No.: PCT/JP2006/322230

§ 371 Date: May 15, 2008

(30) Foreign Application Priority Data
Nov. 21, 2005 (JP) 2005-335856

(51) Int. Cl. C08J 7/02; B08B 1/02; G02B 1/10; G02B 1/11; C08J 7/04; B08B 3/04; B08B 5/00; B08B 7/04

(52) U.S. Cl. 427/162; 134/9; 15/302; 15/303; 15/306.1; 15/308

(57) ABSTRACT

A method of optical-film treatment in which coating troubles apt to occur in the formation of a functional layer, e.g., an antireflection layer, on a continuous film by coating fluid application, such as transverse thickness-difference lines, coating streaks, and tailing, are diminished. The method of optical-film treatment comprises wetting with a liquid a continuous film which is being continuously conveyed, continuously rubbing the continuous film with an elastomer, and then removing the liquid from the continuous-film surface, and is characterized in that the surface of the elastomer has a coefficient of static friction of 0.2-0.9.

### TECHNICAL FIELD

The present invention relates to an optical film treating method, an optical film treating apparatus and an optical film producing method in which coating failures such as a transversely-streaked unevenness, a coating streak, and a trailing unevenness, being apt to take place easily at the time of coating a functional layer such as an antireflection layer on a lengthy film can be improved, in particular, relates to an optical film treating method, an optical film treating apparatus and an optical film producing method capable of improving the transversely-streaked unevenness.

### BACKGROUND ART

In recent years, the development of a thin and light notebook type personal computer and a thin and large screen type TV has progressed. With this progress, a protection film of a polarizing plate for use in display unit such as a liquid crystal display has been required more strongly to be thinner, larger and higher functional. Moreover, liquid crystal image display devices (liquid crystal display etc.), such as a computer and a word processor, which have an optical film provided with an antireflection layer to increase visibility and an antiglare layer to scatter reflected light with convexo-concave formed on its surface, have been used widely.

An antireflection layer have been improved in terms of various kinds or performance in accordance with usage, and there has been employed a method of providing an antireflection function to a display in order to improve visibility by pasting various front plates having these functions to a polarizer of a liquid crystal display. (For example, refer to Patent Document 1) An optical film used as these front plates is provided in many cases with an antireflection layer formed by coating, vacuum deposition, or a sputtering technique.

Moreover, in order to make a display unit thin more, the thickness of a film to be used has been also required to be thin more, or in order to make a screen large more, the width of an optical film has been required to be wide more. Especially, although an optical film excellent in flatness has been required for a large screen, the film excellent in flatness has not been obtained in a conventional film, in particular, having a wide width and a thin thickness. Further, in a film having a wide area, a film having a sufficient scratch resistance has not been obtained.

Further, when a metal oxide layer is coated as an antireflection layer, since coating nonuniformity tends to easily take place, the improvement for this has been required. Especially, when the width of a base film becomes wide of 1.4 m or more, the coating nonuniformity tends to extremely easily take place. Therefore, the improvement of the coating nonuniformity, such as a transversely-streaked unevenness, a coating streak, and a trailing unevenness has been required.

Conventionally, in order to improve a point defect resulting from foreign matters, it has been known to conduct a wet type dust removing treatment to a film surface. (For example, refer to Patent Documents 2 to 4.) However, although the point defect resulting from foreign matters may be improved to some extent by such a dust removing treatment, it is not enough. Moreover, these patent documents do not teach about the problem of the transversely streaked unevenness and about the improving technique for it.

[Patent document 1] Japanese Patent Unexamined Publication No. 2002-182005

[Patent document 2] Japanese Patent Unexamined Publication No. 8-89920

[Patent document 3] Japanese Patent Unexamined Publication No. 2001-38306

[Patent document 4] Japanese Patent Unexamined Publication No. 2003-255136

### DISCLOSURE OF THE INVENTION

### Problem to be Solved by the Invention

An object of the present invention is to provide an optical film treating method, an optical film treating apparatus, and an optical film producing method, in which coating failures such as a transversely streaked unevenness, a coating streak, and a trailing unevenness, being apt to easily take place at the time of coating a functional layer such as an antireflection layer on a lengthy film can be improved.

### Means for Solving the Problem

The above-mentioned object of the present invention can be attained by the following structures.

1. In an optical film treating method of removing liquid on a surface of a lengthy film after wetting the lengthy film being conveyed continuously with liquid and rubbing this lengthy film with an elastic member continuously, the optical film treating method characterized in that the static friction coefficients of the surface of this elastic member is 0.2 or more and 0.9 or less.
2. The optical film treating method described in 1 is characterized in that the above-mentioned elastic member is a surface modified rubber.
3. The optical film treating method described in 1 or 2 is characterized in that the above-mentioned surface modified rubber is a rubber whose surface is subjected to an organic halogen compound treatment.
4. The optical film treating method described in any one of 1 to 3 is characterized in that the above-mentioned elastic member is a rotating rubber roller.
5. The optical film treating method described in any one of 1 to 4 is characterized in that the contact angle of the above-mentioned rubber roller with the lengthy film is 1° or more and less than 135°.
6. The optical film treating method described in any one of 1 to 5 is characterized in that the time period of the above-mentioned lengthy film rubbed with the above-mentioned elastic member is 0.05 seconds or more and 3 seconds or less.
7. The optical film treating method described in any one of 1 to 6 is characterized in that the surface pressure of the above-mentioned lengthy film rubbed with the above-mentioned elastic member is 500 N/m² or more and 5000 N/m² or less.
8. The optical film treating method described in 1 is characterized by comprising a process of removing liquid adhering to the surface of above-mentioned elastic member.
9. The optical film treating method described in 1 is characterized by comprising a process of detecting widthwise end positions of the above-mentioned lengthy film and adjusting a conveyance position.
10. The optical film treating method described in 1 is characterized in that when the above-mentioned lengthy film is rubbed with the above-mentioned elastic member, the above-mentioned lengthy film is rubbed with the above-mentioned elastic member continuously while air is being sent to the back of the lengthy film.
11. The optical film treating method described in 1 is characterized in that the processed surface of the above-mentioned lengthy film is wet by a means for supplying a liquid to the processed surface of the above-mentioned lengthy film.
12. The optical film treating method described in 11 is characterized in that the means for supplying a liquid is a spray nozzle.
13. The optical film treating method described in 12 is characterized in that the average diameter of droplets when the liquid supplied from the above-mentioned spray nozzle adheres to the above-mentioned lengthy film is 10 μm or more and 5000 μm or less.
14. The optical film treating method described in any of 11 to 13 is characterized in that the amount of the liquid supplied to the above-mentioned lengthy film is 3 g/m² or more and 100 g/m² or less.
15. The optical film treating method described in any of 11 to 14 is characterized in that the temperature of the above-mentioned liquid is 30° C. or more and 100° C. or less and the temperature of the above-mentioned elastic member is 30° C. or more and 100° C. or less.
16. The optical film treating method described in any of 11 to 14 is characterized in that the above-mentioned lengthy film is a cellulose ester film and the above-mentioned liquid is water.
17. An optical film producing method is characterized in that after the lengthy film has been processed with the optical film treating method described in any of 1 to 16, the processed surface of the lengthy film is provided with an optical functional layer.
18. The optical film producing method described in 18 is characterized in that the above-mentioned optical function layer is a hard coat layer or an antireflection layer.
19. The optical film producing method described in 17 or 18 is characterized in that the above-mentioned cellulose ester film contains a mat agent, the above-mentioned hard coat layer is formed by a process of coating a hard coat layer coating fluid containing an acrylate type ultraviolet curable resin and an organic solvent, and at least one layer of the above-mentioned antireflection layer is formed by a process of coating an antireflection layer coating fluid containing a low surface tension substance and an organic solvent.
20. In an optical film treating apparatus comprising a liquid supplying means for wetting a lengthy film being conveyed continuously with liquid; an elastic member rubbing means for rubbing this lengthy film with an elastic member; an elastic member surface liquid removing means for removing liquid from the surface of this elastic member, and a liquid removing means for removing liquid on the surface of the lengthy film after rubbing; the optical film treating apparatus is characterized in that the static friction coefficients of the surface of this elastic member is 0.2 or more and 0.9 or less.
21. The optical film treating apparatus described in 20 is characterized by comprising a means for detecting widthwise end positions of above-mentioned lengthy film and adjusting a conveyance position.
22. The optical film treating apparatus described in 20 is characterized by comprising a liquid temperature control means for controlling temperature of the above-mentioned liquid is 30° C. or more and 100° C. or less.
23. The optical film treating apparatus described in 20 is characterized by comprising a means for sending air to the back of above-mentioned lengthy film.
24. The optical film treating apparatus described in 20 is characterized in that the means for wetting the film is a means for supplying liquid onto a processed surface of above-mentioned lengthy film.
25. The optical film treating apparatus described in 20 is characterized in that the means for removing liquid is formed by a suction nozzle and an air nozzle.
26. The optical film treating apparatus described in 20 is characterized in that a processing time period from the means for supplying liquid and the means for removing liquid is 2 seconds or more and 60 seconds or less.

### EFFECT OF THE INVENTION

According to the present invention, it is possible to provide an optical film treating method and an optical film treating apparatus in which coating failures such as a transversely streaked unevenness, a coating streak, and a trailing unevenness, being apt to easily take place at the time of coating a functional layer such as an antireflection layer on a lengthy film can be improved, especially it is characterized in that the transversely streaked unevenness can be improved.

### BRIEF DESCRIPTION OF THE DRAWING

FIG. 1 is a schematic diagram showing an entire view of an apparatus for rubbing with an elastic body a lengthy film of the present invention whose one side surface is wetted with liquid.

FIG. 2 is a schematic diagram showing an entire view of another apparatus according to the invention.

FIG. 3 is a schematic diagram showing an entire view of another apparatus according to the invention.

FIG. 4 is a schematic diagram showing an entire view of another apparatus according to the invention.

FIG. 5 is a schematic diagram showing an entire view of another apparatus according to the invention.

FIG. 6 is a schematic diagram showing an entire view of another apparatus according to the invention.

FIG. 7 is a schematic diagram showing an installing position of an air nozzle and an air blowing direction.

FIG. 8 is a outlined diagram showing a spray nozzle usable preferably in the present invention.

FIG. 9 is a schematic diagram showing liquid droplet and the size of the liquid droplet.

FIG. 10 is an example of a method of measuring the static friction coefficient of the elastic member according to the present invention.

FIG. 11 is a method of measuring a flow rate distribution of a plurality of nozzles.

FIG. 12 is a schematic diagram of a dip type device used in Example.

FIG. 13 is a schematic diagram of a comparative device used in Example.

### EXPLANATION OF REFERENCE SYMBOL

F Lengthy film
1 Elastic member
2, 2′, 2″ Guide roller
3 Liquid tank
3′ Overflow tank
4 Liquid
5 Air nozzle
6 Air nozzle
7 Suction nozzle
8 Spray nozzle
9 Air nozzle
10 Ultrasonic vibrator
11 Ultraviolet ray irradiating equipment
12 Filter
13 Pressure Feed Pump
14 Nozzle
15 Pipe
16 Baffle plate
17 Dip Tank
18 Coating device

### BEST MODE FOR CARRYING OUT THE INVENTION

Hereinafter, the best modes for carrying out the invention will be explained, however, the present invention is not limited to these.

As a result that the inventor has studied intently in view of the above problems, the inventor found to be able to obtain the following surprising effects by the following optical film treating method and came to accomplish the present invention. Namely, in an optical film treating method of removing liquid on a surface of a lengthy film after wetting the lengthy film being conveyed continuously with liquid and rubbing this lengthy film with an elastic member continuously, the optical film treating method characterized in that the static friction coefficients of the surface of this elastic member is 0.2 or more and 0.9 or less, whereby coating failures such as a transversely streaked unevenness and a coating streak, being apt to easily take place at the time of coating a functional layer such as an antireflection layer on a lengthy film can be improved. The inventor found that by conducting processes of wetting a lengthy film with liquid, rubbing the lengthy film continuously with an elastic member, and thereafter, removing the liquid adhering on the surface of the lengthy film; wrinkle, fray and distortion on this lengthy film can be corrected, as a result, the flatness of this lengthy film can be improved and the coating failures at the time of coating functional layers such as an antireflection layer through a hard coat layer etc can be improved.

Hereinafter, the present invention will be explained in detail.

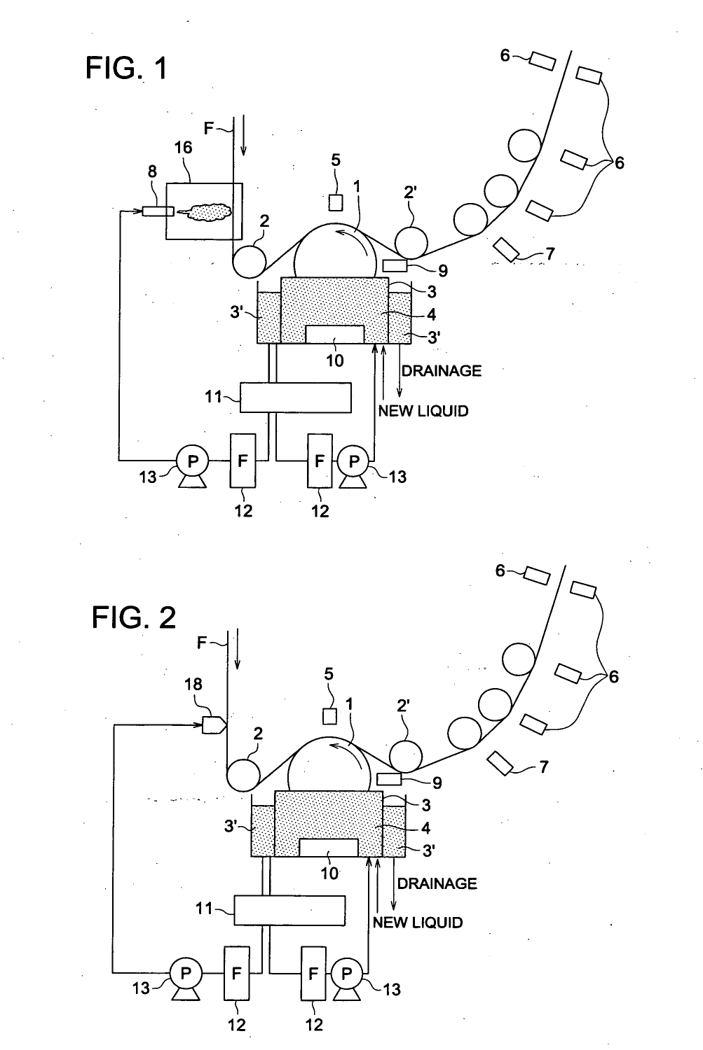

The processing method and processing apparatus of an optical film according to the present invention will be explained with reference to FIGS. 1 to 11. However, the present invention is not limited only to these exemplified structures.

FIG. 1 is a mimetic diagram showing the whole equipment against for rubbing one surface of the lengthy film conveyed continuously with an elastic member of the present invention. Lengthy film F is guided by a guide roller 2 on the condition where the surface of the lengthy film F to be processed is wetted by being sprayed with liquid beforehand by a spray nozzle 8, and then the lengthy film F is rubbed with an elastic member 1 (elastic member roller) being driven. The elastic member 1 being driven is always washed with liquid 4 stored in a liquid tank 3, and the liquid adhered on the elastic member 1 is removed by an air nozzle 9. After the lengthy film F is rubbed with the elastic member 1, the lengthy film F is conveyed by a guide roller 2′, and liquid adhered on the lengthy film F is withdrawn and removed by a suction nozzle 7. Furthermore, the lengthy film F is sprayed with air by an air nozzle 6 such that excessive liquid and foreign matters are removed.

An air nozzle 5 is arranged at the opposite side of the elastic member 1 and sprays air to the back side of the film so as to prevent liquid from adhering on the back side of the film. Moreover, the air nozzle 5 can control the degree of pressure contact of the lengthy film onto the elastic member by adjusting air pressure, and the air nozzle 5 can make the lengthy film to be rubbed continuously with the above-mentioned elastic member while pressing the back side of the lengthy film by adjusting air pressure as mentioned later. Although the above-mentioned air nozzle 5 or a back roll etc. may be used as the above-mentioned pressing means, it is desirable to use the air nozzle 5 from the additional effect which prevents liquid from adhering on the back side of the film, as mentioned above. Subsequently, the lengthy film is conveyed to a dryer (not shown) in which both sides of the film are dried, and then the lengthy film is further conveyed to a coating process of a functional layer as a next step.

A guide roller 2 and 2′ guide the passage of the lengthy film F. Here, although each of guide rollers 2 and 2′ is arranged in a predetermined position respectively, the important matter at this time is that these rollers are arranged such that the lengthy film F may be brought in contact with the elastic member 1 with a desired lap angle as mentioned later.

The elastic member 1 is arranged between the guide roller 2 and the guide roller 21, and rotates by being driven by a motor which is not illustrated. The lower part of this elastic member 1 is immersed in liquid 4 in the liquid tank 3. The lengthy film F is continuously rubbed with this rotating elastic member 1, whereby wrinkle, fray, and distortion on its surface are corrected.

Here, it is desirable that the lower part of the elastic member 1 is immersed in the liquid 4, and the peripheral surface of the elastic member 1 is immersed in the liquid 4 with its rotation, thereby cleaning foreign matters which adhere to the peripheral surface when the elastic member 1 rubs the surface of the lengthy film. At this time, in the lower part of the elastic member, in order to remove soil and adhering matters on the peripheral surface of the elastic member, the elastic member can be cleaned by being rubbed with a blade, a brush, a non-woven fabric, and so on, or by the use of a ultrasonic vibrator 10 showing in the figure. In the present invention, it is desirable to use the ultrasonic vibrator, because the soil of the elastic member 1 and adhering foreign matters are effectively removable. This ultrasonic vibrator 10 emits supersonic waves to the surface of the elastic member 1 and removes foreign matters transferring onto the surface of the elastic member 1. Here, in order to transmit the emitted supersonic waves efficiently to the surface of the elastic member 1, the ultrasonic vibrator 10 is arranged so that liquid 4 is held between the elastic members 1 and the ultrasonic vibrator 10. Moreover, plural oscillators may be provided, and in this case, it is necessary to determine an interval between ultrasonic vibrators such that an overlap of supersonic waves between neighboring ultrasonic vibrators may become uniform. The ultrasonic vibrator 10 may be used with a frequency within a range of 10 to 100000 kHz. Moreover, plural oscillators which oscillate respective different frequencies can be used in combination, or an oscillator capable of modulating frequency may be also used.

The ultrasonic output per unit area of an oscillator may be 0.1 W/cm² to 2 W/cm². There is an optimal point in the distance from the ultrasonic vibrator 10 to the elastic member 1 from the existence of a stationary wave. Therefore, it is desirable to use a distance of an integral multiple of the value obtained by the following formula.

λ=C/f

Here, λ represents wavelength, C represents a ultrasonic wave propagation velocity, and f represents frequency.

The time period of ultrasonic wave processing is preferably within a range of 1 to 100 seconds, 10 to 100000 kHz, especially preferably 40 to 1500 kHz.

Examples of usable ultrasonic vibrators, include WS-600-28N, WS-600-40N and WS600-75N, WS-600-100N, WS-1200-28N, WS-1200-40N, WS-1200-75N, WS-1200-100N, N60 R-M, N30 R-M, N60 R-M, W-100-HFMKIIN, W-200-HFMKIIN, produced by Honda Electronics Co., Ltd., and one produced by Japanese Alex Co., Ltd.

After the elastic member 1 is immersed in liquid 4, the elastic member 1 is pulled up from the liquid 4 by its rotation, and then liquid adhering to the elastic member surface is removed. Although the removing may be made by scraping with a nonwoven fabric or a blade as a removing means, it may be made especially preferably by scraping with an air nozzle.

In FIG. 1, liquid adhering to the elastic member 1 is removed by the air nozzle 9. It is desirable to remove the liquid with the removing ratio of 80 to 100%, and more preferably 90 to 100%.

Removing ratio=(quantity of liquid removed from the elastic member surface/quantity of liquid which has adhered to the elastic member surface before the removing)×100

Commercial equipment can be used for the air nozzle and the suction nozzle mentioned above. For example, MX series, DX-DY series, DZ-DLZ series, DN-DM series, DL-DLX series, CX-CLX series, LDN-LDLX series, DV series, bow nozzle, RS series, RD series, D series, and NM series, produced by Daihiro Kennetsu Company Ltd.; 50750 series, and SJA series, produced by Spraying System Japan Company Ltd., may be employed.

Although an example of the desirable attachment specification of an air nozzle and a suction nozzle is shown below, it is not limited to this example.

### <Air Nozzle>

Slit width: 0.8 mm (preferably within a range of 0.2 to 2 mm)

Slit length: 1600 mm (based on a film width)

Blowing wind velocity: 100 m/sec (preferably within a range of 50 to 300 m/sec)

Distance to a film: 3 mm (preferably within a range of 2 to 10 mm)

### <Suction Nozzle>

Slit width: 2 mm (preferably within a range of 0.2 to 4 mm)

Slit length: 1600 mm (based on a film width)

Suctioning wind velocity: 50 m/sec (preferably within a range of 20 to 150 m/sec)

Distance to a film: 3 mm (preferably within a range of 2 to 10 mm)

FIGS. 2 to 6 are schematic diagrams showing the whole view of another apparatus according to the present invention.

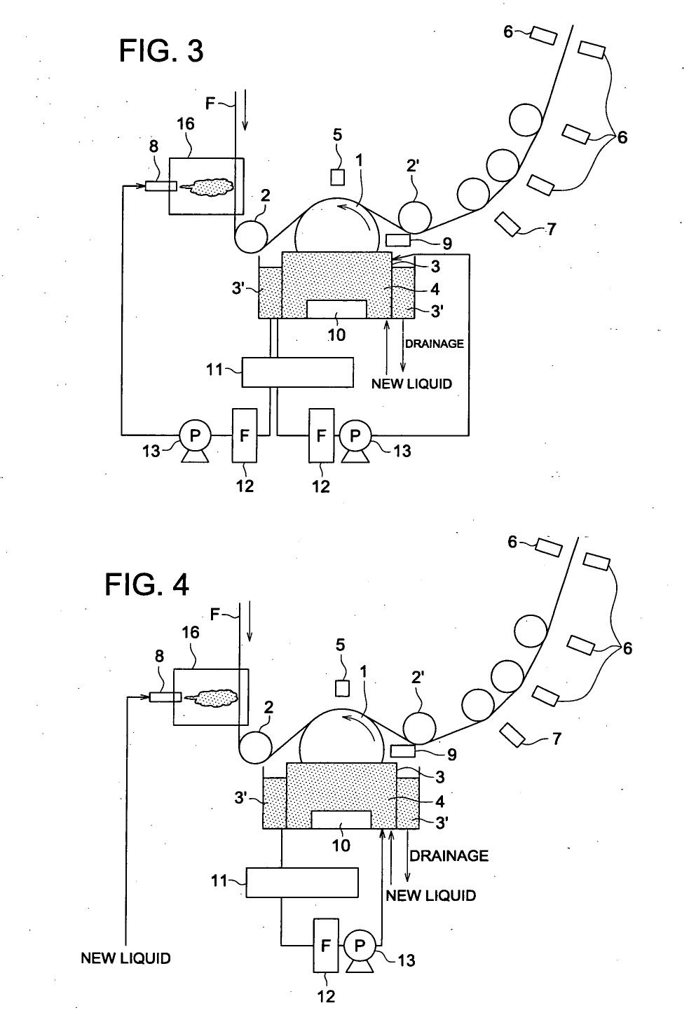

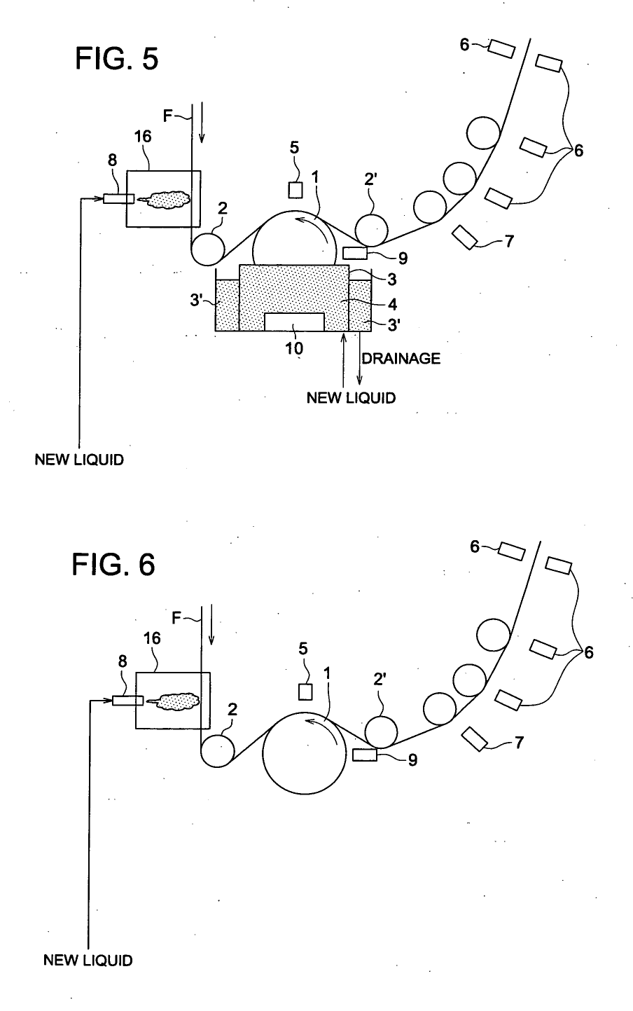

FIG. 2 shows an example in which a coating device 18 is used instead of the air nozzle 8, FIG. 3 shows an example in which liquid filtered with a filter is returned from an upper part of the liquid tank 3, FIG. 4 shows an example in which the liquid supply to the air nozzle 8 is conducted with new liquid, FIG. 5 shows an example in which the liquid tank 3 is supplied with only new liquid and is not circulated, and FIG. 6 shows an example in which the elastic member 1 is not washed in the liquid tank 3 and only adhering droplets are flown away by an air nozzle 9.

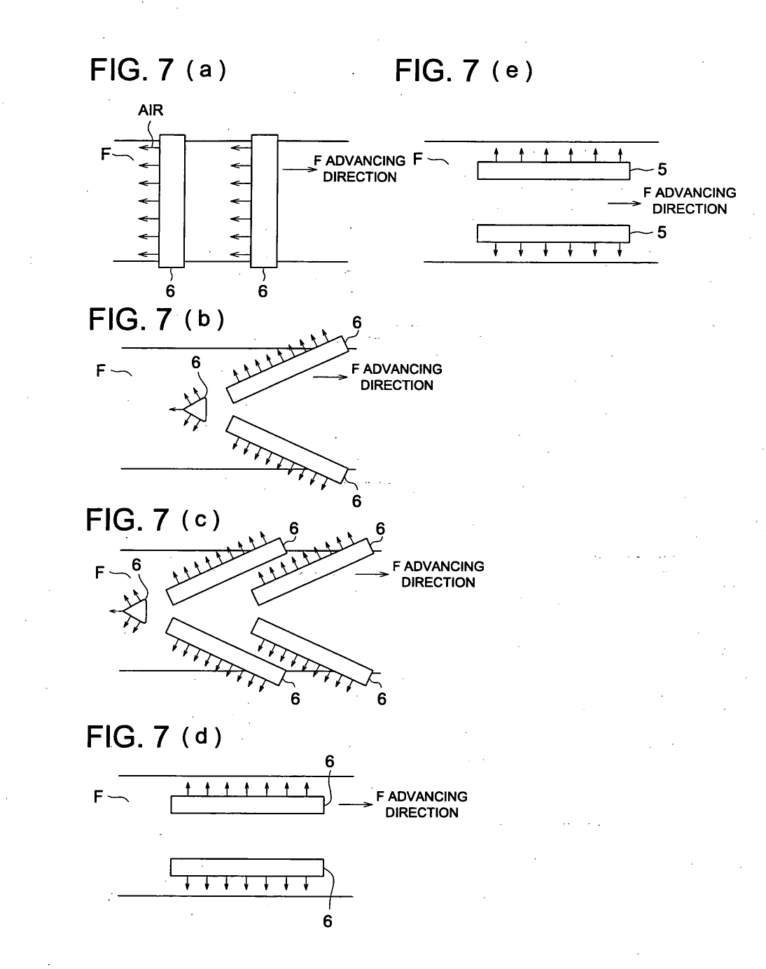

FIGS. 7(a) to 7(e) are schematic diagrams showing the installation locations of air nozzle 5 or 6 and the blow-off direction of air. FIG. 7 (a) shows the situation that air is sprayed in the direction to counter the film advancing direction, and FIG. 7 (b) and FIG. 7 (c) show the situations that air is sprayed toward the film outside. FIG. 7 (d) and FIG. 7 (e) show the situations which are suitable mainly for air nozzles 5 and 6 installed at the opposite side to the processed surface of the film and have the high effect to prevent liquid from proceeding to the back side of the film.

In the present invention, in order to rub a film with an elastic member on the condition that the surface of the film to be treated is made wet, there is provided a liquid supply means to supply liquid to the film surface before the film arrives at the position of the elastic member 1. As the liquid supply means, a coating device such as a gravure coater, a wire burr, a slit-die coater, and a dip coater or and ink-jet device may be used, however, it is also possible to use a spray nozzle. Preferably, the supply by the spray nozzle may be desirable.

In the case that pure water is used as the liquid, when the pure water is supplied to a film with a coating device, such as a gravure coater, a wire burr, a slit-die coater, and a dip coater, the pure water on the film becomes a big droplet immediately after the pure water is supplied, and the pure water falls down from the film during conveyance. On the other hand, when the pure water is supplied to the film by a spray nozzle, the pure water on the film becomes fine droplets, and does not fall down from the film during conveyance.

In the present invention, it is indispensable that only the surface of the film to be processed is wetted previously before being rubbed with an elastic member. As shown in FIG. 1, a spray nozzle 8 is arranged as the liquid supply mans before a guide roller 2. Liquid stored in an overflow tank 3′ is sterilized with a ultraviolet sterilizer 11 connected with a pipe, is filtered with a filter 12, and then spayed by a nozzle 8 through a pressure feed pump 13 so that the surface of the film to be processed can be wetted beforehand. The filter used here can be chooses suitably, and a filter with a pore size of 0.1 to 10 μm may be used independently or in combination suitably. Moreover, a pleat insertion type cartridge filter can be selected advantageously from view points of a filtering life and the easiness in handling.

Moreover, it is necessary to set up a filtration circulating flowing quantity such that the number of foreign matters in a liquid tank does not increase with the elapse time with foreign matters carried into the tank from a film surface. The quantification of the number of foreign matters floating in the liquid can be made by the use of HIAC/ROYCO liquid particle counter model 4100 manufactured by Nozaki & Co., Ltd, and the fractional size of a filter and a circulating flowing quantity for the filter can be adjusted such that particles having a size to be removed do not increase with operating hours. Moreover, it is desirable to replace the liquid in the liquid tank with new liquid by 0.1 to 10 times per hour in order to suppress the increase in the number of foreign matters.

As the spray nozzle 8, one set of a bar-shaped one having a length corresponding to the width of a film may be used, or plural sets of a bar-shaped one having shorter length may be used. Although the aperture diameter of a nozzle does not have any restriction specifically, it may be desirably about 05 mm to 2 mm, and a feeding quantity of liquid may be within a range of 0.1 l/minutes to 10 l/minutes. When two or more spray nozzles are used, it is desirable to adjust the two or more spray nozzles such that flow rate distribution may become uniform in a width direction, and it is desirable that flow rate dispersion of the liquid having passed each spray nozzle in the range of the above-mentioned feeding amount of liquid is made within a range of ±1% or less.

In the present invention, usable kinds of spray nozzle, include without any restriction in particular, well-known spray nozzles, such as a flat spray nozzle, a solid spray nozzle, a full cone spray nozzle, a hollow cone spray nozzle, and also a two-phase flow spray nozzle.

As the spray nozzle, commercially available spray nozzles, for example, Vee Jet, Uni Jet, Flood Jet, 1/8J1/4J series, and 1/4JAU series manufactured by Splaying System Japan Company Ltd., VE*VEP series manufactured by Ikeuchi Company Ltd, may be usable.

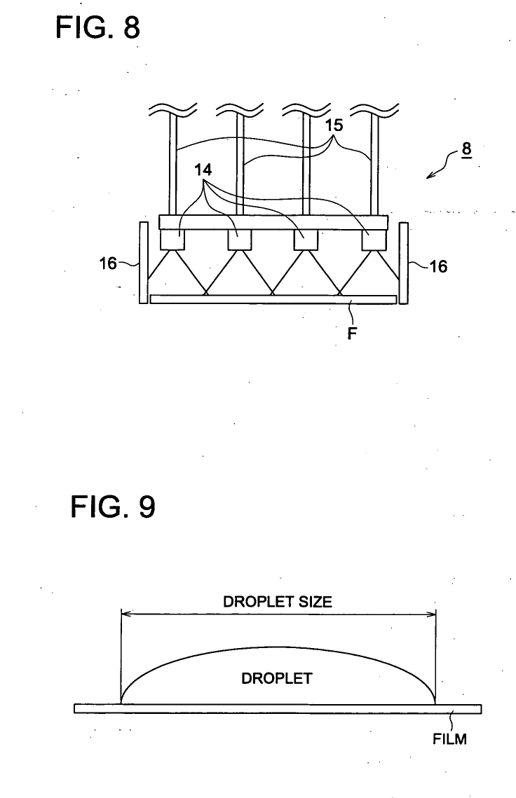

FIG. 8 shows a schematic diagram of a spray nozzle device preferably used in the present invention. This figure shows an example and the present invention is not restricted to this example.

A spray nozzle 8 has two or more nozzles 14 in the width direction of a film F, and liquid 4 drawn out through a pipe 15 from above-mentioned overflow tub 3′ is supplied and sprayed. It is desirable to provide a baffle plate 16 such that the sprayed liquid may not proceed to the back of a film. It is possible to adjust suitably an amount of liquid adhering to the surface of a film to be processed. In this case, the amount of liquid can be adjusted by a step of properly setting a droplet diameter, a flow rate, the number of spray nozzles, the distance between a film and a spray nozzle, a spraying angle of a spray, a spraying pressure, and so on.

A quantity of adhering liquid is preferably 1 g/m² or more, and more preferably 3 g/m² or more and 100 g/m² or less.

The average diameter of droplets, is preferably 10 μm or more and 5000 μm or less. The diameter of droplets can be measured by the following measuring method.

### <Droplet Diameter Measuring Method>

Under the droplet diameter measurement conditions that the temperature of water is 20° C., a room temperature is 20±2° C., a humidity is 50%±5%, and a line velocity is 15 m/min, liquid is sprayed from a spray nozzle toward a film currently being conveyed. After the spraying, a film is sampled, and the diameter of droplet on the sampled film is measured with a microscope as shown in FIG. 9.

The installing position of the spray nozzle according to the present invention is determined such that a surface of a lengthy film is processed preferably at 2 to 60 seconds after the surface is wetted by the spray nozzle. Therefore, the above-mentioned position may change depending on the conveying speed of the lengthy film. However, when the surface of the lengthy film is processed or rubbed with the elastic member 1, it is required to maintain a proper adhering quantity of the liquid and a proper diameter of droplet sprayed beforehand in order to obtain the effect of the present invention.

The elastic member 1 according to the present invention may be rotated in the same direction or the reverse direction to the conveying direction of the lengthy film F. However, it may be preferable to set up a diameter and a rotation speed of the elastic member 1 such that the absolute value of the difference in line speed between the elastic member 1 and the lengthy film F is 5 m/minutes or more. The rotation speed is preferably 1 to 100 rpm, more preferably 5 to 60 rpm.

The conveying speed of the lengthy film F at the time of conducting the process of the present invention is usually 5 to 200 m/minutes, and more preferably 10 to 100 m/minutes.

It is suitable for continuous production to make the elastic member 1 the shape of a roller. Moreover, the elastic member 1 is made of single materials, such as a natural rubber and a synthetic rubber, or may be constituted by complex materials, such as a metal roller and a rubber. For example, metal rolls, such as aluminum, iron, copper, and stainless steel, may be covered with polyamide, such as 6-nylon, 66-nylon, and copolymer nylon; polyester, such as polyethylene terephthalate, polybutylene terephthalate, and copolymerization polyester; polyolefines, such as polyethylene and polypropylene; poly halogenated vinyl, such as polyvinyl chloride, poly fluoridation Biniderin, and Teflon (registered trademark); natural rubber, neoprene rubber, nitrile rubber, nodell, Viton rubber, hypalon, polyurethane, rayon (registered trademark), and cellulose with a thickness of 0.5 mm or more, preferably 0.5 to 100 mm, still more preferably 1.0 to 50 mm on the surface of the metal roller. As the viewpoint of selecting the quality of the material of these elastic members, it is desirable not to soften or not to elute depending on the liquid to be used. Moreover, the rubber hardness of the elastic member 1 is measured by Durometer A type in accordance with the method specified in JIS K-6253, is preferably 15 to 70, more preferably 20 to 60.

In the present invention, it is required for the static friction coefficients on the surface of the elastic member to be 0.2 or more and 0.9 or less, more preferably to be 0.3 or more and 0.8 or less. When the elastic member rubs a lengthy film, if it is less than 0.2, it is not desirable, because effects to correct a surface wrinkle, a fray, and distortion are weak, on the other hand, if it exceeds 0.9, it is not also desirable, because the rubbed lengthy film may be damaged and transversely-streaked unevenness my occur.

The static friction coefficient of the elastic member can be measured by the following methods.

### <Measurement of Static Friction Coefficient of an Elastic Member>

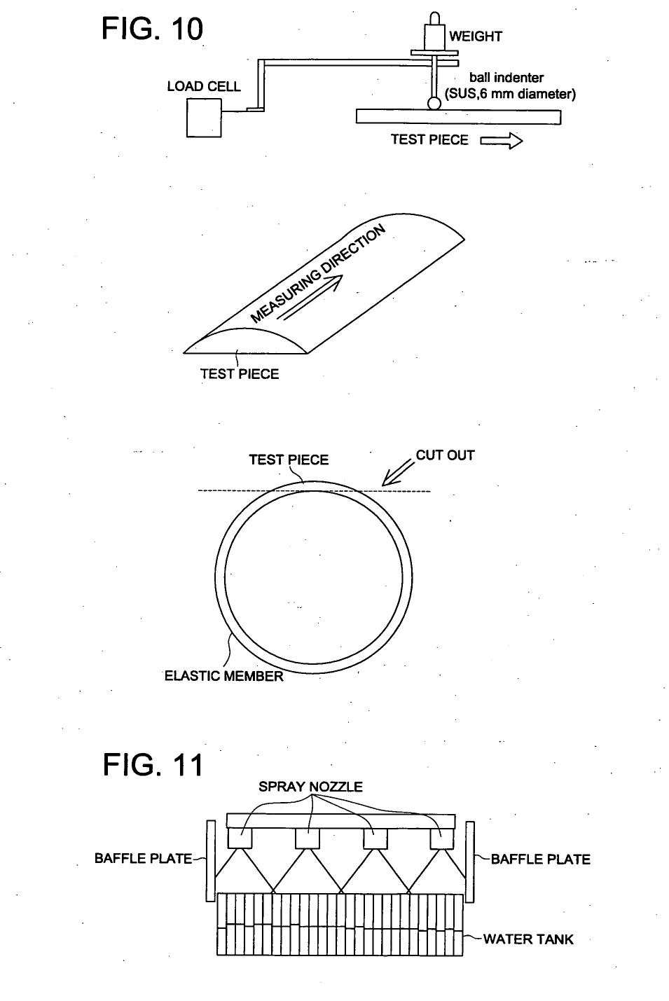

An example of methods of measuring the static friction coefficient of the elastic member according to the present invention is shown in FIG. 10.

By the use of Hayden surface test machine (TYPE: HEIDON-14D made by Shinto Science Company Ltd.), the friction coefficient of a test sample (vulcanized rubber product) is measured by the ball indenter (SUS, diameter 6) method. A principle illustration of this test is shown in FIG. 10.

In this Hayden surface test machine, as shown in FIG. 10, a test weight for a vertical load is mounted on a ball made from SUS via a support member, and this ball made from SUS is pushed onto a test sample cut out of an elastic member under the weight of the test weight (200 g) for a vertical load. And then, a friction produced when the above-mentioned test sample is moved rightward on the illustration is measured.

The other measurement conditions in this testing machine are described below.

Measurement tool; Ball indenter (SUS, diameter 6)

Test sample size; although the test sample size does not have limitation in particular, a size with which a moving distance of 50 mm or more can be secured is desirable.

Test load; 200 g (test weight for a vertical load)

Test rate; 600 mm/min

Atmosphere; 23° C.±2, 50%±10RH (within air-conditioning and no dew condensation)

Since a static friction coefficient of a usual rubber is 1.0 or more, the elastic member 1 to according to the present invention is desirably a surface modified rubber. In order to make the static friction coefficient of the elastic member 1 into the above-mentioned range, it may be preferable to employ the following methods, such as a method to use a silicon rubber layer filled up with fluororesin powder processed with sodium naphthalene complex as disclosed in Japanese Patent Unexamined Publication No. 7-158632; a method to use a thin layer formed from the melt material of ultrahigh molecular weight polyolefine fine particles as disclosed in Japanese Patent Unexamined Publication No. 9-85900; a method to form a polycondensation material of alkoxy silane hydrolyzate in a vulcanized rubber as disclosed in Japanese Patent Unexamined Publication No. 11-166060; a method to make a functional group containing monomer to conduct a pyrogenetic reaction with a rubber as disclosed in Japanese Patent Unexamined Publication No. 11-199691; a method to make rubber to react with silica as disclosed in Japanese Patent Unexamined Publication No. 2000-198864; a method to make a functional group containing monomer to conduct a pyrogenetic reaction with a fluororubber base material as disclosed in Japanese Patent Unexamined Publication No. 2002-371151; and a method to use a polychloroprene rubber as disclosed in Japanese Patent Unexamined Publication No. 2004-251373. However, in the present invention, it may be preferable to employ a method to use a rubber as an elastic member and to adjust the static friction coefficient by applying an organic halogenated compound treatment on the surface of the rubber.

Examples of the rubber capable of being modified by the organic halogenated compound treatment, include acrylonitrile-butadiene rubber, polychloroprene rubber, styrene-butadiene rubber, synthetic polyisoprene rubber, polybutadiene rubber, ethylenepropylenediene ternary polymerization rubber, natural rubber, and so on. In view of the above objects, it may be preferable to use acrylonitrile-butadiene rubber as a elastic member. These rubber may be used usually after being vulcanized, and the vulcanization may be performed by the usual vulcanizing method used in this industry.

Examples of the organic halogenated compound used to modify the above-mentioned rubber, include halogenated succin imide like N-bromo succin imide, trichloroisocyanuric acid, halogenated compounds of isocyanuric acid like dichloroisocyanuric acid, and halogenated hydantoin like dichlorodimethylhydantoin. It may be preferably trichloroisocyanuric acid.

In order to make the organic halogenated compound act on the rubber surface, it is desirable to dissolve it in an organic solvent and to use it with a suitable concentration. A solvent suitable for being used for this purpose needs not to react with this organic halogenated compound. Examples of the usable organic solvent, include, for example, aromatic hydrocarbon, such as benzene and xylene; ether, such as diethyl ether, dioxane, and tetrahydrofuran; ester, such as ethyl acetate, ketone, such as methyl ethyl ketone and cyclohexanone; and chlorinated hydrocarbon, such as ethyl chloride and chloroform. Although the concentration of the organic halogenated compound in the organic solvent in the case of processing the rubber surface is not specifically restricted, it may usually 2 to 10% by weight, preferably 4 to 6% by weight. When the concentration is higher than 2% by weight, the efficiency to modify rubber is good. On the other hand, when it is lower than 10% by weight, it becomes easy to coat it uniform and effectively on a rubber surface, and the modification effect becomes also enough, and rubber does not harden.

In order to make an organic halogenated compound solution act on a rubber, what is necessary is just to merely make the solution contact with the rubber, and a special method is not needed. For example, it can be coated on the surface of a rubber with a spray or a brush, or a rubber may be immersed into the solution, and further the rubber may be rubbed with the solution.

Here, a lap angle of a lengthy film F to an elastic member 1 (or contact angle of the elastic member 1 for the lengthy film F) is determined by the arrangement of guide rollers 2 and 2′ arranged before and after the elastic member 1. If the lap angle is made larger, since a processing time of the passage of the lengthy film F on the elastic member 1 is extendable, the higher rubbing effect may be acquired. However, in order to convey stably without causing wrinkles, rubbing scratch, and meandering, it may be preferable to set it as being less than 180 degrees, more preferable as being 1 degrees or more and less than 135 degree, still more preferably 5 degrees or more and less than 90 degree. Moreover, it is also possible to extend the processing time by enlarging the diameter of the elastic member 1. In view of problems of occupation space and cost, the diameter is preferably less than 2000 mm, more preferably 50 mm or more and less than 1000 mm, and still more preferably 100 mm or more and less than 500 mm.

A time period during which the above-mentioned lengthy film is rubbed with the above-mentioned elastic member, is desirably 0.05 second or more and 3 seconds or less. If it is less than 0.05 second, it may be difficult to obtain the effect of the present invention. On the other hand, if it is 3 seconds or less, abrasion due to fracture of liquid membrane may not occur and sufficient rubbing effect may be acquired.

Although a face pressure applied to the lengthy film F on the elastic member 1 is controllable with an air pressure by the above-mentioned air nozzle 5, it is also controllable with a tension and a roller diameter of a film conveying system. Since the roller diameter is related to the above-mentioned processing time, it is desirable to control the tension of the conveying system. In order to obtain this effect of the present invention, it is desirable to keep the face pressure high. However, if it is set up too high, the liquid membrane of a liquid may fracture and the elastic member 1 and lengthy film F contact directly to each other. Therefore, it becomes easy to generate rubbing scratch. Usually, it is desirable to set the face pressure at the time of the above-mentioned lengthy film being rubbed with the above-mentioned elastic member at 500 N/m² to 5000 N/m².

The face pressure can be obtained by the following formula:

Face pressure N/m²=(line tension N/film width m)/elastic member radius m

Moreover, the time period when the processed surface of the lengthy film has got wet with liquid is controllable by the adjustment of the distance between a spray nozzle 8, an elastic member, a suction nozzle 7, and an air nozzle 6. From a viewpoint of preventing an occurrence of a watermark etc., the time period when the processed surface of the lengthy film has got wet with liquid is preferably 2 seconds or more and 60 seconds or less. With regard to the start point of the time period when the processed surface of the lengthy film has got wet with liquid, a time point when the processed surface of the lengthy film is wetted with liquid jetted from a liquid supply means (for example, nozzle 8) to wet the processed surface of the lengthy film becomes the start point of the time period. With regard to the end point of the time period when the processed surface of the lengthy film has got wet with liquid, a time point when 95% or more of the liquid adhering on the processed surface of the lengthy film is flown away or evaporated by for example a suction nozzle 7 and an air nozzle becomes the end point. The temperature of air jetted from an air nozzle 6 is desirably room temperature to 80° C., and more desirably 40 to 70° C.

Although the liquid 4 is not restricted especially, it may be selected from one which does not dissolve or extract components contained in the lengthy film F and a under-coated layer etc included in a base surface by a process of coating and the other methods. Examples of the liquid 4, include, organic solvents, such as methanol, ethanol, isopropyl alcohol, acetone, methyl acetate, toluene, and xylene; and water or pure water containing a fluorine base solvent, an acid or an alkali, a salt, a surface active agent, a defoaming agent, and so one. Pure water is the most desirable.

In the present invention, although the temperature of the above-mentioned liquid 4 is usually 0 to 100° C., it is more preferably 30° C. or more and 100° C. or less. Simultaneously, it is desirable in order to obtains the effect of the present invention that the temperature of the above-mentioned elastic member is also 30° C. or more and 100° C. or less. The temperature control for the liquid 4 may be conducted with warm water circulation by a usual heater. The temperature of the elastic member may be adjusted by the immersion of the elastic member in a hot water for a proper timer period or warm water circulation in the inside of the elastic member.

The conveying speed may be set suitably at 5 m/minute or more and 200 m/minutes or less.

In order to precisely correct the wrinkle, tensile, and displacement, a device which avoids the meandering of the long roll film is preferably equipped. It is preferable that an edge position controller (also referred to as EPC) disclosed in JP-A No. 6-8663, or a center position controller (also referred to as CPC) is used to correct meandering. These devices detect the edges of the film with an air servo sensor or an optical sensor to control the transport of the film using the obtained information, whereby the edge positions and the center position of the film with respect to the lateral direction are kept constant while the film is transported. One or two guide rolls or a flat expander roll having a driving member as actuators are moved to the right and left (or up and down) along the line to correct the meandering. A pair of small pinch rolls are placed on each of the right and left of the film (one of the pair of pinch rolls is placed on the front surface of the film and the other is placed on the back surface of the film, wherein the two pairs of the pinch rolls are located on both sides of the film), whereby the film is sandwiched and pulled to correct meandering (a cross guide method). The principle of meandering correction of these devices can be described as follows: When the running film tends to move to the left, the roll is tilted so as to move the film to the right, in the former method, and in the latter method, a pair of pinch rolls on the right nip the film to pull it to the right.

The aforementioned meandering preventive apparatuses is preferably installed within a region of 2 to 30 m distant away in an upstream side or a downstream side from a position as a original point where the elastic member of the present invention is arranged, and at least one of the aforementioned meandering preventive apparatuses is preferably installed for each of the upstream side and the downstream side.

The optical film to according to the present invention is characterized by being obtained with the above-mentioned producing method, and in the present invention, this optical film is desirably used as a support of an antireflection film.

The feature of the antireflection film employing the optical film of the present invention is a laminated film of optical interfering layers laminated a high refraction layer and a low refraction layer in order from a support side on at least one surface of the support (other layers may be added depending on the case). Moreover, it is desirable to provide a hard coat layer between the support and an antireflection layer. The hard coat layer is prepared by the use of the below-mentioned actinic ray curable resin.

In the antireflection layer, it is desirable to set the optical film thickness of the high refraction layer and the low refraction layer to be λ/4 for the light having a wavelength λ. The optical film thickness is a thickness defined by the product of the refraction n of a layer and the thickness d of the layer. The value of a refractive index of the layer is mostly determined with metals or compounds contained in the layer. For example, the refractive index of the layer contusing Ti becomes high, that containing Si becomes low, the compound containing F becomes still lower, and a refractive index may be set up with such a combination of metals and compounds. The refractive index and the thickness are obtained by calculation with measurements of spectral reflectance.

Here, when a film is obtained by a process of coating a solution containing metallic compounds onto a support, these antireflection optical characteristics are determined only by a physical thickness as mentioned above.

Especially, even if the film thickness deviates slightly by several nanometers, the color of reflected light in the vicinity of 550 nm changes between purplish red and purple blue. This color unevenness is hardly conspicuous in the case where an amount of transmitted light from a display is much. However, in the case where the amount of transmitted light is little, or when a display is turned off, the color unevenness is notably conspicuous and the visibility becomes inferior. Moreover, when the deviation of thickness is large, the reflectance for light of 400 to 700 nm cannot be reduced, therefore, it becomes difficult to obtain desired antireflection characteristics.

### [Lengthy Film]

The lengthy film used in the present invention is not limited especially. Examples of it, include a polyester film, a cellulose ester film, a polycarbonate film, a polyether sulfone film, a cyclic olefin resin film, and so on. As the lengthy film, a film produced by a melt casting method or a solvent casting method is used preferably. Especially, a cellulose ester film is desirable in the present invention, and further the cellulose ester film stretched to at least one way is more desirable. Examples of the cellulose ester film, include Konica Minolta TAC, for example, KC8UX, KC4UX, KC5UX, KC8UY, KC4UY, KC12UR, KC8UCR-3, KC8UCR-4, KC8UCR-5, KC4UE, KC4FR-1, KC4FR-2 (produced by Konica Minolta Opt. Inc.). The thickness of the lengthy film is 10 to 500 μm, preferably 10 to 200 μm, more preferably 20 to 100 μm, and still more preferably 30 to 70 μm. The length is 100 to 10000 m, preferably 300 to 5000 m.

Cellulose as a source material of the cellulose ester preferably used in the present invention is not specifically limited, however, usable are cotton linter, wood pulp (obtained from acicular trees or from broad leaf trees) or kenaf. The cellulose esters obtained from these cellulose source materials may also be used by mixing with each other in any ratio. However, it may be preferable to use cotton linter in an amount of 50% by weight or more.

In case, an acid anhydride (acetic anhydride, propionic anhydride, and butyric anhydride) is used as an acylation agent, cellulose ester can be prepared through a common reaction using an organic acid such as acetic acid and an organic solvent such as methylene chloride, in the presence of a protic catalyst such as sulfuric acid. When an acylation agent is an acid chloride (CH₃COCl, C₂H₅COCl or C₃H₇COCl), a reaction is carried out using a basic compound such as an amine as a catalyst. Specifically, the reaction can be carried out according to the method disclosed in JP-A No. 10-45804. The cellulose ester used in the present invention is obtained through a reaction using in combination of the above acylation agents depending on the acylation degree. In an acylation reaction to form a cellulose ester, an acyl group reacts with the hydroxyl group of a cellulose molecule. A cellulose molecule is made up of many glucose units connected each other, and a glucose unit contains three hydroxyl groups. The number of acyl groups introduced to three hydroxyl groups is referred to as a degree of substitution.

For example, in the case of cellulose triacetate, all the three hydroxyl groups in one glucose unit are bonded with acetyl groups.

Although there is no limitation in particular in the cellulose ester which can be used for a cellulose ester film, it is desirable that the degrees of substitution of a total acyl group is 2.40 to 2.98, and among the acyl groups, the degree of substitution of an acetyl group usable more preferably is 1.4 or more.

An acyl substitution degree can be determined through a method prescribed in ASTM-D817-96.

The cellulose ester preferably is a cellulose ester in which a propionate group or a butyrate group is bonded to cellulose in addition to an acetyl group, like cellulose acetate, such as cellulose triacetate and cellulose diacetate; cellulose acetate propionate, cellulose acetate butylate, cellulose acetate propionate butyratein, for example. Here, butyrate also contains iso- in addition to n-. The cellulose acetate propionate with a large substitution degree of a propionate group is excellent in water resistance.

The number average molecular weight Mn (measurement method is described below) of cellulose ester is desirably 70000-250000, because the mechanical strength of a film obtained from the cellulose ester being within the above range becomes strong, and a dope solution becomes proper viscosity, and more desirably 80000 to 150000. Moreover, the ratio (MW/Mn) (weight average molecular weight (Mw)/number average molecular weight (Mn)) is desirably in the ranges of 1.0 to 5.0, more preferably 1.5 to 4.5.

### <<Measurement of Number Average Molecular Weight of Cellulose Ester>>

It can be measured on the following conditions with high performance liquid chromatography.
Solvent: acetone
Column: MPWx1 (made by TOSOH CORP.)
Sample concentration: 0.2 (weight/volume) %
Flow rate: 1.0 ml/minute
Sample injection rate: 300 μL
Standard sample: polymethylmethacrylate (weight average molecular weight 188,200)
Temperature: 23° C.

With regard to metal which may be used during the production of cellulose ester or exists slightly in used materials, it is preferable that such metal is contained in cellulose ester as few as possible. The total content of metal, such as Ca, Mg, Fe, Na and so on is preferably 100 ppm or less.

### (Organic Solvent)

As organic solvent useful for formation of a cellulose ester solution with cellulose ester dissolved therein or dope, methylene chloride of chlorine-based organic solvent may be employed. The methylene chloride is suitable for dissolution of the cellulose ester, cellulose triacetate in particular. Examples of non-chloride organic solvents include methyl acrylate, ethyl acrylate, amyl acetate, acetone, tetrahydrofuran, 1,3-dioxolane, 1,4-dioxane, cyclohexanone, ethyl formate, 2,2,2-trifluoroethanol, 2,2,3,3-hexafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, and nitroethane.

When these organic solvents are used for the cellulose triacetate, the method of dissolution at the room temperature can be used. Further, use of high temperature dissolution method, low temperature dissolution method and high pressure dissolution method also preferably reduces the amount of insoluble substances.

Methylene chloride can be used for the cellulose ester other than the cellulose triacetate. Methyl acrylate, ethyl acrylate and acetone are preferably utilized. Particularly use of the methyl a certain is preferred. In the present invention, the organic solvent capable of effectively dissolving the aforementioned cellulose ester is called the good solvent, and the organic solvent used in great quantity exhibiting the major effect in dissolution is called the major (organic) solvent.

The dope preferably contains 1 through 409 by weight of alcohol of 1 through 4 carbon atoms (per molecule), in addition to the aforementioned organic solvent. After the dope is flow-cast over the metal support, the solvent starts to evaporate and the percentage of alcohol is increased. Then the dope membrane (web) starts to gelates to strengthen the web and to facilitate separation of the web from the metal support. These alcohols can be used as such a gelation solvent. Alcohols also work to accelerate dissolution of the cellulose ester of the non-chlorine organic solvent when the ratio of alcohols is less.

Typical alcohols of 1 through 4 carbon atoms (per molecule) are methanol, ethanol, n-propanol, iso-propanol, n-butanol, sec-butanol and tert-butanol.

Among these, ethanol is preferable because it excels at stability of dope and has a comparatively-low boiling point, good drying property, and little toxicity. These organic solvents are called poor solvents because they have no ability to dissolve cellulose derivatives.

### [Production of Cellulose Ester Film by a Solution Casting Film Forming Method]

The film forming method of a cellulose ester film used as a support is described. The cellulose ester film is produced with the solution casting film forming method.

### 1) Dissolution Process:

This process is a process to form a dope such that a cellulose ester, a polymer and an additive are dissolved in an organic solvent which mainly contains good solvent for cellulose ester (flake-shaped), in a vessel while stirring the mixture of them, or a process to form a dope such that a polymer solution and an additive solution are mixed in a cellulose solution. As a method of dissolving a cellulose ester, various methods such as a method of performing under the ambient pressure, a method of performing under a temperature below the boiling point of the main solvent, a method of performing under a temperature above the boiling point of the main solvent while applying a pressure, a method of performing a cooling dissolving method described in the official gazettes of Japanese Patent O.P.I. Publication No. 9-95544, Japanese Patent O.P.I. Publication No. 9-95557 and Japanese Patent O.P.I. Publication No. 9-95538, a method of performing under a high pressure described in the official gazette of Japanese Patent O.P.I. Publication No. 11-21379 may be employed. However, in the present invention, a method of performing under a temperature above the boiling point of the main solvent while applying a pressure especially is desirable.

The concentration of the cellulose ester in a dope is desirably 10 to 35% by weight. After adding dissolving or dispersing an additive in the dope while dissolving or after dissolving, the dope is filtered with a filer media and degassed, and then the dope is sent to the following manufacturing process with a feeding pump.

### 2) Casting Process:

In this casting process, a dope solution is sent to a high pressure die using a feeding pump (for example, a high pressure metering gear pump) and cast on an endless metal belt, for example, a stainless steel belt, or on a rotating cylindrical metal support at a prescribed position from the high pressure die. A high pressure die is preferable since uniform thickness is more easily obtained by adjusting the slit shape at the tip of a die. A high pressure die includes a coat-hanger die and a T die either of which are preferably used. Two high pressure dies may be provided simultaneously on a metal support to increase the film forming rate by dividing the amount of dope and by superimposing two film layers.

### 3) Solvent Evaporation Process:

A web (a film of a dope after the dope is cast on a metal support is referred to as a web) is heated on a metal support to evaporate the contained solvent until the web becomes peelable. The following methods may be used to promote evaporation of a solvent from a web: blowing from above the web; heating a metal support from a back surface using a liquid heat medium; and heating from both surfaces of a web using radiant heat. Among these methods, the method to heat a metal support from a back surface using a liquid heat medium is preferable with respect to drying efficiency, however the above methods may also be used in combination. In the case of heating a back surface using a liquid heat medium, it may be preferable to heat at a temperature lower than the boiling point of the main solvent of an organic solvent used in the dope or lower than the boiling point of an organic solvent having a lowest boiling point.

### 4) Peeling Process

A web dried on a metal support is peeled from the metal support at a prescribed position. The peeled web is sent to the next process. If the amount of the residual solvent (below mentioned formula) in a web is too much at the point of peeling, peeling is difficult and if the amount of the residual solvent is too small, partial peeling of the web may occur prior to the point of peeling.

As an alternate method to increase the formation rate of a web (by peeling while an amount of the residual solvent is as much as possible, the formation rate of a web can be increased), a gel casting method may be used.

With regard to a drying method and a producing method of an optical film according to the present invention, in the case where the cellulose ester film produced by the solution casting film forming method is used as a support, the solution casting film forming method is not limited specifically and includes methods used generally in this technical field, for examples, methods described in U.S. Pat. No. 2,492,978, U.S. Pat. No. 2,739,070, U.S. Pat. No. 2,739,069, U.S. Pat. No. 2,492,977, U.S. Pat. No. 2,336,310, U.S. Pat. No. 2,367,603, U.S. Pat. No. 2,607,704, British patent No. 64,071, British patent No. 735,892, Japanese Patent No. 45-9074, Japanese Patent No. 49-5614, Japanese Patent No. 60-27562, Japanese Patent No. 61-39890, and Japanese Patent No. 62-4208.

A solvent used for preparing a dope of cellulose ester used in the solution casting film forming method may be used alone, or used together with two or more solvents in combination. A mixture of a good solvent for cellulose ester and a poor solvent is more preferably used to increase manufacturing efficiency. A mixed solvent being rich in a good solvent is preferable to increase solubility of the cellulose ester. The preferable mixing ratio is from 70 to 98 percent by weight of a good solvent, and from 30 to 2 percent of a poor solvent.

Herein, the good solvent is defined as being capable of dissolving cellulose ester with a single use, and a poor solvent is defined as being capable of swelling or being incapable of dissolving cellulose ester with a single use. Therefore, the target of the solvent and the a poor solvent may change depending on the average acetylation degree of a cellulose ester. For example, acetone is used as a solvent, it becomes a good solvent for a cellulose ester in which an amount of bonded acetic acid is 55%, and becomes a poor solvent for a cellulose ester in which an amount of bonded acetic acid is 60%.

Good solvents used in the present invention are not specifically limited, however, for example, in the case of cellulose triacetate, organic halogen compounds such as methylene chloride, dioxolanes, and methyl acetate may be employed, and in the case of cellulose acetate propionate, methylene chloride, acetone and methyl acetate may be employed.

Poor solvents used in the present invention are not specifically limited, however, for example: methanol, ethanol, i-propyl alcohol, n-butanol, cyclohexane, acetone and cyclohexanone may be preferably used.

As a dissolving method in the time of preparing a dope, a common method can be employed. A method of dissolving a cellulose ester while stirring with a process of heating under the application of pressure at a temperature not less than a boiling point of a solvent under atmospheric pressure and within a range that the solvent does not boil, may be preferably employed, because formation of a gel or an insoluble agglomerate called “Mamako” may be avoided.

Further, a method of mixing a cellulose ester with a poor solvent so as to wet or swell the cellulose, and thereafter, solving by further mixing it with a good solvent, may also employed.

The kinds of pressurized container is not needed to be asked specifically, any container may be used as far as it can bear for a predetermined pressure and can allow to conduct therein a process of heating under the application of pressure and a process of stirring. On the pressurized container, gauges such as a pressure gauge and a thermometer are mounted properly. Pressure may be applied by injecting an inert gas such as nitrogen or by increasing the vapor pressure of the solvents by heating. Heating is preferably carried out from the outside of the container. A jacket type heater is preferable because the temperature is easily controlled.

With regard to the heating temperature with the addition of a solvent, a temperature not less than a boiling point of the used solvent under atmospheric pressure and within a range that the solvent does not boil, may be preferably from the viewpoint of the solubility of a cellulose ester. However, if the temperature is too high, a required pressure becomes high. As result, the productivity may decrease. The dissolving temperature is preferably from 45 to 120° C., more preferably from 60 to 110° C. and still more preferably from 70 to 105° C. The pressure is controlled not to allow the solvent to boil at the set temperature.

In addition to the cellulose ester and the solvent, required additives, such as a plasticizer and an ultraviolet absorber, are beforehand mixed with a solvent. After the additives are dissolved or dispersed in the solvent, the additives are supplied into a solvent before a cellulose ester is dissolved, or into a dope after the cellulose ester has been dissolved.

After the cellulose ester has been dissolved, the resultant cellulose ester solution may be taken out from the container while being cooled, or may be pumped out from the container by a pump and then is cooled by a heat exchanger. Thereafter, the cellulose ester solution is supplied to a film forming process. At this time, the cellulose ester solution may be cooled to normal temperature. However, it may be preferable that the cellulose ester solution is cooled to a temperature lower by 5 to 10° C. than the boiling point and then is supplied to a casting process while keeping the temperature, because the viscosity of the dope can be reduced.

The substitution degree of an acyl group can be measured by a method in accordance with the regulation specified in ASTM-D817-96.

The cellulose ester is made into a film by a method generally called a solution casting film forming method as mentioned later. In this method, onto a metal support (hereafter, merely referred to as metal support) for solution casting, such as an endless metal belt (for example, stainless belt) being conveyed infinitely and a rotating metal drum (for example, a drum applied a chrome plating with cast iron), a dope (meaning a cellulose ester solution) is cast from a pressure die. Thereafter, a web (dope film) formed on the metal drum is separated or peeled from the metal drum and dried.

It is desirable to make a cellulose ester film contain ultraviolet absorber described below from a viewpoint of the deterioration prevention when the cellulose ester film is placed on the outdoors as an image display device.

As a UV absorber, a UV absorber which excels in the absorbing power of ultraviolet rays with a wavelength of 370 nm or less and has few absorption of a visible ray with a wavelength of 400 nm or more is preferably used. Examples of a UV absorbing agent preferably used in the present invention include: an oxybenzophenone based compound, a benzotriazol based compound, a salicylic acid ester based compound, a benzophenone based compound, a cyanoacrylate based compound, and a nickel complex salt. However, the present invention is not limited to these examples.

In the present invention, the thickness of a cellulose ester film is preferably 10 to 200 μm, more preferably 30 to 70 μm. Conventionally, coating unevenness was apt to take place on such a thin film. However, according to the present invention, a stable coating ability is expectable even for a thin film less than 70 μm.

In the present invention, in the case where an optical thin film is provided on the surface of the above support, the optical thin film can be provided such that the thickness deviation for an average thickness can be made ±8%, more preferably within ±5%, still more preferably ±1% to be a uniform thin film. Especially, the producing method of the present invention exhibits its remarkable effect when it is applied to a wide optical film of 1400 mm or more. Although the maximum width of an optical film preferably applied with the producing method of the present invention is not limited especially from the point of thickness precision, a width of 4000 mm or less is desirable from the point of a manufacturing cost.

In the optical film according to the present invention, if a matting agent is contained in a cellulose ester film, conveyance and rolling up can be conducted easily.

The matting agent is preferably fine particles as small as possible, examples of the particles include: inorganic particles such as silicon dioxide, titanium dioxide, aluminum oxide, zirconium oxide, calcium carbonate, kaolin, talc, burned calcium silicate, hydrated calcium silicate, aluminum silicate, magnesium silicate, and calcium phosphate; methyl polymethacrylate acrylate resin powder, and acrylic styrene resin powder, polymethyl methacrylate resin powder, silicon system resin powder, polystyrene system resin powder, polycarbonate resin powder, benzoguanamine system resin powder, melamine system resin powder, polyolefin system resin powder, polyester system resin powder, polyamide system resin powder, polyimide system resin powder, and polyfluoroethylene system resin powder. Especially crosslinked high molecular particles are desirable. However, in the present invention, the particles not limited to these.

Among the above particles, silicon dioxide is preferable especially in order to adjust dynamic friction coefficient. Also, it is preferable to reduce haze in the film. The average particle diameter of primary particles or secondary particles of the particles is preferably in the range of 0.01 to 5.0 μm and the content of these particles is preferably in the range of 0.005 to 0.5 percent by weight of the cellulose ester.

The particles such as the silicon dioxide particles are often surface treated with an organic substance, and this is preferable because it reduces haze in the film.

Examples of the organic compound used in the surface treatment include halosilanes, alkoxysilanes, silazanes, and siloxanes. Particles having a larger average particle diameter have a greater slipping effect, while particles having a smaller average particle diameter have excellent transparency. The average primary particle size of primary particles of preferable particles is preferably 20 nm or less, more preferably 5 to 16 nm, and still more preferably 5 to 12 nm.

In the cellulose ester film, it is desirable that these particles form concavo-convex of 0.01 to 1.0 μm on the surface of the cellulose ester film.

Examples of the silicon dioxide particles include Aerosil 200, 200V, 300, R972, R972V, R974, R202, R812, OX50, or TT600 (each manufactured by Aerosil Co., Ltd.), and of these, Aerosil 200V, R972, R972V, R974, R202, and R812, are preferred. Two or more of these particles may be combined and used. In the case where 2 or more particles are used, they may be mixed in a suitably selected proportion. In this case, particles which have different particle size and quality such as Aerosil 200V and R927V may be used in weight proportions in the range from 0.1:99.9 to 99.9:0.1. As zirconium oxide, commercial products, such as Aerosil R976 or R811 (product made from Japanese Aerosil), can also be used.

As the organic substance particles, commercial products, such as Tossparl 103, 105, 108, 120, 145, 3120, and 240 (made by Toshiba Silicone), can also be used as a silicone resin.

Measurement of the primary average particle diameter of the fine particles used for the present invention is conducted such that 100 particles are observed with a transmission type electron microscope (500,000 to 2000,000 magnification) so as to measure the diameter of the particles and to determine the mean value of the measured diameters as a primary average particle diameter.

An apparent specific gravity of the fine particles is desirably 70 g/liter, more preferably 90 to 200 g/liter, and still more preferably 100 to 200 g/liter. When the apparent specific gravity is larger, it may become more possible to make a high-concentration dispersion liquid and it may become preferable that a haze and a coagulum may be improved. Further, in case that a dope solution having a high solid concentration is prepared as being like the present invention, it is used especially preferably.

Silicon dioxide fine particles having a mean diameter of primary particles of 20 nm or less and an apparent specific gravity of 70 g/liter or more can be obtained such that, for example, a mixture of vaporized silicon tetrachloride and hydrogen is burn in air at 1000 to 1200° C. The apparent specific gravity of the above-mentioned description can be calculated with the following ways, a predetermined quantity of silicon dioxide fine particles is taken in a measuring cylinder, the weight of them is measured at this time, and the apparent specific gravity is calculated with the following formula.

Apparent specific gravity (g/liter)=the weight (g) of silicon dioxide fine particles/the volume (liter) of silicon dioxide fine particles

The following three kinds of methods, for example, may be employed as a method of preparing a dispersion solution of fine particles usable in the present invention and a method of adding it in a dope.

### <<Preparing Method A>>

After carrying out stirring mixing a solvent and fine particles, the mixture is dispersed by a homogenizer. The resultant dispersion solution is made as a fine particle dispersion liquid. The fine particle dispersion liquid is added in a dope solution and is stirred.

### <<Preparing Method B>>

After carrying out stirring mixing a solvent and fine particles, the mixture is dispersed by a homogenizer. The resultant dispersion solution is made as a fine particle dispersion liquid. Separately, a small amount of cellulose triacetate is added in a solvent and dissolved by stirring. The resultant solution is added with the fine particle dispersion liquid and is stirred. The resultant liquid is made as a fine particle additive liquid. The fine particle additive liquid is added in a dope solution and is stirred with a line mixer.

### <<Preparing Method C>

A small amount of cellulose triacetate is added in a solvent and dissolved by stirring. The resultant solution is added with fine particle and is dispersed by a homogenizer. The resultant liquid is made as a fine particle additive liquid. The fine particle additive liquid is added in a dope solution and is stirred with a line mixer.

Preparing method A is excellent in dispersion ability for the silicon dioxide fine particles, and Preparing method C is excellent in that the silicon dioxide fine particles hardly recoagulates. Among them, Preparing method B described above is excellent in both the point of the dispersion ability for the silicon dioxide fine particles and the point that the silicon dioxide fine particles hardly recoagulates, therefore, is more preferable.

### <<Dispersing Method>>

When mixing silicon dioxide fine particles with a solvent etc., the concentration of the silicon dioxide is desirably 5% by weight to 30% by weight, more desirably 10% by weight to 25% by weight, most desirably 15% by weight to 20% by weight. When the dispersion concentration is higher, liquid turbidity to added amount tends to become low and a haze and a coagulum may be improved, therefore it may be preferable.

The added amount of silicon dioxide fine particles to a cellulose ester is desirably 0.01 to 0.5 parts by weight of silicon dioxide fine particles to 100 parts by weight of cellulose ester, is more desirably 0.05 to 0.2 parts by weight, and is most desirably 0.08 to 0.12 parts by weight. When the added amount is larger, it may be excellent in a dynamic friction coefficient, and when the added amount is smaller, haze is low and a coagulum becomes little.

The organic solvent used for dispersion is desirably a lower alcohol. As the lower alcohol, methanol, ethanol, propyl alcohol, isopropyl alcohol, butanol, etc. may preferably be listed. Although a solvent other than the lower alcohol is not limited especially, it is desirable to use a solvent which is used at the time of preparing a dope.

As a homogenizer, a usual homogenizer can be used. The homogenizer is roughly divided into a media homogenizer and a medialess homogenizer. As a homogenization for silicon dioxide fine particles, the medialess homogenizer is desirable, because of low haze. As the media homogenizer, a ball mill, a sandmill, a dieno mill, etc. are may be listed. Although a supersonic wave type, a centrifugal type, a high-pressure type, etc. may be employed as the medialess homogenizer, a high-pressure homogenization apparatus is desirable in the present invention. The high-pressure homogenization apparatus is an apparatus to create a special condition such as a high shearing and a high-pressure state by making a composition mixed of fine particles and a solvent to pass at a high speed through a small tube. When processing with the high-pressure homogenization apparatus, it is desirable that the maximum pressure condition in a small tube having a pipe diameter of 1 to 2000 μm the apparatus is 9.8 MPa or more, more preferably 19.6 MPa or more. At this time, an apparatus in which the highest arrival velocity reaches 100 m/sec. or more, or an apparatus in which a rate of heat transfer reaches more than 420 kJ/hour is desirable.

Example of the high pressure dispersing apparatus includes an ultra high speed homogenizer (commercial name: Microfluidizer) manufactured by Microfluidics Corporation and Nanomizer manufactured by Nanomizer Nanomizer Co., Ltd. Other than the above, Manton-Goulin type high pressure dispersing apparatus such as a homogenizer manufactured by Izumi Food Machinery Co., Ltd is applicable.

In the present invention, when the above-mentioned particles are made to be contained, it is desirable that particles are uniformly distributed in the thickness direction of a cellulose ester film. However, it is more desirable that particles are distributed mainly in proximity of the surface of a cellulose ester film. For example, it is desirable that for example, two or more kinds of dopes are cast simultaneously from a single die with a co-casting technique such that the dope containing particles is arranged to the surface side. With this technique, haze can be reduced and a dynamic friction coefficient can be lowered. Furthermore, it is more desirable to use three kinds of dopes such that dope containing particles is arranged at a single side or both side on the surface side.

In order to adjust the dynamic friction coefficient of a support, it is possible to provide a back coat layer containing particles can on the back side. The dynamic friction coefficient can be adjusted with the size, the additive amount, and the material of particles to be added.

As a plasticizer used for the present invention, a phosphate ester type plasticizer and a non-phosphate ester type plasticizer are used preferably.

As a phosphate ester type plasticizer, triphenyl phosphate, tricresyl phosphate, cresyldiphenyl phosphate, octyl diphenyl phosphate, diphenylbiphenyl phosphate, trioctylphosphate, tributyl phosphate, etc. may be listed.

As a non-phosphate plasticizer, phthalate ester, multivalent alcohol ester, polycarboxylic-acids ester, citrate, glycolic acid ester, fatty acid ester, pyromellitic acid ester, trimellitic acid ester, polyester, etc. may be used.

Especially, a multivalent alcohol ester plasticizer, phthalic ester, citrate ester, fatty acid ester, a glycolate system plasticizer, a polyester plasticizer, etc. are desirable.

A polyalcohol ester consists of an ester of an aliphatic polyalcohol having a valence of two or more and monocarboxylic acid, and preferably includes an aromatic ring or a cycloalkyl ring in a molecule. It is preferably aliphatic series multivalent alcohol ester of 2 to 20 valent.

A polyalcohol used in the present invention is represented by formula (1)

R₁—(OH)ₙ Formula (1)

(Here, R₁ represents an organic acid having a valence of n, n represents a positive integer of 2 or more.)

Examples of a preferable polyalcohol are listed below, however, the present invention is not limited thereto: Adonitol, arabitol, ethylene glycol, diethylene glycol, triethylene glycol, tetraethylene glycol, 1,2-propanediol, 1,3-propanediol, dipropylene glycol, a tripropylene glycol, 1,2-butanediol, 1,3-butanediol, 1,4-butanediol, dibutyleneglycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, xylitol, etc. can be listed. In particular, triethylene glycol, tetraethylene glycol, dipropylene glycol, a tripropylene glycol, sorbitol, trimethylolpropane, and xylitol are desirable.

A mono carboxylic acid to be used for the polyalcohol ester is not specifically limited, and well known compounds such as aliphatic monocarboxylic acid, alicyclic monocarboxylic acid and aromatic monocarboxylic acid may be used. Alicyclic monocarboxylic acid or aromatic monocarboxylic acid is preferably used with respect to improving moisture permeability and retention of additives.

Examples of preferable monocarboxylic acids are listed below, however, the present invention is not limited thereto.

For aliphatic monocarboxylic acids, normal or branched fatty acids having from 1 to 32 carbon atoms are preferably used. The number of carbon atoms is more preferably from 1 to 20 and still more preferably from 1 to 10. The use of an acetic acid will help improve the mutual solubility, so that a mixture of an acetic acid and other monocarboxylic acids is also preferable.

Examples of preferable aliphatic mono carboxylic acids include saturated fatty acids such as: acetic acid, propionic acid, butyric acid, valeric acid, caproic acid, enanthic acid, caprylic acid, pelargonic acid, capric acid, 2-ethyl-hexanoic acid, undecylic acid, lauric acid, tridecylic acid, myristic acid, pentadecylic acid, palmitic acid, heptadecanoic acid, stearic acid, nonadecane acid, arachidic acid, behenic acid, lignoceric acid, cerotinic acid, heptacosanoic acid, montanic acid, melissic acid, lacceric acid, as well as unsaturated fatty acids such as: undecylic acid, oleic acid, sorbic acid, linoleic acid, linolenic acid and arachidonic acid.

Examples of preferable alicyclic monocarboxylic acids include: cyclopentanecarboxylic acid, cyclohexanecarboxylic acid, cyclooctanecarboxylic acid, and derivatives thereof.

Examples of preferable aromatic monocarboxylic acids include: benzoic acid and toluic acid, both of which have benzene ring in which alkyl groups are introduced, biphenylcarboxylic acid, naphthalenecarboxylic and tetralincarboxylic acid having 2 or more benzene rings, and (derivatives thereof, of these, benzoic acid is specifically preferred.

The molecular weight of the polyalcohol ester is not limited, however, the molecular weight is preferably from 300 to 1,500 and more preferably from 350 to 750. A higher molecular weight is preferable in that the volatility of the polyalcohol is reduced, while a lower molecular weight is preferable with respect to moisture permeability, or to mutual solubility with cellulose ester.

Carboxylic acid to be used for a polyalcohol ester, may be used alone or in combination of two or more carboxylic acids. Hydroxyl groups in a polyalcohol may be completely esterified or only partially esterified remaining unsubstituted hydroxyl groups.

Specific examples of polyalcohol esters are shown below:

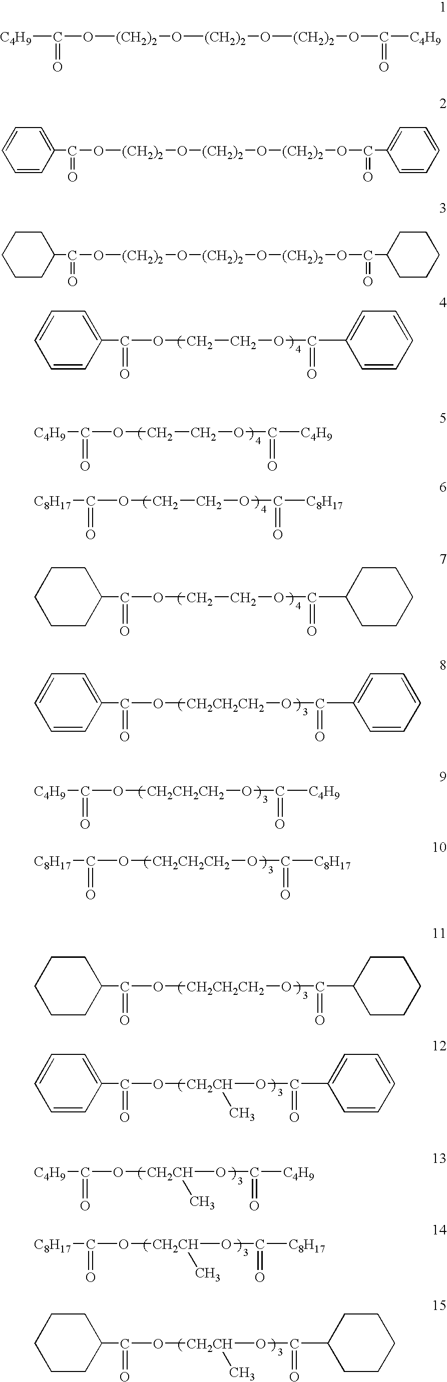

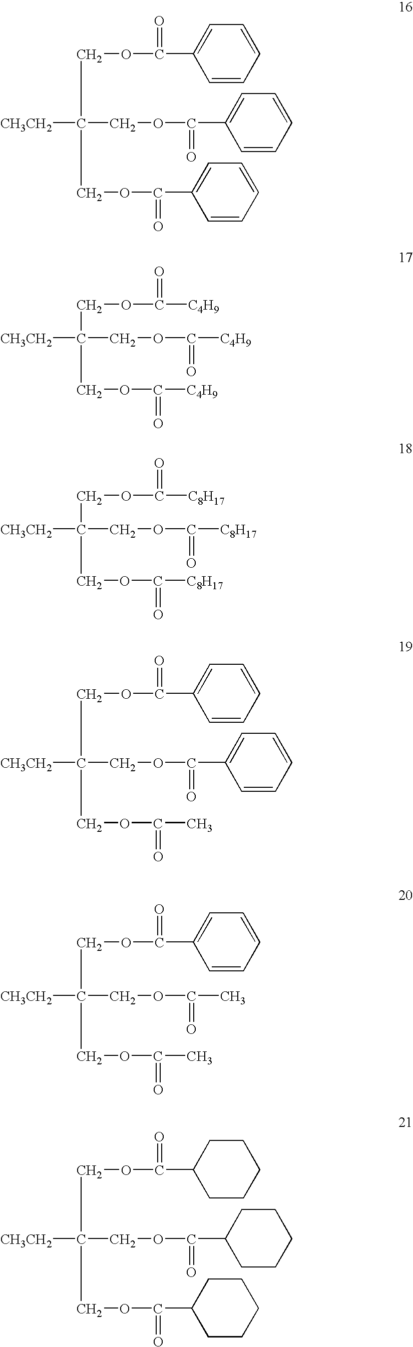

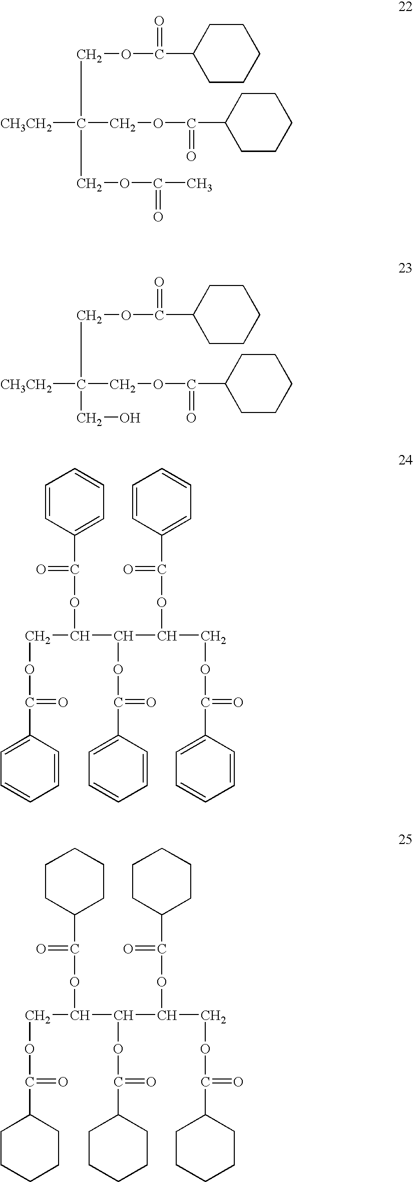

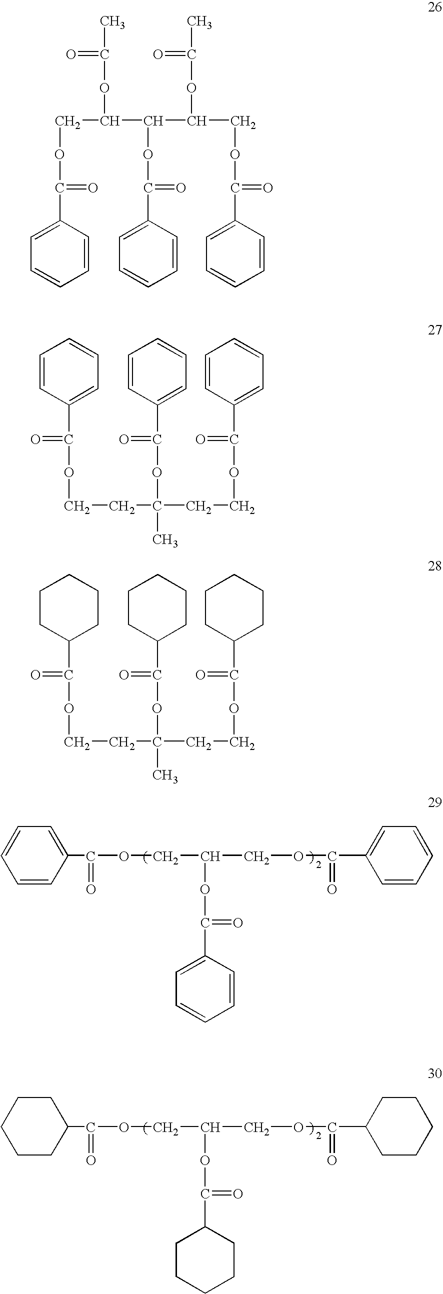

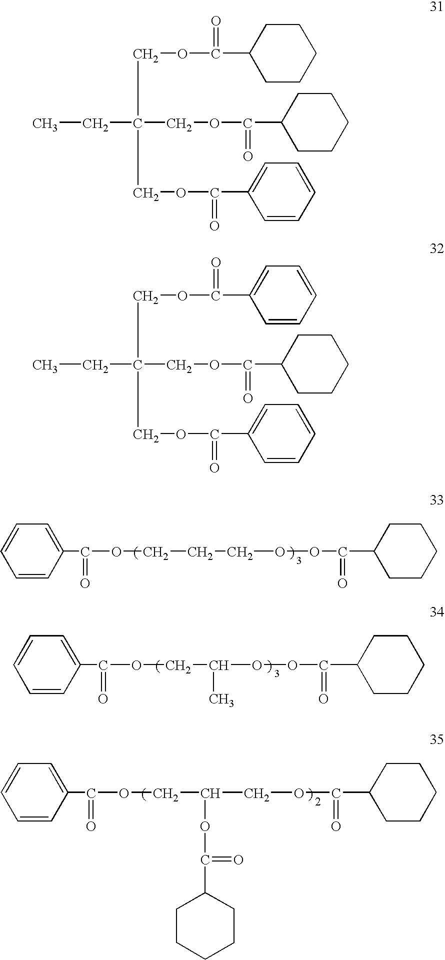

Glycolate plasticizers are not limited specifically, alkylphthalylalkyl glycolates are preferably used. Examples of an alkylphthalylalkyl glycolate include: methylphthalylmethyl glycolate, ethylphthalylethyl glycolate, propylphthalylpropyl glycolate, butylphthalylbutyl glycolate, octylphthalyloctyl glycolate, methylphthalylethyl glycolate, ethylphthalylmethyl glycdolate, ethylphthalylpropyl glycolate, methylphthalylbutyl glycolate, ethylphthalylbutyl glycolate, butylphthalylmethyl glycolate, butylphthalylethyl glycolate, propylphthalylbutyl glycolate, butylphthalylpropyl glycolate, methylphthalyloctyl glycolate, ethylphthalyloctyl glycolate, octylphthalylmethyl glycolate and octylphthalylethyl glycolate.

Examples of a phthalate plasticizer include: diethyl phthalate, dimethoxyethyl phthalate, dimethyl phthalate, dioctyl phthalate, dibutyl phthalate, di-2-ethylhexyl phthalate and dioctyl phthalate.

Examples of a citrate plasticizer include, acetyl citrate trimethyl, acetyl triethyl citrate, acetyl tributyl citrate.

Examples of a fatty acid ester plasticizer include: butyl oleate, methylacetyl ricinoleate and dibutyl sebacate.

The ester plasticizer used in the present invention is not specifically limited, however, an ester plasticizer which has an aromatic ring or a cycloalkyl ring in the molecule are applicable. For example, an ester plasticizer represented by the following Formula (2) are preferably used:

B-(G-A)ₙ-G-B Formula (2)

where B represents benzene monocarboxylic acid group, G represents an alkylene glycol group having 2-12 carbon atoms, an aryl glycol group having 6-12 carbon atoms, or an oxyalkylene glycol group having 4-12 carbon atoms, A represents an alkylene dicarboxylic acid having 4-12 carbon atoms, or an aryl dicarboxylic acid group having 6-12 carbon atoms, and n represents an integer of 1 or more.

A compound represented by Formula (2) is structured by benzene monocarboxylic acid group represented with B, an alkylene glycol group or an oxyalkylene glycol group or an aryl glycol group represented with G, and an alkylene dicarboxylic acid group or an aryl dicarboxylic acid group represented with A and is prepared through a reaction similar to the preparation reaction of a common polyester plasticizer.

Examples of a benzene monocarboxylic acid component of the ester plasticizer of the present invention include: benzoic acid, p-tert-butyl benzoic acid, o-toluic acid, m-toluic acid, p-toluic acid, dimethyl benzoic acid, ethyl benzoic acid, n-propyl benzoic acid, aminobenzoic acid and acetoxy benzoic acid, which may be used alone or in combination of two or more acids.

Examples of an alkylene glycol component having 2 to 12 carbon atoms of the ester plasticizer of the present invention include: ethylene glycol, 1,2-propylene glycol, 1,3-propylene glycol, 1,2-butanediol, 1,3-butanediol, 2-methyl-1,3-propanediol, 1,4-butanediol, 1,5-pentanediol, 2,2-dimethyl-1,3-propanediol (also known as neopentylglycol), 2,2-diethyl-1,3-propanediol (also known as 3,3-dimethylol pentane), 2-n-butyl-2-ethyl-1,3-propanediol (also known as 3,3-dimethylol heptane), 3-methyl-1,5-pentanediol-1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, which may be used alone or in combination of two or more glycols. Since alkylene glycol having carbon atoms of 2 to 12 is especially excellent in compatibility with cellulose ester, it is especially desirable.

Examples of an oxyalkylene glycol component having 4 to 12 carbon atoms of the aromatic terminal ester of the present invention include: diethylene glycol, triethylene glycol, tetraethylene glycol, dipropylene glycol and triropylene glycol, which may be used alone or in combination of two or more glycols.

Examples of an alkylene dicarboxylic acid component having 4 to 12 carbon atoms of the aromatic terminal ester of the present invention include: succinic acid, maleic acid, the fumaric acid, glutaric acid, adipic acid, azelaic acid, sebacic acid and dodecane dicarboxylic acid, which may be used alone or in combination of two or more acids. Examples of an arylene dicarboxylic acid component having 6 to 12 carbon atoms include: phthalic acid, terephthalic acid, 1,5-naphthalene dicarboxylic acid and 1,4-naphthalene dicarboxylic acid.

The number average molecular weight of the polyester plasticizer used in the present invention is preferably 300 to 1500, and more preferably 400-1000. The acid value of the polyester plasticizer used in the present invention is 0.5 mgKOH/g or less and the hydroxyl value is 25 mgKOH/g or less, more preferably, the acid value is 0.3 mgKOH/g or less and the hydroxyl value is 15 mgKOH/g or less.

Examples of a synthetic method of an aromatic terminal ester plasticizer are shown below:

### <Sample No. 1 (Aromatic Terminal Ester Sample)>

In a container, 410 parts of phthalic acid, 610 parts of benzoic acid, 737 parts of dipropylene glycols and 0.40 parts of tetra-isopropyl titanates (as a catalyst) were loaded at a time, and, while stirring under a nitrogen atmosphere, the mixture was heated at 130-250° C. until the acid value decreased to 2 or less. The excess monovalent alcohol was refluxed using a reflux condenser and produced water was continuously removed. Then, the container was evacuated to 100 Pa and, finally, to 4.0×10² Pa at 200-230° C., while the distillate was removed. The product was filtered to obtain an aromatic terminal ester type plasticizer having the following features:

| | |
|---|---|
| Viscosity (25° C., mPa · s): | 43400 |
| Acid value: | 0.2 |

### <Sample No. 2 (Aromatic Terminal Ester Sample)>

An aromatic terminal ester having the following features was prepared in the same manner as Sample No. 1 except that 410 parts of phthalic acid, 610 parts of benzoic acid, 341 parts of ethylene glycol and 0.35 parts of tetra-isopropyl titanates (as a catalyst) were used.

| | |
|---|---|
| Viscosity (25° C., mPa · s): | 31000 |
| Acid value: | 0.1 |

### <Sample No. 3 (Aromatic Terminal Ester Sample)>

An aromatic terminal ester having the following features was prepared in the same manner as Sample No. 1 except that 410 parts of phthalic acid, 610 parts of benzoic acid, 418 parts of 1,2-dihydroxypropane and 0.35 parts of tetra-isopropyl titanates (as a catalyst) were used.

| | |
|---|---|
| Viscosity (25° C., mPa · s): | 38000 |
| Acid value: | 0.05 |

### <Sample No. 4 (Aromatic Terminal Ester Sample)>

An aromatic terminal ester having the following features was prepared in the same manner as Sample No. 1 except that 410 parts of phthalic acid, 610 parts of benzoic acid, 418 parts of 1,3-dihydroxypropane and 0.35 parts of tetra-isopropyl titanates (as a catalyst) were used.

| | |
|---|---|
| Viscosity (25° C., mpa · s): | 37000 |
| Acid value: | 0.05 |

Although concrete compounds of the aromatic terminal ester type plasticizer according to the present invention are shown below, the present invention is not limited to these.

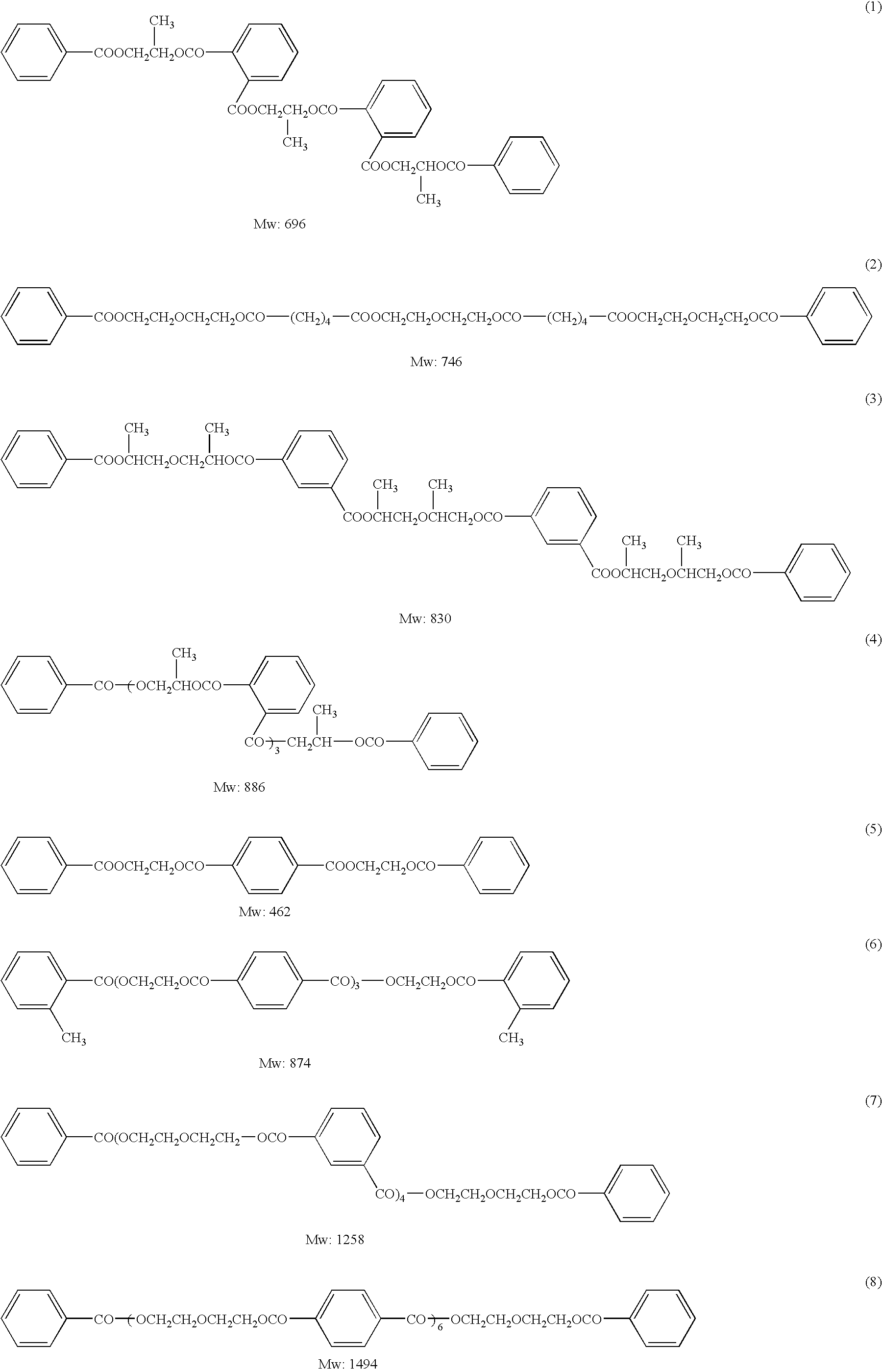

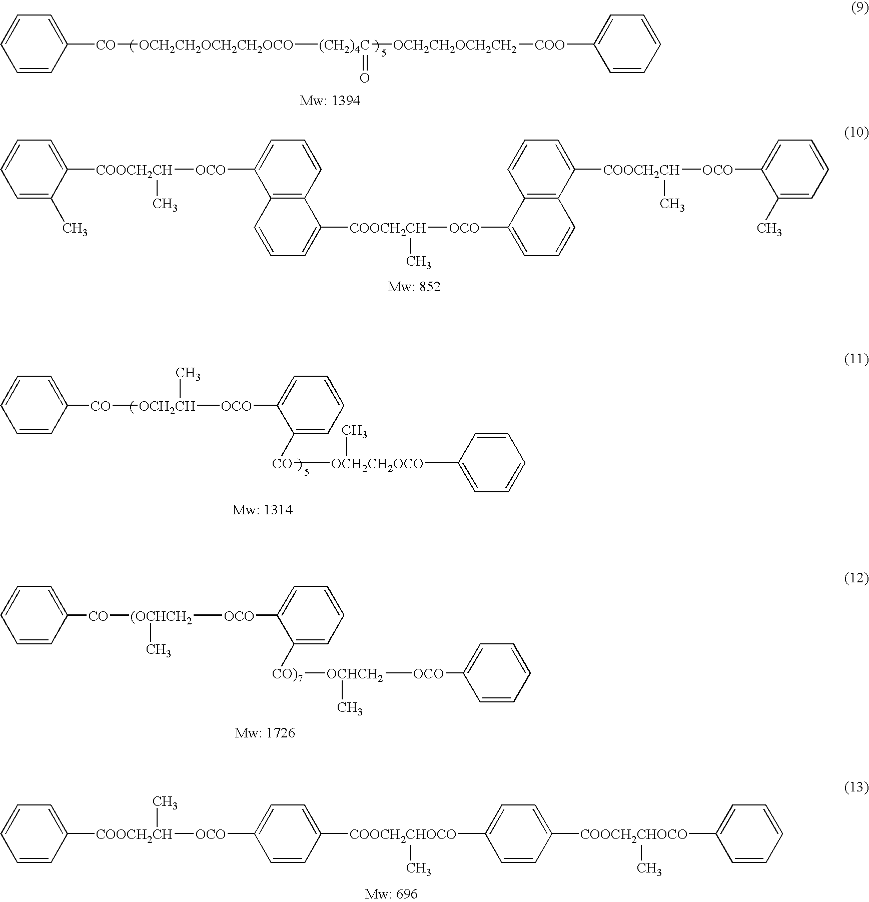

These plasticizers can be used alone or mixed with two or more kinds. The used amount of plasticizers of 1% by weight or less for cellulose ester is not preferable, because the effect to reduce the moisture vapor transmission of a film is small. On the other hand, if the used amount exceeds 20% by weight, the plasticizers may cause bleed-out and the physical properties of a film may deteriorate. Therefore, the used amount is preferably 1 to 20% by weight, more preferably 6 to 16 t by weight, and still more preferably 8 to 13% by weight.

The ultraviolet absorber preferably used for the present invention is explained.

Examples of UV absorbing agents include: an oxybenzophenone based compound, a benzotriazol based compound, a salicylic acid ester based compound, a benzophenone based compound, a cyanoacrylate based compound, and a nickel complex salt based compound. However, the UV absorbing agents are not limited these examples, the other UV absorbing agents may be also used.

As concrete examples, the following compounds can be listed, for example.
UV-1: 2-(2′-hydroxy-5′-methylphenyl)benzotriazol
UV-2: 3′,5′-di-tert-butylphenyl)benzotriazol
UV-3: 2-(2′-hydroxy-3′-tert-butyl-5′-methylphenyl)benzotriazol
UV-4: 2-(2′-hydroxy-3′,5′-di-tert-butylphenyl)-5-chlorobenzotriazol
UV-5: 2-(2′-hydroxy-3′-(3″,4″,5″,6″-tetrahydrophthalimidomethyl)-5′-methylphenyl)benzotriazol
UV-6: 2,2-methylene bis(4-(1,1,3,3-tetramethylbutyl)-6-(2H-benzotriazol-2-yl)phenol)
UV-7: 2-(2′-hydroxy-3′-tert-butyl-5′-methylphenyl)-5-chlorobenzotriazol
UV-8: 2,4-dihydroxybenzophenone
UV-9: 2,2-dihydroxy-4-methoxy benzophenone
UV-10: 2-hydroxy-4-methoxy-5-sulfobenzophenone
UV-11: Bis(2-methoxy-4-hydroxy-5-benzoyl phenylmethane)

Desirable ultraviolet absorbers are excellent in the absorbing power of ultraviolet rays with a wavelength of 370 nm or less and absorb little visible light with a wavelength not less than 400 nm from the viewpoint of good liquid crystal displaying ability. AS the ultraviolet absorbing ability of the optical film according to the present invention, the transmittance to light with a wavelength of 380 nm is desirably 10 W or less, more desirably less than 6%, still more desirably 0 to less than 4%.

The content of the ultraviolet absorber used for an optical film is used as a suitable additive amount in accordance with a setup of the transmittance of light with a wavelength of 380 nm.

As such an antioxidant, a hindered-phenol type compound is used preferably. For example, 2,6-di-t-butyl-p-cresol, a penta ERIS retail-tetrakis[3-(3,5-di-t-butyl-4-hydroxyphenyl)propionate], triethylene glycol-bis[3-(3-t-butyl-5-methyl-4-hydroxyphenyl) propionate], 1,6-dihydroxyhexane-bis[3-(3,5-di-t-butyl-4-hydroxyphenyl) propionate], 2,4-bis-(n-octylthio)-6-(4-hydroxy-3,5-di-t-butyl anilino)-1,3,5-triazine, 2,2-chio-diethylenebis[3-(3,5-di-t-butyl-4-hydroxyphenyl) propionate], Octadecyl-3-(3,5-di-t-butyl-4-hydroxyphenyl) propionate, N,N′-hexamethylene bis(3,5-di-t-butyl-4-hydroxy-hydrocinnamide), 1,3,5-trimethyl-2,4,6-tris(3,5-di-t-butyl-4-hydroxy benzyl)benzene, tris-(3,5-di-t-butyl-4-hydroxy benzyl)-isocyanurate, etc. may be listed. In particular, 2,6-di-t-butyl-p-cresol, a penta erisretil-tetrakis[3-(3,5-di-t-butyl-4-hydroxyphenyl)propionate], and a triethylene glycol-bis[3-(3-t-butyl-5-methyl-4-hydroxyphenyl) propionate] are desirable. Moreover, for example, phosphorus type processing stabilizers, such as metal deactivator of hydrazine types, such as an N,N′-bis[3-(3,5-di-t-butyl-4-hydroxyphenyl) propionyl]hydrazine, and tris(2,4-di-t-butylphenyl) phosphight may be used together. As an added amount of these compound, an added amount of 1 ppm to 1.0% at a mass rate to a cellulose derivative is desirable, and 10 to 1000 ppm are still more desirable.

These antioxidants are also called deterioration prevention agent. When a liquid crystal image display device is placed on the condition of high humidity and high temperature, the deterioration of a cellulose ester film may take place. In this case, the antioxidant has a role to delay or prevent the decomposition of a cellulose ester film by halogen of a remaining solvent in the cellulose ester film or phosphoric acid of a phosphoric acid system plasticizer. Therefore, it may be preferable to make the antioxidant to be contained in the cellulose ester film.

Also, when laminating this film in multilayer by the producing method of the present invention, it is possible to obtain a uniform optical film in which each layer has no unevenness.

Thus, in the present invention, it is possible to provide an optical film in which thin layers having various functions are formed.

In the present invention, as an antistatic layer or a conductive layer, there may be provided 0.1 to 2 μm thickness thin layers on which metal oxide particles and conductive resin particles such as crosslinking cation polymer are coated.

Especially, the optical film obtained by the producing method of optical thin films according to the present invention is useful as a polarizing plate protective film, and a polarizing plate can be produced by a well-known method by the use of these. Since thin films in these optical films have high homogeneity, the optical films can be used preferably for various display units, whereby the outstanding display performance can be obtained.

In the optical film according to the present invention, a hard coat layer, an antiglare layer, antireflection layer, an antistatic layer, a conductive layer, a light diffusion layer, an adhesive layer, an antifouling layer, an orientation layer, a liquid crystal layer, an optical anisotropy layer, etc. can be provided alone or in suitable combination, if needed.

In a liquid crystal display, it is desirable to arrange a basal plate containing liquid crystal usually between two polarizing plates. At this time, especially, since a hard coat layer, an antiglare layer, and antireflection layer are provided on a polarizing plate protective film at the uppermost surface of a display side of a liquid crystal display, it may be especially preferable to use a polarizing plate at this part.

### (Hard Coat Layer)

In the lengthy film which is subjected to a treatment according to the present invention, it is desirable to provide a hard coat layer as a functional layer.

In the optical film of the present invention, it is desirable to provide antireflection layers (a high refractive index layer, a low refractive index layer, etc.) on this hard coat layer so as to constitute an antireflection film.

An actinic ray curable resin layer is preferably used as a hard coat layer.

The actinic ray curable resin layer refers to a layer which contains, as a main component, a resin cured through a crosslinking reaction when exposed to actinic rays such as UV light or electron beams. The actinic ray curable resin layer preferably contains an ethylenically unsaturated monomer, which is exposed to actinic rays such as UV light or electron beams and cured to form a hard coat layer. Although UV (ultraviolet) ray curable resins, electron-rays curable resin, etc. are listed as a typical one as actinic ray curable resin, the resin hardened by UV irradiation is desirable.

Listed as UV curable resins may be, for example, UV curable urethane acrylate resins, UV curable polyester acrylate resins, UV curable epoxy acrylate resins, UV curable polyol acrylate resins, or UV curable epoxy resins.

The UV curable urethane acrylate resins are easily prepared in such a manner that acrylate based monomers having a hydroxyl group such as 2-hydroxyethyl acrylate, 2-hydroxyethyl methacrylate (hereinafter, acrylate includes acrylate itself and methacrylate, and acrylate represents both), or 2-hydroxypropyl acrylate are allowed to react with the product which is commonly prepared by allowing polyester polyols to react with isocyanate monomers or prepolymers. For example, those described in Japanese Patent O.P.I. Publication No. 59-151110 can be used.

For example, preferably employed is a mixture comprising 100 parts of Unidick 17-806 (manufactured by Dainippon Ink and Chemicals Inc.) and one part of Coronate L (manufactured by Nippon Urethane Industry Co., Ltd.).

The UV ray curable polyesteracrylate resins include those prepared easily by reacting a polyesterpolyol with 2-hydroxyethylacrylate or 2-hydroxypropylacrylate, disclosed for example, in Japanese Patent O.P.I. Publication No. 59-151112.

Examples of the UV ray curable epoxyacrylate resin include those prepared by reacting an epoxyacrylate oligomer in the presence of a reactive diluting agent and a photoinitiator, disclosed for example, in Japanese Patent O.P.I. Publication No. 1-105738.

Examples of the UV ray curable polyol acrylate resin include trimethylolpropane triacrylate, ditrimethylolpropane tetraacrylate, pentaerythritol triacrylate, pentaerythritol tetraacrylate, dipentaerythritol hexaacrylate or alkyl-modified dipentaerythritol pentaacrylate.

The photoinitiators for the UV ray curable resins include benzoine or its derivative, or acetophenones, benzophenones, hydroxy benzophenones, Michler's ketone, α-amyloxime esters, thioxanthones or their derivatives. an oxime ketone derivative, a benzophenone derivative or a thioxanthone derivative. These photoinitiators may be used together with a photo-sensitizer. The above photoinitiators also work as a photo-sensitizer. Sensitizers such as n-butylamine, triethylamine and tri-n-butylphosphine can be used in photo-reaction of epoxyacrylates. The content of the photoinitiators or sensitizers in the UV ray curable resin layer is 0.1 to 15 parts by weight, and preferably 1 to 10 parts by weight, based on the 100 parts by weight of the UV ray curable resin layer.

The polymerizable monomers having one unsaturated double bond in the molecule include methyl acrylate, ethyl acrylate, butyl acrylate, benzyl acrylate, cyclohexyl acrylate, vinyl acetate, and styrene. The polymerizable monomers having two or more unsaturated double bonds in the molecule include ethylene glycol diacrylate, propylene glycol diacrylate, divinylbenzene, 1,4-cyclohexane diacrylate, 1,4-cyclohexyldimethyl diacrylate, trimethylol propane triacrylate, and pentaerythritol tetraacrylate.

The UV curable resins available on the market utilized in the present invention include Adekaoptomer KR, BY Series such as KR-400, KR-410, KR-550, KR-566, KR-567 and BY-320B (manufactured by Asahi Denka Co., Ltd.); Koeihard A-101-KK, A-101-WS, C-302, C-401-N, C-501, M-101, M-102, T-102, D-102, NS-101, FT-102Q8, MAG-1-P20, AG-106 and M-101-C (manufactured by Koei Kagaku Co., Ltd.); Seikabeam PHC2210 (S), PHC X-9 (K-3), PHC2213, DP-10, DP-20, DP-30, P1000, P1100, P1200, P1300, P1400, P1500, P1600, SCR900 (manufactured by Dainichiseika Kogyo Co., Ltd.); KRM7033, KRM7039, KRM7130, KRM7131, UVECRYL29201 and UVECRYL29202 (manufactured by Daicel U. C. B. Co., Ltd.); RC-5015, RC-5016, RC-5020, RC-5031, RC-5100, RC-5102, RC-5120, RC-5122, RC-5152, RC-5171, RC-5180 and RC-5181 (manufactured by Dainippon Ink & Chemicals, Inc.); Olex No. 340 Clear (manufactured by Chyugoku Toryo Co., Ltd.); Sunrad H-601, RC-750, RC-700, RC-600, RC-500, RC-611 and RC-612 (manufactured by Sanyo Kaseikogyo Co., Ltd.); SP-1509 and SP-1507 (manufactured by Syowa Kobunshi Co., Ltd.); RCC-15C (manufactured by Grace Japan Co., Ltd.) and Aronix M-6100, M-8030 and M-8060 (manufactured by Toagosei Co., Ltd.).

Concrete examples include trimethylol propane triacrylate, ditrimethylol propane tetracrylate, pentaerythritol triacrylate, pentaerythritol tetracrylate, dipentaerythritol hexaacrylate and alkyl modified dipentaerythritol pentaacrylate.

These actinic ray curable resin layers can be applied by any method well known in the art, for example: a gravure coater, a dip coater, a reverse coater, a die coater and ink jet printing.

Light sources to cure layers of UV curable-resin by photo-curing reaction are not specifically limited, and any light source may be used as far as UV ray is generated. For example, a low-pressure mercury lamp, a medium-pressure mercury lamp, a high-pressure mercury lamp, an ultrahigh-pressure mercury lamp, a carbon arc lamp, a metal halide lamp and a xenon lamp may be utilized. An air cooling or a water cooling light source is preferably used. The preferable irradiation quantity of light may be changed depending on the type of lamp, however, it is preferably from 5 to 500 mJ/cm², and more preferably from 20 to 150 mJ/cm².

Moreover, it is desirable to reduce oxygen concentration to 0.01% to 2% by nitrogen purge in irradiating section.

Irradiation of an actinic ray is preferably carried out under tension in the longitudinal direction of the film and more preferably under tension in both the lateral and the longitudinal directions. The preferable tension is from 30 to 300 N/m. The method to provide tension is not specifically limited and following methods are preferably used a method of providing tension while the film is being transported over back rolls, and a method using a tenter to give tension in the lateral direction or in biaxial directions. A cellulose ester film exhibiting a superior flatness can be obtained using these methods.

An organic solvent used for a coating solution of a UV curable-resin can be selected from, for example, the hydrocarbon series (toluene and xylene), the alcohol series (methanol, ethanol, isopropanol, butanol and cyclohexanol), the ketone series (acetone, methyl ethyl ketone and isobutyl ketone), the ester series (methyl acetate, ethyl acetate and methyl lactate), the glycol ether series and other organic solvents. These organic solvents may be also used in combination. The above mentioned organic solvents preferably contain propylene glycol monoalkyl ether (the alkyl having 1 to 4 carbon atoms) or propylene glycol monoalkyl ether acetate (the alkyl having 1 to 4 carbon atoms) in an amount of 5% by weight or more, and more preferably from 5 to 80% by weight.

The present invention is effective especially in the case of using a hard coat layer coating liquid containing acrylate system ultraviolet curing resin and the above-mentioned organic solvent.

In a coating solution of a UV ray-curable resin, a silicon compound such as a polyether modified silicone oil, is preferably added. The number average molecular weight of the polyether modified silicone oil is preferably from 1,000 to 100,000 and more preferably from 2,000 to 50,000. Addition of the polyether modified silicone oil with a number average molecular weight of less than 1,000 may lower the drying rate of the coating solution, while that of more than 100,000 may be difficult to bleed out at the surface of the coated film.

Silicon compounds available on the market include, for example: DKQ8-779 (a trade name of Dow Corning Corp.), SF3771, SF8410, SF8411, SF8419, SF8421, SF8428, SH200, SH510, SH1107, SH3749, SH3771, BX16-034, SH3746, SH3749, SH8400, SH3771M, SH3772M, SH3773M, SH3775M, BY-16-837, BY-16-839, BY-16-869, BY-16-870, BY-16-004, BY-16-891, BY-16-872, BY-16-874, BY22-008M, BY22-012M, FS-1265 (all being trade names of Dow Corning Toray Silicone Co., Ltd.), KF-101, KF-100T, KF351, KF352, KF353, KF354, KF355, KF615, KF618, KF945, KF6004, siliconeX-22-945, X22-160AS (all being trade names of Shin-Etsu Chemical Co., Ltd.), XF3940, XF3949 (both being trade names of Toshiba Silicones Co., Ltd.), DISPARLONLS-009 (a trade name of Kusumoto Chemicals Ltd.), GLANOL410 (a trade name of Kyoeisha Chemicals Co., Ltd.), TSF4440, TSF4441, TSF4445, TSF4446, TSF4452, TSF4460 (all being trade names of GE Toshiba Silicones Co., Ltd.), BYK-306, BYK-330, BYK-307, BYK-341, BYK-344, BYK-361 (all being trade names of BYK-Chemie Japan KK), L Series (L-7001, L-7006, L-7604 and L-9000), Y Series and FZ Series (FZ-2203, FZ-2206 and FZ-2207) (all from Nippon Unicar Co., Ltd.).

These compositions may improve the coating ability of a coating solution onto a substrate or an under coat layer. These compounds used in the top layer of film may contribute to improvement of scratch resistance of the film as well as water-resistance, oil-resistance and anti-stain properties of the film. The content of the silicon compound is preferably from 0.01 to 3% by weight based on the solid components in the coating solution.

The aforementioned coating methods are also used as coating method of a UV ray-curable resin layer coating solution. The wet thickness of the coated UV-curable resin layer is preferably from 0.1 to 30 μm and more preferably from 0.5 to 15 μm. The dry thickness of the coated UV-curable resin layer is preferably from 0.1 to 20 μm and more preferably from 1 to 10 μm.

The UV ray-curable resin layer is preferably irradiated with UV rays during or after drying. The duration of UV ray irradiation is preferably from 0.1 seconds to 5 minutes in order to secure the exposure amount from 5 to 150 mJ/cm² as mentioned above. In view of working efficiency and hardening efficiency of the UV-curable resin layer, the duration is more preferably from 0.1 to 10 seconds.

Intensity of the actinic ray is preferably from 50 to 150 mW/cm² on the irradiated surface.

The UV-cured resin layer thus obtained may preferably contain inorganic or organic microparticles in order to attain the following characteristics, preventing blocking, improving scratch resistance, providing an antiglare property and optimizing the reflective index.

Examples of inorganic microparticles used for the hard coat layer, include, for example: silicon oxide, titanium oxide, aluminum oxide, zirconium oxide, magnesium oxide, calcium carbonate, talc, clay, calcined kaolin, calcined calcium silicate, hydrated calcium silicate, aluminum silicate, magnesium silicate and calcium phosphate. Among these, silicon oxide, titanium oxide, aluminum oxide, zirconium oxide, magnesium oxide are specifically preferable.

Organic microparticles include, for example: microparticles of polymethacrylic acid methyl acrylate resin, acryl styrene based resin, polymethyl methacrylate resin, silicon based resin, polystyrene based resin, polycarbonate resin, benzoguanamine based resin, melamine based resin, polyolefin based resin, polyester based resin, polyamide based resin, polyimide based resin and polyfluorinated ethylene based resin. Specifically preferable organic microparticles include, for example: microparticles of cross-linked polystylene (such as SX-130H, SX-200H and SX-350H manufactured by Soken Chemical & Engineering Co., Ltd.) and polymethyl methacrylate (such as MX150 and MX300 manufactured by Soken Chemical & Engineering Co., Ltd.).

The average particle diameter of the microparticles is preferably from 0.005 to 5 μm and specifically preferably from 0.01 to 1 μm. As for the ratio of ultraviolet ray curable resin composition and particle powder, it is desirable to blend particle powder so as to become 0.1 to 30 parts by weight to 100 parts by weight of the resin composition.

Moreover, the ultraviolet ray curable resin layer is a clear hard coat layer whose center line average roughness (Ra) specified by JIS B 0601 is 1 to 50 nm, or an antiglare layer in which Ra is about 0.1 to 1 μm. The center-line average roughness (Ra) is preferably measured by means of a surface roughness meter using interference of light, for example, RST/PLUS manufactured by WYKO Co., Ltd.

The hard coat layer of the present invention may preferably contain an antistatic agent. For example, preferable are an electrically conductive material containing as a main ingredient at least one of the element selected from the group of Sn, Ti, In, Al, Zn, Si, Mg, Ba, Mo, W and V, and having a volume resistivity of not more than 10⁷ Ω·cm.

Examples of the antistatic agent also include: oxides and complex oxides of the above described elements.

Examples of a metal oxide include: ZnO, TiO₂, SnO₂, Al₂O₃, In₂O₃, SiO₂, MgO, BaO, MoO₂, V₂O₅ and complex metal oxides thereof. Of these, specifically preferable are, for example, ZnO, In₂O₃, TiO₂, and SnO₂. As examples of introduction of foreign element, effective are, (i) introduction of, for example, Al or In in ZnO; (ii) introduction of, for example, Nb or Ta in TiO₂; and (iii) introduction of, for example, Sb, Nb or a halogen atom in SnO₂. The amount of the foreign element is preferably 0.01 to 25 mol % and specifically preferably 0.1 to 15 mol %. The volume resistivity of these conductive metal oxide powder is preferably 10⁷ Ω·cm or less and specifically preferably 10⁵ Ω·cm or less.

Moreover, it is also desirable to prepare a ultraviolet ray curable resin layer having a concavo-convex by an embossing method using a molding roll (embossing roll) on the surface of which concavo-convex are formed, and make this resin layer into an antiglare layer

### (Antireflection Layer)

In the optical film of the present invention, it is desirable to provide an antireflection layer further as a functional layer on the above-mentioned hard coat layer. It is especially desirable that it is a low refractive index layer containing hollow particles.

### (Low Refractive Index Layer)

The low refractive index layer used for the present invention desirably contains hollow particles, in addition, more desirably contains silicon alkoxide, a silane coupling agent, a hardening agent, etc.

### <Hollow Particles>

It is desirable that a low refractive index layer contains the following hollow particles.

The hollow particles include (1) composite particles made of porous particle and coated layer arranged on this porous particle surface and (2) hollow particles that have hollow in their interior and are filled with contents of solvent, gas or porous substances. Here, a low refractive index layer coating solution may contain (1) composite particles or (2) hollow particles or may contain both.

Herein, hollow particles are particles the interior of which is provided with a hollow, and the hollow is surrounded by a particle wall. The interior of the hollow is filled with the contents such as a solvent, a gas or a porous substance which have been utilized in preparation. The mean particle size of such hollow particles is preferably in a range of 5 to 300 nm and preferably of 10 to 200 nm. The mean particle size of hollow particles utilized is appropriately selected depending on the thickness of the formed transparent cover film and is preferably in a range of ⅔ to 1/10 of the layer thickness of the transparent cover film of such as a formed low refractive index layer. These hollow particles are preferably utilized in a state of being dispersed in a suitable medium to form a low refractive index layer. As dispersing medium, water, alcohol (such as methanol, ethanol and isopropanol), ketone (such as methyl ethyl ketone and methyl isobutyl ketone) and ketone alcohol (such as diacetone alcohol) are preferable.

A thickness of the cover layer of a complex particle or the thickness of the particle wall of a hollow particle is preferably in a range of 1 to 20 nm and more preferably in a range of 2 to 15 nm. In the case of a complex particle, when a thickness of the cover layer is less than 1 nm, a particle may not be completely covered, whereby an effect of a low refractive index may not be obtained. Further, when a thickness of the cover layer is over 20 nm, the porosity (a micro-pour volume) of a complex particle may be decreased, resulting in an insufficient effect of a low refractive index. Further, in the case of a hollow particle, particle shape may not be kept when a thickness of the particle wall is less than 1 nm, while an effect of a low refractive index may not be obtained when a thickness exceeds 20 nm.

The cover layer of a complex particle or the particle wall of a hollow particle is preferably comprised of silica as a primary component. Further, components other than silica may be incorporated and specific examples include such as Al₂O₃, B₂O₃, TiO₂, ZrO₂, SnO₂, CeO₂, P₂O₃, Sb₂O₃, MoO₃, ZnO₂, and WO₃. A porous particle to constitute a complex particle includes those comprised of silica; those comprised of silica and an inorganic compound other than silica and those comprised of such as CaF₂, NaF, NaAlF₆ and MgF. Among them, specifically preferable is a porous particle comprised of a complex oxide of silica and an inorganic compound other than silica. An inorganic compound other than silica includes one type or at least two types of such as Al₂O₃, B₂O₃, TiO₂, ZrO₂, SnO₂, CeO₂, P₂O₃, Sb₂O₃, MoO₃, ZnO₂ and WO₃. In such a porous particle, mole ratio MOₓ/SiO₂ is preferably in a range of 0.0001-1.0 and more preferably of 0.001-0.3 when silica is represented by SiO₂ and an inorganic compound other than silica is represented by an equivalent oxide (MOₓ). A porous particle having mole ratio MOₓ/SiO₂ of less than 0.0001 is difficult to be prepared and the pore volume is small to unable preparation of a particle having a low refractive index. Further, when mole ratio MOₓ/SiO₂ of a porous particle is over 1.0, the pore volume becomes large due to a small ratio of silica and it may be further difficult to prepare a particle having a low refractive index.

A pore volume of such a porous particle is preferably in a range of 0.1 to 1.5 ml/g and more preferably of 0.2 to 1.5 ml/g. When the pore volume is less than 0.1 ml/g, a particle having a sufficiently decreased refractive index cannot be prepared, while, when it is over 1.5 ml/g, strength of a particle is decreased and strength of the obtained cover film may be decreased.

Herein, the pore volume of such a porous particle can be determined by a mercury pressurized impregnation method. Further, a content of a hollow particle includes such as a solvent, a gas and a porous substance which have been utilized at preparation of the particle. In a solvent, such as a non-reacted substance of a particle precursor which is utilized at hollow particle preparation and a utilized catalyst may be contained. Further, a porous substance includes those comprising compounds exemplified in the aforesaid porous particle. These contents may be those comprising single component or mixture of plural components.

As a manufacturing method of such hollow particles, a preparation method of complex oxide colloidal particles, disclosed in paragraph Nos. [0010] through [0033] of JP-A No. 7-133105 (JP-A refers to Japanese Patent Publication Open to Public Inspection), is suitably applied. Specifically, in the case of a complex particle being comprised of silica and an inorganic compound other than silica, the hollow particle is manufactured according to the following first to third processes.

First Process: Preparation of Porous Particle Precursor

In the first process, alkaline aqueous solutions of a silica raw material and of an inorganic compound raw material other than silica are independently prepared or a mixed aqueous solution of a silica raw material and an inorganic compound raw material other than silica is prepared, in advance, and this aqueous solution is gradually added into an alkaline aqueous solution having a pH of not less than 10 while stirring depending on the complex ratio of the aimed complex oxide, whereby a porous particle precursor is prepared.

As a silica raw material, silicate of alkali metal, ammonium or organic base is utilized. As silicate of alkali metal, utilized are sodium silicate (water glass) and potassium silicate. Organic base includes quaternary ammonium salt such as tetraethylammonium salt; and amines such as monoethanolamine, diethanolamine and triethanolamine. Herein, an alkaline solution, in which such as ammonia, quaternary ammonium hydroxide or an amine compound is added in a silicic acid solution, is also included in silicate of ammonium or silicate of organic base.

Further, as a raw material of an inorganic compound other than silica, utilized is an alkali-soluble inorganic compound.

The pH value of a mixed aqueous solution changes simultaneously with addition of these aqueous solutions, however, operation to control the pH value into a specific range is not necessary. The aqueous solution finally takes a pH value determined by the types and the mixing ratio of inorganic oxide. At this time, the addition rate of an aqueous solution is not specifically limited. Further, dispersion of a seed particle may be also utilized as a starting material at the time of manufacturing of complex oxide particles. Said seed particles are not specifically limited, however, particles of inorganic oxide such as SiO₂, Al₂O₃, TiO₂ or ZrO₂ or complex oxide thereof are utilized, and generally sol thereof can be utilized. Further, a porous particle precursor dispersion prepared by the aforesaid manufacturing method may be utilized as a seed particle dispersion. In the case of utilizing a seed particle dispersion, after the pH of a seed particle dispersion is adjusted to not lower than 10, an aqueous solution of the aforesaid compound is added into said seed particle dispersion while stirring. In this case pH control of dispersion is not necessarily required. By utilizing seed particles in this manner, it is easy to control the particle size of prepared particles and particles having a uniform size distribution can be obtained.

A silica raw material and an inorganic compound raw material, which were described above, have a high solubility at alkaline side. However, when the both are mixed in pH range showing this high solubility, the solubility of an oxoacid ion such as a silicic acid ion and an aluminic acid ion will decrease, resulting in precipitation of these complex products to form particles or to be precipitated on a seed particle causing particle growth. Therefore, at the time of precipitation and growth of particles, pH control in a conventional method is not necessarily required.

A complex ratio of silica and an inorganic compound other than silica is preferably in a range of 0.05-2.0 and more preferably of 0.2-2.0, based on mole ratio MOₓ/SiO₂, when an inorganic compound other than silica is converted to oxide (MOₓ) In this range, the smaller is the ratio of silica, increases the pore volume of porous particles. However, a pore volume of porous particles barely increases even when the mole ratio is over 2.0. On the other hand, a pore volume becomes small when the mole ratio is less than 0.05. In the case of preparing hollow particles, mole ratio of MOₓ/SiO₂ is preferably in a range of 0.25-2.0.

Second Process: Elimination of Inorganic Compounds other than Silica from Porous Particles

In the second process, at least a part of inorganic compounds other than silica (elements other than silica and oxygen) is selectively eliminated from the porous particle precursor prepared in the aforesaid first process. As a specific elimination method, inorganic compounds in a porous particle precursor are dissolving eliminated by use of such as mineral acid and organic acid, or ion-exchanging eliminated by being contacted with cationic ion-exchange resin.

Herein, a porous particle precursor prepared in the first process is a particle having a network structure in which silica and an inorganic compound element bond via oxygen. In this manner, by eliminating inorganic compounds (elements other than silica and oxygen) from a porous particle precursor, porous particles, which are more porous and have a large pore volume, can be prepared. Further, hollow particles can be prepared by increasing the elimination amount of inorganic compound (elements other than silica and oxygen) from a porous particle precursor.

Further, in advance to elimination of inorganic compounds other than silica from a porous particle precursor, it is preferable to form a silica protective film by adding a silicic acid solution which contains a silane compound having a fluorine substituted alkyl group, and is prepared by dealkalization of alkali metal salt of silica; or a hydrolyzable organosilicon compound, in a porous particle precursor dispersion prepared in the first process. The thickness of a silica protective film is 0.5-15 nm. Herein, even when a silica protective film is formed, since the protective film in this process is porous and has a thin thickness, it is possible to eliminate the aforesaid inorganic compounds other than silica from a porous particle precursor.

By forming such a silica protective film, the aforesaid inorganic compounds other than silica can be eliminated from a porous particle precursor while keeping the particle shape as it is. Further, at the time of forming a silica cover layer described later, the pore of porous particles is not blocked by a cover layer, and thereby the silica cover layer described later can be formed without decreasing the pore volume. Herein, when the amount of inorganic compound to be eliminated is small, it is not necessary to form a protective film because the particles will never be broken.

Further, in the case of preparation of hollow particles, it is preferable to form this silica protective film. At the time of preparation of hollow particles, a hollow particle precursor, which is comprised of a silica protective film, a solvent and insoluble porous solid within said silica protective film, is obtained when inorganic compounds are eliminated, and hollow particles are formed, by making a particle wall from a formed cover layer, when the cover layer described later is formed on said hollow particle precursor.

The amount of a silica source added to form the aforesaid silica protective film is preferably in a range to maintain the particle shape. When the amount of a silica source is excessively large, it may become difficult to eliminate inorganic compounds other than silica from a porous particle precursor because a silica protective film becomes excessively thick. As a hydrolizable organosilicon compound utilized to form a silica protective film, alkoxysilane represented by formula RₙSi(OR′)₄₋ₙ [R, R′: a hydrocarbon group such as an alkyl group, an aryl group, a vinyl group and an acryl group; n=0, 1, 2 or 3] can be utilized. Fluorine-substituted tetraalkoxysilane, such as tetramethoxysilane, tetraethoxysilane and tetraisopropoxysilane, is specifically preferably utilized.

As an addition method, a solution, in which a small amount of alkali or acid as a catalyst is added into a mixed solution of these alkoxysilane, pure water and alcohol, is added into the aforesaid dispersion of porous particles, and silicic acid polymer formed by hydrolysis of alkoxysilane is precipitated on the surface of inorganic oxide particles. At this time, alkoxysilane, alcohol and a catalyst may be simultaneously added into the dispersion. As an alkali catalyst, ammonia, hydroxide of alkali metal and amines can be utilized. Further, as an acid catalyst, various types of inorganic acid and organic acid can be utilized.

In the case that a dispersion medium of a porous particle precursor is water alone or has a high ratio of water to an organic solvent, it is also possible to form a silica protective film by use of a silicic acid solution. In the case of utilizing a silicic acid solution, a predetermined amount of a silicic acid solution is added into the dispersion and alkali is added simultaneously, to precipitate silicic acid solution on the porous particle surface. Herein, a silica protective film may also be formed by utilizing a silicic acid solution and the aforesaid alkoxysilane in combination.

Third Process: Formation of Silica Cover Layer

In the third process, by addition of such as a hydrolyzable organosilicon compound containing a silane compound provided with a fluorine substituted alkyl group, or a silicic acid solution, into a porous particle dispersion (into a hollow particle dispersion in the case of hollow particles), which is prepared in the second process, the surface of particles is covered with a polymer substance of such as a hydrolyzable organosilicon compound or a silicic acid solution to form a silica cover layer.

As a hydrolyzable organosilicon compound utilized for formation of a silica cover layer, alkoxysilane represented by formula RₙSi(OR′)₄₋ₙ [R, R′: a hydrocarbon group such as an alkyl group, an aryl group, a vinyl group and an acryl group; n=0, 1, 2 or 3], as described before, can be utilized. Tetraalkoxysilane such as tetramethoxysilane, tetraethoxysilane and tetraisopropoxysilane are specifically preferably utilized.

As an addition method, a solution, in which a small amount of alkali or acid as a catalyst is added into a mixed solution of these alkoxysilane, pure water and alcohol, is added into the aforesaid dispersion of porous particles (a hollow particle precursor in the case of hollow particles), and silicic acid polymer formed by hydrolysis of alkoxysilane is precipitated on the surface of porous particles (a hollow particle precursor in the case of hollow particles). At this time, alkoxysilane, alcohol and a catalyst may be simultaneously added into the dispersion. As an alkali catalyst, ammonia, hydroxide of alkali metal and amines can be utilized. Further, as an acid catalyst, various types of inorganic acid and organic acid can be utilized.

In the case that a dispersion medium of porous particles (a hollow particle precursor in the case of hollow particles) is water alone or a mixed solution of water with an organic solvent having a high ratio of water to an organic solvent, it is also possible to form a cover layer by use of a silicic acid solution. A silicic acid solution is an aqueous solution of lower polymer of silicic acid which is formed by ion-exchange and dealkalization of an aqueous solution of alkali metal silicate such as water glass.

A silicic acid solution is added into a dispersion of porous particles (a hollow particle precursor in the case of hollow particles), and alkali is simultaneously added to precipitate silicic acid lower polymer on the surface of porous particles (a hollow particle precursor in the case of hollow particles). Herein, silicic acid solution may be also utilized in combination with the aforesaid alkoxysilane to form a cover layer. The addition amount of an organosilicon compound or a silicic acid solution, which is utilized for cover layer formation, is as much as to sufficiently cover the surface of colloidal particles and the solution is added into a dispersion of porous particles (a hollow particle precursor in the case of hollow particles) at an amount to make a thickness of the finally obtained silica cover layer of 1-20 nm. Further, in the case that the aforesaid silica protective film is formed, an organosilicon compound or a silicic acid solution is added at an amount to make a thickness of the total of a silica protective film and a silica cover layer of 1-20 nm.

Next, a dispersion of particles provided with a cover layer is subjected to a thermal treatment. By a thermal treatment, in the case of porous particles, a silica cover layer, which covers the surface of porous particles, becomes minute to prepare a dispersion of complex particles comprising porous particles covered with a silica cover layer. Further, in the case of a hollow particle precursor, the formed cover layer becomes minute to form a hollow particle wall, whereby a dispersion of hollow particles provided with a hollow, the interior of which is filled with a solvent, a gas or a porous solid, is prepared.

Thermal treatment temperature at this time is not specifically limited provided being so as to block micro-pores of a silica cover layer, and is preferably in a range of 80 to 300° C. At a thermal treatment temperature of lower than 80° C., a silica cover layer may not become minute to completely block the micro-pores or the treatment time may become long. Further, when a prolonged treatment at a thermal treatment temperature of higher than 300° C. is performed, particles may become minute and an effect of a low refractive index may not be obtained.

A refractive index of inorganic particles prepared in this manner is as low as less than 1.44. It is estimated that the refractive index becomes low because such inorganic particles maintain porous property in the interior of porous particles or the interior is hollow.

It is preferable that other than minute hollow particles, the low refractive index layer incorporates hydrolyzed products of alkoxysilicon compounds and condensation products which are formed via the following condensation reaction. It is particularly preferable to incorporate a SiO₂ sol prepared employing the alkoxysilicon compounds represented by following Formula (3) and/or (4) or hydrolyzed products thereof.

R1-Si(OR2)₃ Formula (3)

Si(OR2)₄ Formula (4)

wherein R1 represents a methyl group, an ethyl group, a vinyl group, or an organic group incorporating an acryloyl group, a methacryloyl group, an amino group, or an epoxy group, and R2 represents an methyl group or an ethyl group.

Hydrolysis of silicon alkoxide and silane coupling agents is performed by dissolving the above in suitable solvents. Examples of used solvents include ketones such as methyl ethyl ketone, alcohols such as methanol, ethanol, isopropyl alcohol, or butanol, esters such as ethyl acetate, or mixtures thereof.

Water in a slightly larger amount for hydrolysis is added to a solution prepared by dissolving the above silicon alkoxide or silane coupling agents in solvents, and the resulting mixture is stirred at 15 to 35° C. but preferably 20 to 30° C. for 1 to 48 hours but preferably 3 to 36 hours.

It is preferable to employ catalysts during the above hydrolysis. Preferably employed as such catalysts are acids such as hydrochloric acid, nitric acid, or sulfuric acid. These acids are employed in the form of an aqueous solution at a concentration of 0.001-20.0 N, but preferably 0.005-5.0 N. It is possible to employ water in the above aqueous catalyst solution as water for hydrolysis.

Alkoxysilicon compounds undergo hydrolysis over the specified period of time, and the hydrolyzed alkoxysilicon solution is diluted with solvents, followed by the addition of other necessary additives, whereby a low refractive index layer liquid coating composition is prepared. It is possible to form a low refractive index layer on a substrate by applying the above liquid coating composition onto a substrate such as a film followed by drying.

### <Alkoxysilicon Compounds>

In the present invention, preferred as alkoxysilicon compounds (hereinafter also referred to as alkoxysilanes) employed to prepare the low refractive index layer liquid coating composition are those represented by following Formula (5).

R4-nSi(OR′)n Formula (5)

wherein R′ represents an alkyl group; R represents a hydrogen atom or a univalent substituent; and n represents 3 or 4.

The alkyl groups represented by R′ include groups such as a methyl group, an ethyl group, a propyl group, or a butyl group, which may have a substituent. The substituents are not particularly limited as long as characteristics as an alkoxysilane are maintained. Examples of such substituents include a halogen atom such as fluorine and an alkoxy group, but unsubstituted alkyl groups are more preferred. Particularly preferred are a methyl group and an ethyl group.

The univalent substituents represented by R are not particularly limited, and examples include an alkyl group, a cycloalkyl group, an alkenyl group, an aryl group, an aromatic heterocyclyl group, and a silyl group. Of these, preferred are an alkyl group, a cycloalkyl group, and an alkenyl group. These may be further substituted. Cited as substituents of R are a halogen atom such as a fluorine atom or a chlorine atom, an amino group, an epoxy group, a mercapto group, a hydroxyl group, and an acetoxy group.

Specific preferable examples of the alkoxysilane represented by the above formula include tetramethoxysilane, tetraethoxysilane (TEOS), tetra-n-propoxysilane, tetraisopropoxysilane, tetra-n-butoxysilane, tetra-t-butoxysilane, tetrakis(methoxyethoxy)silane, tetrakis(methoxypropoxy)silane, methyltrimethoxysilane, methyltriethoxysilane, ethyltrimethoxysilane, ethyltriethoxysilane, n-propyltrimethoxysilane, n-propyltriethoxysilane, n-butyltrimethoxysilane, i-butyltrimethoxysilane, n-hexyltrimethoxysilane, 3-glycycloxyproyltrimethoxysilane, 3-aminopropyltriethoxysilane, 2-(3,4-epoxycyclohexyl)ethyltrimethoxysilane, 3-chloropropyltrimethoxysilane, 3-mercaptopropyltrimethoxysilane, acetoxytriethoxysilane, (heptadecafluoro-1,1,2,2-tetrahydrodecyl)trimethoxysilane, (3,3,3-trifluoropropyl)trimethoxysilane, (3,3,3-trifluoropropyl)trimethoxysilane, spentafluorophenylpropyltrimethoxysilane, further vinyltrimethoxysilane, vinyltriethoxysilane, phenyltrimethoxysilane, vinyltrimethoxysilane, and vinyltriethoxysilane.

Further, included may be silicon compounds in the form of oligomers such as SILICATE 40, SILICATE 45, SILICATE 48, and M SILICATE 51, produced by Tamagawa Chemical Co., which are partial condensation products of the above compounds.

Since the above alkoxysilanes incorporate silicon alkoxide group capable of undergoing hydrolysis polycondensation, the network structure of polymer compounds is formed in such a manner that these alkoxysilanes undergo hydrolysis, condensation and crosslinking. The resulting composition is employed as a low refractive index layer liquid coating composition which is applied onto a substrate and dried, whereby a layer uniformly incorporating silicon oxide is formed on the substrate.

It is possible to perform a hydrolysis reaction employing the method known in the art. Hydrophilic alkoxysilanes are dissolved in a mixture of water of the specified amount and hydrophilic organic solvents such as methanol, ethanol, or acetonitrile so that alkoxysilanes are compatible with solvents. After the addition of hydrolysis catalysts, alkoxysilanes undergo hydrolysis and condensation. By performing the hydrolysis and condensation reaction commonly at 10 to 100° C., silicate oligomers in a liquid state, having at least two hydroxyl groups, are formed, whereby a hydrolyzed liquid composition is prepared. It is possible to appropriately control the degree of hydrolysis varying the amount of employed water.

In the present invention, preferred as solvents added to alkoxysilanes together with water are methanol and ethanol since they are less expensive and form a layer exhibiting excellent characteristics and desired hardness. It is possible to employ isopropanol, n-butanol, isobutanol, and octanol, while the hardness of the resulting layer tends to decrease. The amount of solvents is commonly 50 to 400 parts by weight with respect to 100 parts by weight of tetraalkoxysilanes prior to hydrolysis, but is preferably 100 to 250 parts by weight.

The hydrolyzed liquid composition is prepared as described above. The above composition is diluted with solvents, and if desired, added with additives. Subsequently, components required to form a low refractive index layer liquid coating composition are mixed, whereby a low refractive index layer liquid coating composition is prepared.

### (Hydrolysis Catalyst)

Cited as hydrolysis catalysts may be acids, alkalis, organic metals, and metal alkoxides. In the present invention, preferred are inorganic acids such as sulfuric acid, hydrochloric acid, nitric acid, hypochlorous acid, or boric acid, or organic acids. Of these, particularly preferred are nitric acid, carboxylic acids such as acetic acid, polyacrylic acid, benzenesulfonic acid, paratoluenesulfonic acid, and methylsulfonic acid. Of these, most preferably employed are nitric acid, acetic acid, citric acid, and tartaric acid. Other than above citric acid and tartaric acid, also preferably employed are levulinic acid, formic acid, propionic acid, malic acid, succinic acid, methylsuccinic acid, fumaric acid, oxalacetic acid, pyruvic acid, 2-oxoglutaric acid, glycolic acid, D-glyceric acid, D-gluconic acid, malonic acid, maleic acid, oxalic acid, isocitric acid, and lactic acid.

Of the above catalysts, preferred are those which do not remain in the layer via evaporation during drying and also exhibit a low boiling point. Accordingly, acetic acid and nitric acid are most preferred.

The added amount is commonly 0.001 to 10 parts by weight with respect to 100 parts by weight of the employed alkoxysilicon compounds (for example, tetraalkoxysilane), but is preferably 0.005 to 5 parts by weight. Further, the added amount of water is to be at least the amount capable of performing theoretically 100% hydrolysis of the compound to be hydrolyzed. It is recommended to add water in an equivalent amount of 100-300%, but preferably of 100-200%.

During the hydrolysis of the above alkoxysilanes, it is preferable to blend the following minute inorganic particles.

After initiation of hydrolysis, a hydrolyzed liquid composition is allowed to stand over the specified period of time. After the hydrolysis reaches the specified degree, the above catalysts are employed. The standing period refers to the sufficient period during which the above hydrolyses and crosslinking due to condensation are progressed to result in desired layer characteristics. The specific period varies depending on the type of acid catalysts, but when acetic acid is employed, the period is at least 15 hours at room temperature, while when nitric acid is employed, the period is preferably at least two hours. Ripening temperature affects ripening temperature. Generally, at a higher temperature, ripening is more promoted. However, since gelling occurs at more than or equal to 100° C., it is appropriate to raise and maintain the temperature in a range of 20 to 60° C.

The silicate oligomer solution prepared by performing hydrolysis and condensation as described above is added with the above minute hollow particles and additives, and the resulting mixture is diluted as required, whereby a low refractive index layer liquid coating composition is prepared. Subsequently, the resulting coating composition is applied onto the above film, whereby it is possible to form a layer as a low refractive index layer composed of an excellent silicon oxide layer.

Further, in the present invention, other than the above alkoxysilanes, employed may be the compounds which are prepared by modifying silane compounds (being monomers, oligomers, or polymers) having a functional group such as an epoxy group, an amino group, an isocyanate group, or a carboxyl group, and may be employed individually or in combination.

### <Fluorine Compound>

The low refractive index layer used for the present invention preferably may be composed of fluorine compounds as a principal component, and more preferably contains hollow particles and a fluorine compound. As a binder matrix, the low refractive index layer preferably contains a fluorine containing resin (hereinafter, it may be referred as “fluorine containing resin before cross linkage”) which is cross-linked by heat or ionizing radiation. A good antifouling antireflection film can be provided by the content of this fluorine containing resin.

Preferably listed as fluorine containing resins prior to coating are fluorine containing copolymers which are formed employing fluorine containing vinyl monomers and crosslinking group providing monomers. Listed as specific examples of the above fluorine containing vinyl monomer units are fluoroolefins (for example, fluoroethylene, vinylidene fluoride, tetrafluoroethylene, hexafluoroethylene, hexafluoropropylene, perfluoro-2,2-dimethyl-1,3-dioxol), partially or completely fluorinated alkyl ester derivatives of (meth)acrylic acid (for example, BISCOAT 6FM (produced by Osaka Organic Chemical Industry Ltd.) and M-2020 (produced by Daikin Industries, Ltd.), and completely or partially fluorinated vinyl ethers. Listed as monomers to provide a crosslinking group are vinyl monomers previously having a crosslinking functional group in the molecule, such as glycidyl methacrylate, vinyltrimethoxysilane, γ-methacryloyloxypropyltrimethoxysilane, or vinyl glycidyl ether, as well as vinyl monomers having a carboxyl group, a hydroxyl group, an amino group, or a sulfone group (for example, (meth)acrylic acid, methylol (meth)acrylate, hydroxyalkyl(meth)acrylate, allyl acrylate, hydroxyalkyl vinyl ether, and hydroxyalkyl allyl ether). JP-A Nos. 10-25388 and 10-147739 describe that a crosslinking structure is introduced into the latter by adding compounds having a group which reacts with the functional group in the polymer and at least one reacting group. Listed as examples of the crosslinking group are a acryloyl, methacryloyl, isocyanate, epoxy, aziridine, oxazoline, aldehyde, carbonyl, hydrazine, carboxyl, methylol or active methylene group. When fluorine containing polymers undergo thermal crosslinking due to the presence of a thermally reacting crosslinking group or the combinations of an ethylenic unsaturated group with thermal radical generating agents or an epoxy group with a heat generating agent, the above polymers are of a heat curable type. On the other hand, in cases in which crosslinking undergoes by exposure to radiation (preferably ultraviolet radiation and electron beams) employing combinations of an ethylenic unsaturated group with photo-radical generating agents or an epoxy group with photolytically acid generating agents, the polymers are of an ionizing radiation curable type.

Further, employed as a fluorine containing resins prior to coating may be fluorine containing copolymers which are prepared by employing the above monomers with fluorine containing vinyl monomers, and monomers other than monomers to provide a crosslinking group in addition to the above monomers. Monomers capable being simultaneously employed are not particularly limited. Those examples include olefins (ethylene, propylene, isoprene, vinyl chloride, and vinylidene chloride); acrylates (methyl acrylate, ethyl acrylate, and 2-ethylhexyl acrylate); methacrylates (methyl methacrylate, ethyl methacrylate, butyl methacrylate, and ethylene glycol dimethacrylate); styrene derivatives (styrene, divinylbenzene, vinyltoluene, and α-methylstyrene); vinyl ethers (methyl vinyl ether); vinyl esters (vinyl acetate, vinyl propionate, and vinyl cinnamate); acrylamides (N-tert-butylacrylamide and N-cyclohexylacrylamide); methacrylamides; and acrylonitrile derivatives. Further, in order to provide desired lubricating properties and antistaining properties, it is also preferable to introduce a polyorganosiloxane skeleton or a perfluoropolyether skeleton into fluorine containing copolymers. The above introduction is performed, for example, by polymerization of the above monomers with polyorganosiloxane and perfluoroether having, at the end, an acryl group, a methacryl group, a vinyl ether group, or a styryl group and reaction of polyorganosiloxane and perfluoropolyether having a functional group.

The used ratio of each monomer to form the fluorine containing copolymers prior to coating is as follows. The ratio of fluorine containing vinyl monomers is preferably 20 to 70 mol percent, but is more preferably 40 to 70 mol percent; the ratio of monomers to provide a crosslinking group is preferably 1 to 20 mol percent, but is more preferably 5 to 20 mol percent, and the ratio of the other monomers simultaneously employed is preferably 10 to 70 mol percent, but is more preferably 10 to 50 mol percent.

It is possible to obtain the fluorine containing copolymers by polymerizing these monomers employing methods such as a solution polymerization method, a block polymerization method, an emulsion polymerization method or a suspension polymerization method.

The fluorine containing resins before cross linkage are commercially available and it is possible to employ commercially available products. Listed as examples of the fluorine containing resins prior to coating are SAITOP (produced by Asahi Glass Co., Ltd.), TEFLON (a registered trade name) AD (produced by Du Pont), vinylidene polyfluoride, RUMIFRON (produced by Asahi Glass Co., Ltd.), and OPSTAR (produced by JSR).

The dynamic friction coefficient and contact angle to water of the low refractive index layer composed of crosslinked fluorine containing resins are in the range of 0.03 to 0.15 and in the range of 90 to 120 degrees, respectively.

<Additives>

If desired, it is possible to incorporate additives such as silane coupling agents or hardening agents in the low refractive index liquid coating composition. Specific examples include vinyltriethoxysilane, γ-methacryloxypropyltrimethoxysilane, γ-glycidoxypropyltrimethoxysilane, and 3-(2-aminoethylaminopropyl)trimethoxysilane.

Cited as hardening agents are organic acid metal salts such as sodium acetate or lithium acetate, of which sodium acetate is particularly preferred. The added amount to the siliconalkoxysilane hydrolyzed solution is preferably in the range of about 0.1 to about 1 part by weight with respect to 100 parts by weight of solids in the hydrolyzed solution.

Further, it is preferable to add, to the low refractive index layer employed in the present invention, various leveling agents, surface active agents, and low surface tension substances such as silicone oil.

Specific commercially available silicone oils include L-45, L-9300, FZ-3704, FZ-3703, FZ-3720, FZ-3786, FZ-3501, FZ-3504, FZ-3508, FZ-3705, FZ-3707, FZ-3710, FZ-3750, FZ-3760, FZ-3785, FZ-3785, and Y-7499 of Nippon Unicar Co., Ltd., as well as KF96L, KF96, KF96H, KF99, KF54, KF965, KF968, KF56, KF995, KF351, KF352, KF353, KF354, KF355, KF615, KF618, KF945, KF6004, and FL100 of Shin-Etsu Chemical Co., Ltd.

Moreover, it is also desirable to use a surface active agent indicated in Table 1. These surface active agents can also be used for the above-mentioned hard coat layer.

TABLE 1

| Maker | Model number | Maker | Model number |
|---|---|---|---|
| *1 | BYK300 | *1 | BYK_UV3500 |
| *1 | BYK301 | *1 | BYK_UV3510 |
| *1 | BYK302 | *1 | BYK_UV3530 |
| *1 | BYK306 | *1 | BYK_UV3570 |
| *1 | BYK307 | *1 | BYK_Silclean3700 |
| *1 | BYK308 | *1 | BYK_Dynwet800 |
| *1 | BYK310 | Nippon Unicar | FZ2207 |
| | | Company Limited | |
| *1 | BYK315 | Nippon Unicar | FZ2222 |
| | | Company Limited | |
| *1 | BYK320 | GE Toshiba Silicone | TSF4440 |
| | | Corporation | |
| *1 | BYK322 | GE Toshiba Silicone | TSF4460 |
| | | Corporation | |
| *1 | BYK323 | GE Toshiba Silicone | XC96-723 |
| | | Corporation | |
| *1 | BYK325 | GE Toshiba Silicone | YF3800 |
| | | Corporation | |
| *1 | BYK330 | GE Toshiba Silicone | XF3905 |
| | | Corporation | |
| *1 | BYK331 | GE Toshiba Silicone | YF3057 |
| | | Corporation | |
| *1 | BYK333 | Neos Corporation | Futergent 251 |
| *1 | BYK333 | Neos Corporation | Futergent 212MH |
| *1 | BYK333 | Neos Corporation | Futergent 250 |
| *1 | BYK333 | Neos Corporation | Futergent 222F |
| *1 | BYK333 | Neos Corporation | Futergent 212D |
| *1 | BYK335 | Neos Corporation | FTX-218 |
| *1 | BYK337 | Neos Corporation | Futergent300 |
| *1 | BYK340 | Neos Corporation | Futergent310 |
| *1 | BYK341 | Neos Corporation | Futergent320 |
| *1 | BYK344 | Neos Corporation | FTX-209F |
| *1 | BYK345 | Neos Corporation | FTX-245F |
| *1 | BYK346 | Neos Corporation | FTX-218G |
| *1 | BYK347 | Dainippon Ink | Megafuck F-470 |
| | | Corporation | |
| *1 | BYK348 | Dainippon Ink | Megafuck F-479 |
| | | Corporation | |
| *1 | BYK350 | Dainippon Ink | Megafuck F-482 |
| | | Corporation | |
| *1 | BYK352 | Dainippon Ink | Megafuck F-483 |
| | | Corporation | |
| *1 | BYK354 | Dainippon Ink | Diffensa MCF-350SF |
| | | Corporation | |
| *1 | BYK355 | Kyoueisha Chemical | Polyfulo No. 75 |
| | | Corporation | |
| *1 | BYK356 | Kyoueisha Chemical | Polyfulo No. 77 |
| | | Corporation | |
| *1 | BYK357 | Kyoueisha Chemical | Polyfulo No. 90 |
| | | Corporation | |
| *1 | BYK358N | Kyoueisha Chemical | Gulanor 410 |
| | | Corporation | |
| *1 | BYK359 | Kyoueisha Chemical | Gulanor 440 |
| | | Corporation | |
| *1 | BYK361N | Kyoueisha Chemical | Gulanor 450 |
| | | Corporation | |
| *1 | BYK370 | Kyoueisha Chemical | Fuloren DOPA-33 |
| | | Corporation | |
| *1 | BYK375 | Kyoueisha Chemical | Polyfulo KL-600 |
| | | Corporation | |
| *1 | BYK377 | Seimi Chemical | Sarfulon S-386 |
| | | Corporation | |
| *1 | BYK380N | Kao Corporation | Electrostoripper EA |
| *1 | BYK381 | Kao Corporation | Homogenor L-18 |
| *1 | BYK390 | Kao Corporation | Amiito 302 |

*1: Bickchemi Company Limited

These components enhance coatability onto a substrate or a lower layer. When incorporated in the uppermost layer of the multicoated layers, water- and oil-repellency, and anti-staining are enhanced and in addition, abrasion resistance of the surface is also enhanced. Since the excessive addition of these components results in repellency during coating, the added amount is preferably in the range of 0.01-3% by weight with respect to the solids in the liquid coating composition.

### <Organic Solvents>

Solvents employed in the liquid coating composition during coating the low refractive index layer include alcohols such as methanol, ethanol, 1-propanol, 2-propanol, or butanol; ketones such as acetone, methyl ethyl ketone, or cyclohexanone; aromatic hydrocarbons such as benzene, toluene, or xylene; glycols such as ethylene glycol, propylene glycol, or hexylene glycol; glycol ethers such as ethyl cellosolve, butyl cellosolve, ethyl CARBITOL, butyl CARBITOL, diethyl cellosolve, diethyl CARBITOL, or propylene glycol monomethyl ether; N-methylpyrrolidone, dimethylformamide, methyl lactate, ethyl lactate, methyl acetate, and water. These may be employed individually or in combinations of at least two types.

### <Coating Methods>

The low refractive index layer is coated employing the methods known in the art, such as dipping, spin coating, knife coating, bar coating, air doctor coating, curtain coating, spray costing, or die coating, as well as ink-jet methods known in the art. Coating methods which enable continuous coating and thin layer coating are preferably employed. The coated amount is commonly 0.1 to 30 μm in term of wet thickness, but is preferably 0.5-15 μm. The coating rate is preferably 10-80 m/minute.

When the composition of the present invention is applied onto a substrate, it is possible to control layer thickness and coating uniformity by regulating the solid concentration in the liquid coating composition and the coated amount.

In the present invention, it is also preferable to form an antireflection layer composed of a plurality of layers in such a manner that the medium refractive index layer and high refractive index layer, described below, are provided.

The configuration example of the antireflection layer usable in the present invention is described below, however the antireflection layer is not limited thereto.

Lengthy film/hard coat layer/low refractive index layer

Lengthy film/hard coat layer/medium refractive index layer/low refractive index layer

Lengthy film/hard coat layer/high refractive index layer/low refractive index layer

Lengthy film/hard coat layer/medium refractive index layer/high refractive index layer/low refractive index layer

Lengthy film/antistatic layer/hard coat layer/medium refractive index layer/high refractive index layer/low refractive index layer

Lengthy film/hard coat layer/antistatic layer/medium refractive index layer/high refractive index layer/low refractive index layer

Antistatic layer/lengthy film/hard coat layer/medium refractive index layer/high refractive index layer/low refractive index layer

Lengthy film/hard coat layer/high refractive index layer/low refractive index layer/high refractive index layer/low refractive index layer

### (Medium Refractive Index Layer and High Refractive Index Layer)

The constituting components of the medium and high refractive index layers are not particularly limited as long as the specified refractive index layer is prepared. However, it is preferable that the above layer is composed of the following minute metal oxide particles at a high refractive index, and binders. Other additives may be incorporated. The refractive index of the medium refractive index layer is preferably 1.55 to 1.75, while that of the high refractive index layer is preferably 1.75 to 2.20. The thickness of the high and medium refractive index layers is preferably 5 nm to 1 μm, is more preferably 10 nm to 0.2 μm, but is most preferably 30 nm to 0.1 μm. It is possible to coat those layers employing the same coating method as that of the above low refractive index layer.

### <Minute Metal Oxide Particles>

Minute metal oxide particles are not particularly limited. For example, employed as a main component may be titanium dioxide, aluminum oxide (alumina), zirconium oxide (zirconia), zinc oxide, antimony-doped tin oxide (ATO), antimony pentaoxide, indium-tin oxide (ITO), and iron oxide, which may be blended. In the case of use of titanium dioxide, in term of retardation of activity of photocatalysts, it is preferably to employ core/shell structured minute metal oxide particles which are prepared in such a manner that titanium oxide is employed as a core and the core is covered with a shell composed of alumina, silica, zirconia, ATO, ITO, or antimony pentaoxide.

The refractive index of minute metal oxide particles is preferably 1.80 to 2.60, but is more preferably 1.90 to 2.50. The average diameter of the primary particles of the minute metal oxide particles is preferably 5 nm to 200 nm, but is more preferably 10 to 150 nm. When the particle diameter is excessively small, minute metal oxide particles tend to aggregate to degrade dispersibility, while when it is excessively large, haze is undesirably increased. Minute inorganic particles are preferably in the form of rice grain, needle, sphere, cube, or spindle, or amorphous.

Minute metal oxide particles may be surface-treated with organic compounds. Examples of such organic compounds include polyol, alkanolamine, stearic acid, silane coupling agents, and titanate coupling agents. Of these, most preferred are silane coupling agents, described below. At least two types of surface treatments may be combined.

It is possible to prepare high and medium refractive index layers exhibiting desired refractive indices via appropriate selection of the type of metal oxides and the addition ratio thereof.

### <Binders>

Binders are incorporated to improve film forming properties and physical properties of a coating. Employed as such binders may, for example, be the aforesaid ionizing radiation curing type resins, acrylamide derivatives, multifunctional acrylates, acrylic resins, and methacrylic resins.

### (Metal Compounds and Silane Coupling Agents)

Incorporated as other additives may be metal compounds and silane coupling agents, which may be employed as a binder.

Employed as the metal compounds may be the compounds represented by Formula (6) or chelate compounds thereof.

AnMBx-n Formula (6)

wherein M represents a metal atom; A represents a hydrolysable functional group or a hydrocarbon group having a hydrolysable functional group; B represents a group of atoms, which covalently or ionically bonds metal M; x represent valence of metal atom M; and n represents an integer of 2-x.

Examples of hydrolysable functional group A include an alkoxyl group, a halogen atom such as a chorine atom, an ester group, and an amido group. Preferred as the compounds represented by above Formula (6) are alkoxides having at least two alkoxyl groups bonding a metal atom, or chelate compounds thereof. In view of refractive index, reinforcing effects of coating strength, and ease of handling, cited as preferred metal compounds are titanium alkoxides, zirconium alkoxides, and silicon alkoxides, or chelate compounds thereof. Titanium alkoxides exhibits a high reaction rate, a high refractive index, and ease of handling. However, its excessive addition degrades lightfastness due to its photocatalytic action. Zirconium akloxides exhibit a high refractive index, but tends to result in cloudiness, whereby careful dew point management is required during coating. On the other hand, silicon alkoxides exhibit a low reaction rate and a low refractive index, but ease of excellent handling and excellent lightfastness. Silane coupling agents can react with both minute inorganic particles and organic polymers, whereby it is possible to prepare a strong coating. Further, titanium aloxides enhance reaction with ultraviolet radiation curing resins and metal alkoxides, whereby it is possible to enhance physical characteristics of a coating even by a small amount of their addition.

Examples of titanium alkoxides include tetramethoxytitaium, tetraethoxytitanium, tetra-iso-propoxytitanium, tetra-n-propoxytitanium, tetra-n-butoxytitanium, tetra-sec-butoxytitanium, and tetra-tert-butoxytitanium.

Examples of zirconium alkoxides include tetramethoxyzirconium, tetraethoxyzirconium, tetra-isopropoxyzirconium, tetra-n-proxyzirconium, tetra-n-butoxyzirconium, tetra-sec-butoxyzirconium, and tetra-tert-butoxyzirconium.

Silicon alkoxides and silane coupling agents are the compounds represented by following Formula (7).

RmSi(OR′)n Formula (7)

wherein R represents a reactive group such as an alkyl group (preferably an alkyl group having 1-10 carbon atoms), a vinyl group, a (meth)acryloyl group, an epoxy group, an amido group, a sulfonyl group, a hydroxyl group, a carboxyl group, or an alkoxyl group, R′ represents an alkyl group (preferably an alkyl group having 1-10 carbon atoms), and m+n is 4.

Specifically cited are tetramethoxysilane, tetraethoxysilane, tetra-iso-propoxysilane, tetra-n-propoxysilane, tetra-n-butoxysilane, tetra-sec-butoxysilane, tetra-tert-butoxysilane, terapentaethoxysilane, methyltrimethoxysilane, methyltriethoxysilane, methyltriproxysilane, methyltributoxysilane, dimethyldimethoxysilane, dimethyldiethoxysilane, hexyltrimethoxysilane, vinyltriethoxysilane, γ-methacryloxypropyltrimethoxysilane, γ-glycidoxypropyltrimethoxysilane, and 3-(2-aminoethylaminopropyl)trimethoxysilane.

Cited as preferred chelating agents which are allowed to coordinate with a free metal compound to form a chelate compound may be alkanolamines such as diethanolamine or triethanolamine; glycols such acetylene glycol, diethylene glycol, or propylene glycol; and acetylacetone, ethyl acetacetate, having a molecular weight of at most 100,000. By employing such chelating agents, it is possible to prepare chelate compounds which are stable for water mixing and exhibit excellent coating strengthening effects.

In the medium refractive index composition, the added amount of the metal compounds is preferably less than 5-6 by weight in terms of metal oxides, while in the high refractive index composition, the same is preferably less than 20-06 by weight in terms of metal oxides.

For the medium refractive-index layer and the high refractive index layer, it is desirable to use the various kinds of leveling agents, the surface active agents, the low surface tension substances such as silicone oil, the organic solvents, and the coating methods which are described in the above-mentioned low-refractive-index layer.

The antireflection layer of the present invention is effective especially in the case where at least one layer is formed by the above-mentioned coating method with the antireflection layer coating liquid containing a low surface tension substance and an organic solvent, and very effective especially in the case where all layers of the antireflection layers are formed by the above-mentioned coating method with the antireflection layer coating liquid containing a low surface tension substance and an organic solvent.

### (Polarizing Plate)

The optical film of the present invention is useful as a polarizing plate protective film, and this polarizing plate can be produced by a general method.

The optical film of this invention, the back side of which is subjected to an alkaline saponification treatment, is preferably pasted up on at least one surface of a polarizer which has been prepared by immersion stretching in an iodine solution by use of a completely saponificated type polyvinyl alcohol aqueous solution. On the other surface, the polarizing plate protective film may be used or another polarizing plate protective film may be utilized. Cellulose ester film (such as Konicaminolta TAC KC8UX, KC4UX, KC5UX, KC8UCR3, KC8UCR4, KC8UY, KC4UY, KC12UR, KC8UCR-3, KC8UCR-4, KC8UCR-5, manufactured by Konicaminolta Opto Co., Ltd.) available on the market is also preferably utilized. Against the optical film of this invention, the polarizing plate protective film utilized on another side is preferably provided with retardation of in-plane retardation Ro of 30 to 300 nm and Rt of 70 to 400 nm, which are measured at a wavelength of 590 nm. These can be produced by the methods described in, for examples, Japanese Patent Unexamined Publication No. 2002-71957 and Japanese Patent Unexamined Publication No. 2003-170492. Further, the polarizing plate protective film produced by the method described in Japanese Patent Unexamined Publication No. 2003-12859 and having retardation values Ro and Rt (0 nm≦Ro≦15 nm, −15 nm≦Rt≦15 nm) may also usable. Moreover, also preferably utilized is a polarizing plate protective film which also functions as optical compensation film having an optical anisotropic layer formed by orientating a liquid crystal compound such as discotic liquid crystal. For example, an optical anisotropic layer can be formed by a method described in Japanese Patent Unexamined Publication No. 2003-98348. By the use to combine with a polarizing plate of the present invention, it is possible to obtain a polarizing plate having excellent flatness and a stable viewing angle enlargement effect.

Polalizer film as a primary constituent element of a polarizing plate is an element which passes light having a polarized wave plane in a predetermined direction, and typical polarizer film commonly known at present is polyvinyl alcohol type polarizer film, which is classified into polyvinyl alcohol type film being dyed with iodine and one being dyed with dichroic dye. Polarizer film is prepared by film formation from polyvinyl alcohol aqueous solution, and the obtained film is uniaxially stretched and dyed, or is uniaxially stretched after dying, preferably followed by being subjected to a durability treatment with a boron compound. One surface of optical film of the present invention is pasted up on the surface of said polarizer film to prepare a polarizing plate. Pasting up is preferably carried out by use of a water-based adhesive comprising completely saponified polyvinyl alcohol as a primary component. The thickness of the polarization film is desirably 5 to 30 μm, and more desirably 10 to 20 μm.

It is preferable to use ethylene-modified polyvinyl alcohol having an ethylene unit content of 1 to 4 mol %, a degree of polymerization of 2,000 to 4,000 and a saponification ratio of 99.0 to 99.99 mol % which is described in Japanese Patent Unexamined Publication No. 2003-248123 and Japanese Patent Unexamined Publication No. 2003-342322. Especially, it is preferable to use ethylene-modified polyvinyl alcohol having a cutting temperature in hot-water of 66 to 73° C. Further, in order to decrease color spots, it is more preferable that the difference between the hot water cutting temperatures of the two points 5 cm apart in the TD direction of the film is at most 1° C. Further, in order to decrease color spots, it is still more preferable that the difference between the hot water cutting temperatures of the two points 1 cm apart in the TD direction is 0.5° C. or less.

A polarizer utilizing this ethylene modified polyvinyl alcohol film is excellent in polarizing ability and durability, as well as exhibits few color spottiness, and is specifically preferably applied in a large size liquid crystal display device.

An optically transparent protective layer, exhibiting desired mechanical strength, is adhered to one or both sides of the polarizer prepared as above to prepare a polarizing plate. Listed as adhesives for the above adhesion may be a PVA adhesive and an urethane adhesive. Of these, a PVA adhesive is preferable.

### (Display Unit)

By the incorporation of the polarizing plate of the present invention into a display unit, it is possible to produce the display unit of the present invention excellent in various visibilities. The cellulose resin film of the present invention and the antireflection film employing the film are preferably used in a reflection type, transmission type, or half-transmission type LCD or a LCD of various drive types, such as a TN type, a STN type, an OCB type, a HAN type, a VA type (a PVA type, a MVA type), and an IPS type. Especially, in a display unit having a screen of 30 type or more, in particular, a big screen of 30 to 54, there is no white omission in screen periphery portions and the effect is maintained for a long period of time, and a prominent effect is recognized in a MVA type liquid crystal display. In particular, there were effects that an irregular color, less glare, little waving unevenness, and eyes not having get tired under long observation.

### EXAMPLE

Hereafter, examples are shown and the present invention is concretely explained, however the present invention is not limited to these examples.

### Example 1

### Preparation of Cellulose Ester Film 1

(Silicon dioxide particles A)

| | |
|---|---|
| Aerosil R972V (manufactured by Japan Aerosil) | 12 parts by weight |
| (Average diameter of the primary particles: 16 nm; | |
| apparent specific weight: 90 g/liter) | |
| Ethanol | 88 parts by weight |

The inventors stirred the above mixture by a dissolver for 30 minutes, dispersed the particles a Manthon Gaulin, put methylene chloride to the silicon dioxide particles while stirring, allowed the mixture to be stirred and blended in a dissolver for 30 minutes, thereby obtaining a diluted silicon dioxide dispersion liquid A.

### (Preparation of In-Line Liquid Additive A)

| | |
|---|---|
| TINUVIN 109 (by Ciba Specialty Chemicals K.K) | 11 parts by weight |
| TINUVIN 171 (by Ciba Specialty Chemicals K.K) | 5 parts by weight |
| Methylene chloride | 100 parts by weight |

The aforementioned compositions were put in an enclosed container, heated while being stirred until being dissolved completely, and filtered.

Then, 36 parts by weight diluted silicon dioxide dispersion liquid A was added to this liquid while stirring; further the resultant liquid was stirred for 30 minutes; thereafter 6 parts by weight of cellulose triacetate propionate (acetyl group substitution degree of 1.9, propionyl group substitution degree of 0.8) was added while stirring; further the resultant liquid was stirred for 60 minutes; and then the resultant liquid was filtered by the use of a polypropylene wind cartridge filter TCW-PPS-IN (manufactured by Advantec Toyo Co., Ltd.), whereby the in-line liquid additive A was prepared.

### (Preparation of Doping Solution A)

| | |
|---|---|
| Cellulose ester (cellulose triacetate synthesized from | 100 parts by weight |
| linter cotton) | |
| (Mn = 148000, Mw = 310000, Mw/Mn = 2.1, | |
| Acetyl group substitution ratio of 2.92) | |
| Trimethylol propane tribenzoate | 5.0 parts by weight |
| Ethylphthalylethylglycolate | 5.5 parts by weight |
| Methylene chloride | 440 parts by weight |
| Ethanol | 40 parts by weight |

The aforementioned compositions were put in an enclosed container, heated while being stirred until being dissolved completely, and filtered by a filter paper Azumi No. 24 (by AZUMI FILTERPAPER CO., LTD), whereby drop solution A was prepared.

The doping solution A was filtered in the film production line by the use of Finemet NF (manufactured by Nippon Seisen Co., Ltd.). The in-line liquid additive A was filtered in the in-line liquid additive line by the Finemet NF of Nippon Seisen Co., Ltd. Three parts by weight of the filtered in-line liquid additive A was added to 100 parts by weight of the filtered doping solution A, the resultant solution was mixed sufficiently by an in-line mixer (Toray static in-line mixer Hi-Mixer SWJ manufactured by Toray Industries, Inc.), and then cast uniformly at a width of 1.8 m over the stainless steel band support at a temperature of 32° C. by the use of a belt casting apparatus. The solvent was evaporated on the stainless steel band support until the amount of remaining solvent becomes 1001, and then a web was separated from the stainless steel band support. Then the solvent was left to evaporate from the cellulose ester web at 35° C., and the web was slit to a width of 1.65 m. After that, the web was stretched at a drawing ratio of 1.05 in the TD direction (in the direction perpendicular to the film conveying direction) by a tenter, the web was dried at a drying temperature of 135° C. In this case, the amount of remaining solvent at the time of starting drawing by the tenter was 20%.

After that, the web was conveyed by multiple rolls through the drying zone having a temperature of 110° C. and 120° C. and then the drying operation for the web was completed. The web was slit into a width of 1.4 mm, and was subjected to a knurling process and provided with a knurled portion having a width of 1 cm and an average height of 8 μm on both ends of the film. The web was wound up on a core having an inside diameter of 6 inch with a wind-up initial tension of 220 N/m and a ending tension of 110 N/m, whereby a cellulose film 1 was obtained. The draw ratio (stretching ratio) in MD direction (in the same direction perpendicular with the film conveying direction) calculated by a rotation speed of the stainless band support and the running speed of the tenter was 1.07. The average film thickness of the cellulose film 1 is 60 μm and the number of rolls was 3000 m.

<Treatment to Rub a Film Plane with an Elastic Member>

By the use of the cellulose ester film 1 produced in above-mentioned ways, a treatment to wet a film plane with liquid by a spray nozzle and to rub the film plane with an elastic member was performed with the following specifications.

Under the conditions shown in Table 2, the film plane was wetted with liquid by a spray nozzle and one surface of the lengthy film was rubbed with the elastic member 1 by the used of a film conveying apparatus shown in FIG. 1.

Hereafter, the conditions indicated in Table 2 and the details of the used apparatus are described.

### <Film Conveying Speed>

The cellulose ester film 1 was conveyed at 15 m/minutes.

### <Adhering Amount of Droplets by a Spray>

Droplet (pure water) was made to adhere to a film on the following conditions by the use of a spray nozzle device shown in FIG. 8.

Uses spray nozzle: Spraying system Japan Unijet

Condition 1. In the case of an adhering amount of 1 g/m² and a droplet diameter of 300 μm: Two spray nozzles having a pray pressure of 0.3 MPa, a flow rate of 100 g/minutes and a spray angle of 90° were used in the width direction, and the distance between the lengthy film being conveyed and the spray nozzle was set to 1000 mm.

Condition 2. In the case of an adhering amount of 20 g/m² and a droplet diameter of 5 μm: Two spray nozzles having a pray pressure of 2 MPa, a flow rate of 250 g/minutes and a spray angle of 1200 were used in the width direction, and the distance between the lengthy film being conveyed and the spray nozzle was set to 400 mm.

Condition 3. In the case of an adhering amount of 20 g/m² and a droplet diameter of 6000 μm: five spray nozzles having a pray pressure of 0.05 MPa, a flow rate of 100 g/minutes and a spray angle of 500 were used in the width direction, and the distance between the lengthy film being conveyed and the spray nozzle was set to 400 mm.

Condition 4. In the case of an adhering amount of 120 g/m² and a droplet diameter of 300 μm: five spray nozzles having a pray pressure of 1 MPa, a flow rate of 600 g/minutes and a spray angle of 90° were used in the width direction, and the distance between the lengthy film being conveyed and the spray nozzle was set to 240 mm.

Condition 5. In the case of an adhering amount of 50 g/m² and a droplet diameter of 300 μm: five spray nozzles having a pray pressure of 0.3 MPa, a flow rate of 250 g/minutes and a spray angle of 90° were used in the width direction, and the distance between the lengthy film being conveyed and the spray nozzle was set to 240 mm.

Condition 6. In the case of an adhering amount of 70 g/m² and a droplet diameter of 300 μm: five spray nozzles having a pray pressure of 0.3 MPa, a flow rate of 300 g/minutes and a spray angle of 90° were used in the width direction, and the distance between the lengthy film being conveyed and the spray nozzle was set to 240 mm.

Condition 7. In the case of an adhering amount of 20 g/m² and a droplet diameter of 1000 μm: five spray nozzles having a pray pressure of 0.2 MPa, a flow rate of 100 g/minutes and a spray angle of 700 were used in the width direction, and the distance between the lengthy film being conveyed and the spray nozzle was set to 300 mm.

Condition 8. In the case of an adhering amount of 20 g/m² and a droplet diameter of 3000 μm: five spray nozzles having a pray pressure of 0.1 MPa, a flow rate of 100 g/minutes and a spray angle of 600 were used in the width direction, and the distance between the lengthy film being conveyed and the spray nozzle was set to 320 mm.

Condition 9. In the case of an adhering amount of 3 g/m² and a droplet diameter of 300 μm: five spray nozzles having a pray pressure of 0.3 MPa, a flow rate of 100 g/minutes and a spray angle of 90° were used in the width direction, and the distance between the lengthy film being conveyed and the spray nozzle was set to 900 mm.

Condition 10. In the case of an adhering amount of 100 g/m² and a droplet diameter of 300 μm: five spray nozzles having a pray pressure of 0.3 MPa, a flow rate of 500 g/minutes and a spray angle of 90° were used in the width direction, and the distance between the lengthy film being conveyed and the spray nozzle was set to 270 mm.

Condition 11. In the case of an adhering amount of 20 g/m² and a droplet diameter of 10 μm: Two spray nozzles having a pray pressure of 1.5 MPa, a flow rate of 250 g/minutes and a spray angle of 1200 were used in the width direction, and the distance between the lengthy film being conveyed and the spray nozzle was set to 390 μm.

Condition 12. In the case of an adhering amount of 20 g/m² and a droplet diameter of 5000 μm: five spray nozzles having a pray pressure of 0.15 MPa, a flow rate of 100 g/minutes and a spray angle of 650 were used in the width direction, and the distance between the lengthy film being conveyed and the spray nozzle was set to 300 μm.

Flow rate distribution of plural spray nozzles was measured by the following method by the use of the device of FIG. 11.

### (Measurement of Flow Rate Distribution)

As shown in FIG. 11, an apparatus in which a tank having a width of 1300 mm was provided under the plural spray nozzles was sued for this measurement. The inside of the tank was provided with walls so that it was divided into 27 divisions. Since the flow rate tended to become small at the end portions, baffle plates were installed so as to make the flow rate uniform over to the end portions. For each nozzle, water was supplied for 10 minutes on the condition of a hydraulic pressure of 0.3 MPa and a flow rate 0.13 L/minutes per one nozzle. Thereafter, the quantity of water stored in each division in the tank was measured. In the result, the flow rate distribution was ±1%.

<Contact Time Period with the Elastic Member: Rubbing Time>

Conditions T1. In the case that the contact time with the elastic member was 0.035 second, the diameter of the elastic member was set to 200 mm, and the lap angles was set to 5°.

Conditions T2. In the case that the contact time with the elastic member was 0.052 second, the diameter of the elastic member was set to 200 mm, and the lap angles was set to 75°.

Conditions T3. In the case that the contact time with the elastic member was 2.3 second, the diameter of the elastic member was set to 600 mm, and the lap angles was set to 110°.

Conditions T4. In the case that the contact time with the elastic member was 1 second, the diameter of the elastic member was set to 300 mm, and the lap angles was set to 100°.

Conditions T5. In the case that the contact time with the elastic member was 0.14 second, the diameter of the elastic member was set to 200 mm, and the lap angles was set to 20°.

Conditions T6. In the case that the contact time with the elastic member was 0.05 second, the diameter of the elastic member was set to 200 mm, and the lap angles was set to 7°.

Conditions T7. In the case that the contact time with the elastic member was 3 second, the diameter of the elastic member was set to 800 mm, and the lap angles was set to 108°.

### <Elastic Member and Surface Pressure of a Film>

Condition M1. In the case that the diameter elastic member was 200 mm and the surface pressure was 210 N/m², the treatment was conducted with a line tension of 29.4 N.

Condition M2. In the case that the diameter elastic member was 200 mm and the surface pressure was 2100 N/m², the treatment was conducted with a line tension of 294 N.

Condition M3. In the case that the diameter elastic member was 200 mm and the surface pressure was 5600 N/m², the treatment was conducted with a line tension of 784 N.

Condition M4. In the case that the diameter elastic member was 600 mm and the surface pressure was 1867 N/m², the treatment was conducted with a line tension of 784 N.

Condition M5. In the case that the diameter elastic member was 300 mm and the surface pressure was 2100 N/m², the treatment was conducted with a line tension of 441 N.

Condition M6. In the case that the diameter elastic member was 200 mm and the surface pressure was 4200 N/m², the treatment was conducted with a line tension of 588 N.

Condition M7. In the case that the diameter elastic member was 200 mm and the surface pressure was 700 N/m², the treatment was conducted with a line tension of 98 N.

Condition M8. In the case that the diameter elastic member was 800 mm and the surface pressure was 2100 N/m², the treatment was conducted with a line tension of 1176 N.

Condition M9. In the case that the diameter elastic member was 200 mm and the surface pressure was 500 N/m², the treatment was conducted with a line tension of 70 N.

Condition M10. In the case that the diameter elastic member was 200 mm and the surface pressure was 5000 N/m², the treatment was conducted with a line tension of 700 N.

### <Specification of an Elastic Member>

The specification of the used elastic member was as follows.

Size and the quality of the material of the elastic member: rollers made from aluminum and having respective size of 200 mm, 300 mm, and 600 mm were covered with a 5 mm thick acrylonitrile butadiene rubber layer.

Hardness of the elastic member: Rubber hardness 30 (measured by the use of Durometer A type in accordance with the method specified in JIS-K-6253)

Method of changing the static friction coefficient of the elastic member: After the surface of the elastic member was cleaned thoroughly with petroleum benzine, the surface of the elastic member was coated with a trichloroisocyanuric acid solution in such a way that while the elastic member was being rotated, the elastic member was brought in contact with rag into which 5% by weight trichloroisocyanuric acid solution dissolved in acetic acid ethyl ester was infiltrated. This elastic member was dried at a room temperature as it was, whereby the solvent was volatilized for about 0.5 hour and the surface was dried. At this time, the static friction coefficient of the elastic member was changed as shown in Table 2 by the change of the concentration of the trichloroisocyanuric acid solution. Here, the static friction coefficient was measured in accordance with the above-mentioned method by the use of “Hayden surface measurement machine 14 type” manufactured by Shinto science incorporated company.

Driving direction and number of rotations of the elastic member: It was rotation in the direction reverse to the direction of conveying the film and the number of rotations was 10 rpm.

Temperature of the elastic member: 30° C.

Air supply to the back surface of a film was adjusted as follows by the use of the air nozzle 5.

Slit width: 0.8 mm (preferably within a range of 0.2 to 2 mm)

Slit length: 1600 mm (based on the film width)

Wind blowing velocity: 100 m/sec (preferably within a range of 50 to 300 m/sec).

Distance to a film: 3 mm (preferably within a range of 2 to 10 mm)

The elastic member was washed by the method employing the ultrasonic vibrator shown in FIG. 1 in which two ultrasonic vibrators (special edition model manufactured by Japanese Alex) were installed in the width direction of the film and four ultrasonic vibrators were installed in the film conveying direction. The size of this one ultrasonic vibrator was is 50 cm in the width direction of the film and 30 cm in the film conveying direction, and the ultrasonic vibrator outputted supersonic waves of 100 kHz with the power of 1000 W.

Here, one edge position controller (EPC) was installed at each of the position located away by 10 m from the upstream side and the position located away by 10 m from the downstream side of this device on the film conveying passage, and the position of the lengthy film currently rubbed with the elastic member 1 was controlled by the use of these edge position controller.

The treated cellulose ester film C-1 to C-40 were produced by the use of the above-mentioned cellulose ester film 1 in such a way that supply or no supply of the liquid 4 (pure water) to the film surface by the spray nozzle 8; the adhering amount of liquid; the diameter of droplets; a rubbing time period by the elastic member 1; a surface pressure of a film to the elastic member 1; existence or no existence of the air nozzle 9; spray or no spray onto the back surface of a film by the air nozzle 5; existence or no existence of EPC; and so on were changed respectively as shown in Table 2.

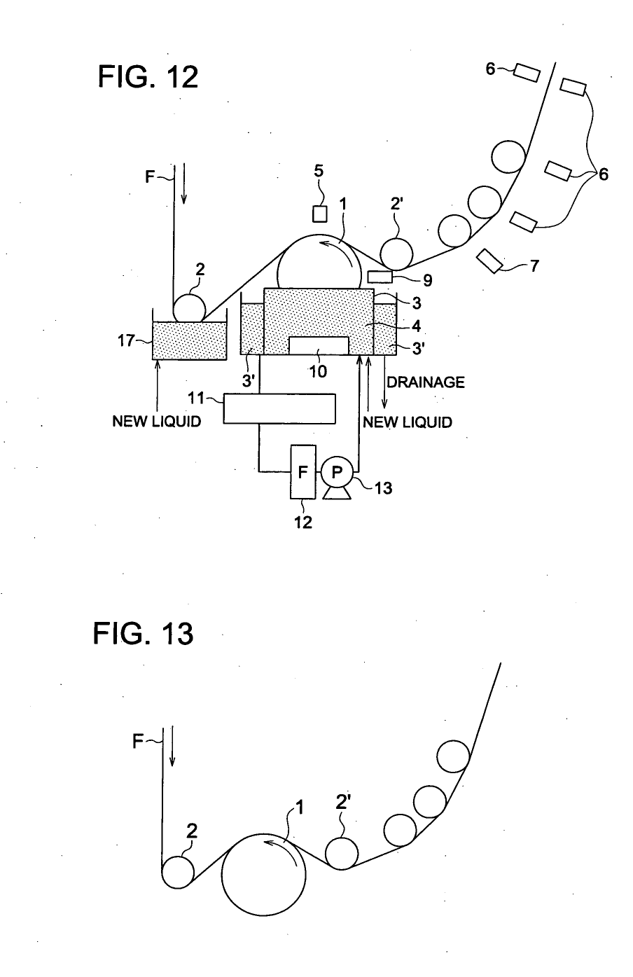

Here, the apparatus shown in FIG. 13 was used for the comparative example cellulose ester film C-3, and the dip type apparatus shown in FIG. 12 was used for the cellulose ester film C-36 of the present invention and the comparative example cellulose ester film C-38 and C-40. Moreover, the elastic member whose static friction coefficient was 0.14 lower than the range of the present invention were used for the comparative example cellulose ester film C-37 and C-38, and the elastic member whose static friction coefficient was 1.0 higher than the range of the present invention were used for the comparative example cellulose ester film C-39 and C-40.

### (Production of an Antireflection Layer-Provided Optical Film)

By the use of the above prepared cellulose ester films C-1 to C-40, antireflection layer-provided optical films (antireflection films) were prepared in accordance with the following procedures.

The refractive index of each layer constituting the antireflection layer was measured in accordance with the following methods.

### (Refractive Index)

The refractive index of each refractive index of the sample coated on the above prepared hard coat film separately for each layer was calculated from the result of measuring the spectral reflection factor by a spectrophotometer. After roughening the rear surface on the sample measuring side, the process of light absorption was applied by a black spray to prevent the light from being reflected on the rear surface. Then the spectrophotometer U-4000 (manufactured by Hitachi, Ltd.) was used to measure the reflection factor in the visible light area (400 nm through 700 nm) under the condition of five-degree specular reflection.

### (Metal Oxide Particle Size)

The present inventors measured the size of the metal oxide particles to be used, by taking the steps of observing 100 particles for each by an electron microscope (SEM), assuming that the diameter of the circle circumscribing each of the particles was as a particle size, and calculated the average value thereof as the particle size.

### <Formation of Hard Coat Layer>

The present inventors prepared the hard coat layer by taking the steps of filtering

The following hard coat layer coating solution was filtered by a polypropylene-made filter having a pore size of 0.4 μm to prepare a hard coat layer coating solution; this solution was coated on the above prepared cellulose ester films C-1 through C-40 by a micro-gravure coater; the coating layer was dried at 90° C. and cured by the use of the ultraviolet lamp under the condition that the intensity of illumination at the irradiating section was 100 mW/cm², and the irradiation amount of light was 0.1 J/cm²; whereby the hard coat layer having a dry film thickness of 7 μm was formed and a hard coat film was obtained.

### (Hard Coat Layer Coating Solution)

The following materials were stirred and blended to get a hard coat layer coating solution.

| | |
|---|---|
| Acryl monomer: KAYARAD DPHA | 220 parts by weight |
| (dipentaerithritol hexaacrylate, manufactured | |
| by Nippon Kayaku Co.) | |
| Irgacure 184 (by Ciba Specialty Chemicals K.K) | 20 parts by weight |
| Propylene glycol monomethyl ether | 110 parts by weight |
| Ethyl acetate | 110 parts by weight |

<<Preparation of Polarizing Plate Protective Film with Antireflection Layer>>

On the above prepared hard coat film, the high refractive index layer, and then the low refractive index layer were coated as an antireflection layer in this order as described below, whereby the antireflection layer-provided optical films 1 to 40 were prepared.

### <<Formation of Antireflection Layer: High Refractive Index Layer>>

On a hard coat layer, the following high refractive index layer coating composition was coated by an extrusion coater; dried at 80° C. for one minute; and then cured by irradiation of 0.1 J/cm² of ultraviolet rays; and further cured with heat at 100° C. for one minute, whereby a high refractive index layer having a thickness of 78 nm was formed.

This high refractive index layer had a refractive index of 1.62.

<High Refractive Index Layer Coating Composition>

| | |
|---|---|
| Isopropyl alcohol solution of metal oxide particles | 55 parts by weight |
| (20% solid, ITO particles, particle size: 5 nm) | |
| Metallic compound; Ti(OBu)₄ (tetra-n- | 1.3 parts by weight |
| butoxytitanium) | |
| Ionizing radiation curable resin: dipentaerithritol | 3.2 parts by weight |
| hexaacrylate | |
| Photo-polymerization initiator: Irgacure 184 (by | 0.8 parts by weight |
| Ciba Specialty Chemicals K.K) | |
| 10% propylene glycol monomethyl ether solution | 1.5 parts by weight |
| containing straight chain dimethyl silicone-EO block | |
| copolymer (FZ-2207, manufactured by Unicar | |
| Co., Ltd.) | |
| Propylene glycol monomethyl ether | 120 parts by weight |
| Isopropyl alcohol | 240 parts by weight |
| Methyl ethyl ketone | 40 parts by weight |

### <<Formation of Antireflection Layer: Low Refractive Index Layer>

on the above prepared high refractive index layer, the following low refractive index layer coating composition was coated by an extrusion coater, dried at 100° C. for one minute; and cured by irradiation of 0.1 J/cm² of ultraviolet rays by the use of an ultraviolet ray lamp so as to form a film. Then, the film was wound on a heat resistant plastic core to a winding length of 4000 m; and subjected to heat-treatment at 80° C. for three days, whereby antireflection layer-provided optical films 1 through 40 were produced.

This low refractive index layer had a thickness of 95 nm and a refractive index of 1.37.

### (Preparation of Low Refractive Index Layer Coating Composition)

<Preparation of Tetraethoxysilane Hydrolysate A>

A hydrolyzate A was prepared in such a way that 289 g of tetraethoxysilane was mixed with 553 g of ethanol 553 g; 157 g of 0.15 aqueous acetic acid solution was added to the mixture; and the resultant mixture was stirred in a water bath of 25° C. for 30 hours.

| | |
|---|---|
| Tetraethoxysilane hydrolysate A | 110 parts by weight |
| Hollow silica particles (P-2) dispersion liquid | 30 parts by weight |
| KBM503 (silane coupling agent, Shinetsu | 4 parts by weight |
| Chemical Co. Ltd.) | |
| 10% propylene glycol monomethyl ether solution | 3 parts by weight |
| containing straight chain dimethyl silicone-EO block | |
| copolymer (FZ-2207, manufactured by Unicar | |
| Co., Ltd.) | |
| Propylene glycol monomethyl ether | 400 parts by weight |
| Isopropyl alcohol | 400 parts by weight |

<Preparation of Hollow Silica Particles (P-2) dispersion Liquid>

A mixture of 100 g of silica sol having an average particle size of 5 nm and SiO₂ concentration of 20% by weight and 1900 g of demineralized water was heated to 80° C. This mother liquid for reaction had a pH value of 10.5. Then 9000 g of aqueous solution containing 0.98% by weight of sodium silicate as SiO₂ and 9000 g of aqueous solution containing 1.02% by weight of sodium aluminate as Al₂O₃ were added simultaneously to this mother liquid. During this time, the temperature of the reaction solution was kept at 80° C. Immediately after addition, the pH value of the reaction solution rose to 12.5, and there was almost no change thereafter. After addition was terminated, the reaction solution was cooled down to the room temperature, and the solution was rinsed by an ultrafiltration membrane. Thus, the nuclear particle dispersion liquid of SiO₂.Al₂O₃ having a solid concentration of 20% by weight was processed (Process (a)).

Then, 1700 g of pure water was added to 500 g of this nuclear particles dispersion liquid 500 g and was heated to 98° C. While this temperature was kept unchanged, silicic acid solution (SiO₂ concentration: 3.5% by weight) was obtained by dealkalization of aqueous sodium silicate solution by the positive ion exchange resin. 3000 g of this silicic acid solution was added to the mixture. Whereby, the dispersion liquid of nuclear particles with the first silica coated layer formed thereon was obtained (Process (b)).

Then 1125 g of pure water was added to 500 g of the nuclear particles dispersion liquid wherein the first silica coated layer having a solid concentration of 13% by weight by rinsing with the ultrafiltration membrane was formed. Further, the concentrated sulfuric acid (35.5%) was added until the pH value reached 1.0, and the process of dealuminization was applied. Then while adding 10 L of aqueous hydrochloric acid solution having a pH value of 3 and 5 L of pure water, the aluminum salts having been dissolved by the ultrafiltration membrane was separated. Whereby the dispersion liquid of SiO₂.Al₂O₃ porous particles was prepared (Process (c)), wherein part of the constituents of the nuclear particles forming the first silica coated layer was removed. A mixture of 1500 g of the porous particles dispersion liquid, 500 g of pure water, 1750 g of ethanol and 626 g of 28% aqueous ammonia solution was heated to 35° C. Then 104 g of ethyl silicate (SiO₂ 28% by weight) was added to this mixture, and the surface of the porous particles having formed the first silica coated layer was covered with an ethyl hydrolyzed polycondensate, thereby forming the second silica coated layer. Thus, the hollow silica particles (P-2) dispersion liquid having a solid concentration of 20% by weight was prepared using the ultrafiltration membrane, wherein the solvent was replaced by ethanol.

The first silica coated layer of this hollow silica particles had a thickness of 3 nm, an average particle size of 47 nm, a MOx/SiO₂ (mole ratio) of 0.0017 and a refractive index of 1.28. In this case, the average particle size was measured by the dynamic light scattering method.

The details of each antireflection film-provided optical film produced in the above ways are indicated in Table 2 and Table 3.

Here, the details of the matter indicated with abbreviations in Table 2 and Table 3 are as follows.

*A: Air nozzle 9 at the outlet side of the elastic member 1

*B: Spray to the back surface of a film by an air nozzle 5

*1: No supply of liquid to a film, no scratch by the elastic member

2: The apparatus shown in FIG. 13 was used.

3: The apparatus shown in FIG. 12 was used.

TABLE 2

| | | Treating condition | | | | | | | | | |
|---|---|---|---|---|---|---|---|---|---|---|---|
| | Treated | Pure | | | Rubbing | | | Elastic 1 | | Presence | |
| | cellulose | water | Adhering | Droplet | time | Surface | | static | | or | |
| | ester | supply | amount | size | period | pressure | | friction | | absence | |
| ** | film No. | method | g/m² | μm | sec. | N/m² | *A | coefficient | *B | of EPC | Remarks |
| 1 (*1) | C-1 | No | — | — | — | — | — | — | — | Presence | Comp. |
| | | supply | | | | | | | | | |
| 2 | C-2 | No | — | — | 0.52 | 2100 | Absence | 1.0 | Presence | Presence | Comp. |
| | | supply | | | | | | | | | |
| 3 (*2) | C-3 | No | — | — | 0.52 | 2100 | Absence | 1.0 | Presence | Presence | Comp. |
| | | supply | | | | | | | | | |
| 4 | C-4 | Spray | 20 | 300 | 0.52 | 2100 | Presence | 0.7 | Presence | Presence | Inv. |
| 5 | C-5 | Spray | 120 | 300 | 0.52 | 2100 | Presence | 0.7 | Presence | Presence | Inv. |
| 6 | C-6 | Spray | 1 | 300 | 0.52 | 2100 | Presence | 0.7 | Presence | Presence | Inv. |
| 7 | C-7 | Spray | 20 | 300 | 0.52 | 2100 | Absence | 0.7 | Presence | Presence | Inv. |
| 8 | C-8 | Spray | 20 | 6000 | 0.52 | 2100 | Presence | 0.7 | Presence | Presence | Inv. |
| 9 | C-9 | Spray | 20 | 5 | 0.52 | 2100 | Presence | 0.7 | Presence | Presence | Inv. |
| 10 | C-10 | Spray | 20 | 300 | 2.30 | 1867 | Presence | 0.7 | Presence | Presence | Inv. |
| 11 | C-11 | Spray | 20 | 300 | 0.035 | 2100 | Presence | 0.7 | Presence | Presence | Inv. |
| 12 | C-12 | Spray | 20 | 300 | 0.52 | 5600 | Presence | 0.7 | Presence | Presence | Inv. |
| 13 | C-13 | Spray | 20 | 300 | 0.52 | 210 | Presence | 0.7 | Presence | Presence | Inv. |
| 14 | C-14 | Spray | 20 | 300 | 0.52 | 2100 | Presence | 1.2 | Presence | Presence | Inv. |
| 15 | C-15 | Spray | 20 | 300 | 0.52 | 2100 | Presence | 0.7 | Absence | Presence | Inv. |
| 16 | C-16 | Spray | 20 | 300 | 0.52 | 2100 | Presence | 0.7 | Presence | Absence | Inv. |
| 17 | C-17 | Spray | 20 | 300 | 0.52 | 2100 | Presence | 0.7 | Presence | Presence | Inv. |
| 18 | C-18 | Spray | 20 | 300 | 0.52 | 2100 | Presence | 0.7 | Presence | Presence | Inv. |
| 19 | C-19 | Spray | 20 | 1000 | 0.52 | 2100 | Presence | 0.7 | Presence | Presence | Inv. |
| 20 | C-20 | Spray | 20 | 3000 | 0.52 | 2100 | Presence | 0.7 | Presence | Presence | Inv. |

**: Antireflection layer provided optical film No.,
Comp.: Comparative example
Inv.: Inventive example

TABLE 3

| | | Treating condition | | | | | | | | | |
|---|---|---|---|---|---|---|---|---|---|---|---|
| | Treated | Pure | | | Rubbing | | | Elastic 1 | | Presence | |
| | cellulose | water | Adhering | Droplet | time | Surface | | static | | or | |
| | ester | supply | amount | size | period | pressure | | friction | | absence | |
| ** | film No. | method | g/m² | μm | sec. | N/m² | *A | coefficient | *B | of EPC | Remarks |
| 21 | C-21 | Spray | 20 | 300 | 0.52 | 2100 | Presence | 0.7 | — | Presence | Inv. |
| 22 | C-22 | Spray | 20 | 300 | 1.00 | 2100 | Presence | 0.7 | Presence | Presence | Inv. |
| 23 | C-23 | Spray | 20 | 300 | 0.14 | 2100 | Presence | 0.7 | Presence | Presence | Inv. |
| 24 | C-24 | Spray | 20 | 300 | 0.52 | 4200 | Presence | 0.7 | Presence | Presence | Inv. |
| 25 | C-25 | Spray | 20 | 300 | 0.52 | 700 | Presence | 0.7 | Presence | Presence | Inv. |
| 26 | C-26 | Spray | 20 | 300 | 0.52 | 2100 | Presence | 0.4 | Presence | Presence | Inv. |
| 27 | C-27 | Spray | 20 | 300 | 0.52 | 2100 | Presence | 0.8 | Presence | Presence | Inv. |
| 28 | C-28 | Spray | 3 | 300 | 0.52 | 2100 | Presence | 0.7 | Presence | Presence | Inv. |
| 29 | C-29 | Spray | 100 | 300 | 0.52 | 2100 | Presence | 0.7 | Presence | Presence | Inv. |
| 30 | C-30 | Spray | 20 | 10 | 0.52 | 2100 | Presence | 0.7 | Presence | Presence | Inv. |
| 31 | C-31 | Spray | 20 | 5000 | 0.52 | 2100 | Presence | 0.7 | Presence | Presence | Inv. |
| 32 | C-32 | Spray | 20 | 300 | 0.05 | 2100 | Presence | 0.7 | Presence | Presence | Inv. |
| 33 | C-33 | Spray | 20 | 300 | 0.52 | 2100 | Presence | 0.7 | Presence | Presence | Inv. |
| 34 | C-34 | Spray | 20 | 300 | 3.00 | 2100 | Presence | 0.7 | Presence | Presence | Inv. |
| 35 | C-35 | Spray | 20 | 300 | 0.52 | 500 | Presence | 0.7 | Presence | Presence | Inv. |
| 36 | C-36 | Dipping | 20 | 20000 | 0.52 | 5000 | Presence | 0.7 | Presence | Absence | Inv. |
| | | (*3) | | | | | | | | | |
| 37 | C-37 | Spray | 20 | 300 | 0.52 | 2100 | Presence | 0.14 | Presence | Presence | Comp. |
| 38 | C-38 | Dipping | 20 | 300 | 0.52 | 2100 | Presence | 0.14 | Presence | Presence | Comp. |
| | | (*3) | | | | | | | | | |
| 39 | C-39 | Spray | 20 | 300 | 0.52 | 2100 | Presence | 1.0 | Presence | Presence | Comp. |
| 40 | C-40 | Dipping | 20 | 300 | 0.52 | 2100 | Presence | 1.0 | Presence | Presence | Comp. |
| | | (*3) | | | | | | | | | |

**: Antireflection layer provided optical film No.,
Comp.: Comparative example
Inv.: Inventive example

<<Evaluation>>

The following evaluations were conducted for the obtained antireflection layer-provided optical films 1 to 40.

### (Evaluation of Longitudinal Streak Failure Resistance of an Antireflection Layer)

The above mentioned antireflection layer-provided optical films were coated ten rolls of 3000 m length. Samples having an area of 1 m² were sampled from 10 places of each roll. The back surface of the antireflection layer of the base of each sample was colored into a solid black by a black spray. Then, the back surface of the antireflection layer was visually checked with green lamps, and the number of longitudinal streaks was evaluated.

10 rolls×1 m²×10 places=100 m²=100 sample evaluation

The longitudinal streak was a straight streak caused in the film conveying direction. Therefore, color appearance of reflected light was differently viewed between the part of the longitudinal streak and other parts.

AA: no longitudinal streak occurrence

A: One longitudinal streak was occurred per 100 samples.

B: Two or more and ten or less of longitudinal streaks were occurred per 100 samples.

C: Eleven or more of longitudinal streaks were occurred per 100 samples.

### (Evaluation of Transverse Streak Failure Resistance of an Antireflection Layer)

Ten rolls of 0.3000 m length antireflection layer-provided optical films were produced for each of optical films 1 to 40. Samples having an area of 1 m² were sampled from 10 places of each roll. The back surface of the antireflection layer of the base of each sample was colored into a solid black by a black spray. Then, the back surface of the antireflection layer was visually checked with three wave fluorescent lamps, and the occurrence of transverse streaks was evaluated.

10 rolls×1 m²×10 places=100 m²=100 sample evaluation

The transverse streak was caused in the film width direction. Therefore, color appearance of reflected light was differently viewed in the shape of stages. The pitch of the stages was about 1 to 5 mm.

AA: No occurrence

A: The transverse streak occurred in one sample per 100 samples.

B: The transverse streak occurred in two samples or more and 10 samples or less per 100 samples.

C: The transverse streak occurred in eleven samples or more per 100 samples.

### (Evaluation of Foreign Matter Failure Resistance)

By the visual inspection for the coating film, the numbers of protrusion-shaped failures and cavity-shaped failures which were observed with a diameter of 100 μm to 150 μm and with a diameter of 150 μm or more were counted per 1 m².

Here, foreign matter failure with a diameter of 100 μm means the failure in which a thickness change ratio of a coating film surface to a reference surface of a coating film is 2 μm (thickness change of a coating film surface)/1050 μm (distance on a reference surface) or more and when the area of a protrusion-shaped portion or a cavity-shaped in which the thickness of a coating film changes to 0.5 μm or more is deemed approximately as a round shape, the diameter of the round shape is 100 μm and the area is visually observed as a foreign matter failure with a size of 100 μm. In the same manner, a failure in which the diameter is 150 μm is deemed as a foreign matter failure with a size of 150 μm. In the actual foreign matter failure inspection, a 150 μm-size foreign matter failure sample and a 100 μm-size foreign matter failure sample were prepared, and then, foreign matter failures having middle sizes between the 150 μm-size foreign matter failure sample and the 100 μm-size foreign matter failure sample were counted as foreign matter failures with a diameter of 100 to 150 μm. Similarly, foreign matter failures having sizes larger than the 150 μm-size foreign matter failure sample were counted as foreign matters with a diameter of 150 μm or more.

Moreover, the appearance of a cross section of protrusion-shaped failures and cavity-shaped failures in the foreign matter failures can be observed with a light interference-type surface roughness meter and so on.

The above-mentioned counted number of foreign matter was evaluated based on the following criterion.

AA: Foreign matters with a size of 100 μm or more were not observed.

A: Foreign matters with a size of 100 μm or more and 150 μm or less were slightly observed.

B: Foreign matters with a size of 100 μm or more and 150 μm or less were observed.

C: Foreign matters with a size of 100 μm or more and 150 μm or less were observed and further foreign matters with a size of 150 μm or more were observed.

### (Evaluation of Wrinkle Resistance)

Ten rolls of antireflection layer-provided optical films were visually observed and occurrence or no occurrence of wrinkle was evaluated based on the following criterion.

AA: Wrinkles did not occur on all of the ten rolls.

A: The occurrence of wrinkles was observed slightly on one roll or more and three rolls or less.

B: The occurrence of wrinkles was observed clearly on one roll or more and three rolls or less.

C: The occurrence of wrinkles was observed clearly on four rolls or more.

### (Evaluation of Scratch Resistance)

The above mentioned antireflection layer-provided optical films were coated ten rolls of 3000 m length. Samples having an area of 1 m² were sampled from 10 places of each roll. The back surface of the antireflection layer of the base of each sample was colored into a solid black by a black spray. Then, the back surface of the antireflection layer was visually checked with three wave fluorescent lamps, and the number of scratches was evaluated.

10 rolls×1 m²×10 places=100 m²=100 sample evaluation

AA: Scratches did not occur.

A: Scratches of one or more and three or less occurred per 10 samples.

B: Scratches of four or more and ten or less occurred per 10 samples.

C: Scratches of eleven or more occurred per 10 samples.

The above evaluation results are shown in Table 4.

TABLE 4

| Anti- | | | | | | |
|---|---|---|---|---|---|---|
| reflection | | Longitudinal | Transverse | Foreign | | |
| layer provided | | streak | streak | material | | |
| optical film | Wrinkle | failure | failure | failure | Scratch | |
| No. | resistance | resistance | resistance | resistance | resistance | Remarks |
| 1 | C | C | C | C | AA | Comp. |
| 2 | C | C | C | A | A | Comp. |
| 3 | C | C | C | A | C | Comp. |
| 4 | AA | AA | AA | AA | AA | Inv. |
| 5 | A | A | A | A | A | Inv. |
| 6 | A | A | A | AA | B | Inv. |
| 7 | AA | A | A | A | A | Inv. |
| 8 | A | A | A | A | A | Inv. |
| 9 | A | A | A | AA | B | Inv. |
| 10 | AA | AA | AA | AA | A | Inv. |
| 11 | AA | AA | AA | A | AA | Inv. |
| 12 | AA | AA | AA | AA | B | Inv. |
| 13 | A | A | A | A | AA | Inv. |
| 14 | AA | AA | AA | AA | B | Inv. |
| 15 | B | A | A | B | AA | Inv. |
| 16 | A | A | A | A | A | Inv. |
| 17 | AA | AA | AA | A | AA | Inv. |
| 18 | A | AA | AA | A | AA | Inv. |
| 19 | A | AA | AA | A | AA | Inv. |
| 20 | A | AA | AA | A | AA | Inv. |
| 21 | AA | AA | AA | A | AA | Inv. |
| 22 | AA | AA | AA | AA | A | Inv. |
| 23 | A | A | AA | A | AA | Inv. |
| 24 | AA | AA | AA | AA | A | Inv. |
| 25 | A | AA | AA | A | AA | Inv. |
| 26 | AA | AA | AA | AA | AA | Inv. |
| 27 | AA | AA | AA | AA | AA | Inv. |
| 28 | A | AA | AA | AA | A | Inv. |
| 29 | A | AA | AA | A | AA | Inv. |
| 30 | AA | AA | AA | A | AA | Inv. |
| 31 | A | AA | AA | A | AA | Inv. |
| 32 | AA | AA | AA | A | AA | Inv. |
| 33 | AA | AA | AA | AA | A | Inv. |
| 34 | A | AA | AA | A | AA | Inv. |
| 35 | AA | AA | AA | AA | A | Inv. |
| 36 | A | A | A | A | A | Inv. |
| 37 | C | A | C | B | A | Comp. |
| 38 | C | B | C | C | A | Comp. |
| 39 | C | A | C | A | B | Comp. |
| 40 | C | B | C | B | B | Comp. |

Comp.: Comparative example,
Inv.: Inventive example

As being clear from the results shown in Table 4, in antireflection layer-provided optical films 4 to 36 employing Cellulose ester films C-4 to C-36 treated in accordance with the present invention, it turned out that longitudinal streak failure resistance, transverse streak failure resistance, foreign matter failure resistance, wrinkle resistance, and scratch resistance were improved in comparison with comparative examples. Moreover, by the setting of the desirable processing methods indicated in claims 2 to 15, the above-mentioned improving effects became still higher.

On the other hand, in antireflection layer-provided optical films 1 to 3 employing Cellulose ester films C-1 to C-3 being Comparative examples in which water for wetting the surface was not supplied, longitudinal streak failure, transverse streak failure, foreign matter failure, wrinkles, and scratches occurred, and these films were not able to be used as an optical film. Moreover, in antireflection layer-provided optical films 37 to 40 employing Cellulose ester films C-37 to C-40 being Comparative examples in which, although water for wetting the surface was supplied, the elastic members having the static friction coefficient being outside of the range of the present invention were used, although improvements were observed in longitudinal streak failure resistance and scratch resistance by the supply of water, transverse streak failure and wrinkles occurred, and these films were not able to be used as an optical film.

### Example 2

Antireflection films were produced with the same manner as in the production of the antireflection film-provided optical film No. 2 and No. 6 in Example 1 except that in place of 10% propylene glycol monomethyl ether solution of straight chain dimethyl silicone-EO block copolymer (FZ-2207, Manufactured by Nippon Unicar Company Limited), 10% propylene glycol monomethyl ether solution of BYK330, BYK337, BYK346, BYK375 Manufactured by Bickchemi Company Limited was used in an amount of 1 parts by weight for the hard coat layer coating solution, in an amount of 1.5 parts by weight for the high refractive index layer coating solution and in an amount of 3 parts by weight for the low refractive index layer coating solution. The antireflection films were evaluated in terms of longitudinal streak failure resistance, transverse streak failure resistance, and wrinkle resistance. In the results, the evaluations were ranked at “AA” of the above evaluations. Therefore, it turned out that the coating ability was improved more.

### Example 3

The polarizing plate and the liquid crystal display were produced by the use of the antireflection layer-provided optical films 1 to 40 produced in the Example 1.

### <<Preparation of Polarizing Plates>

A 120 μm-thick polyvinyl alcohol film was stretched uniaxially (at a temperature of 110° C. and a drawing magnification of ×5). This film was immersed in an aqueous solution of 0.075 g of iodine, 5 g of potassium iodide, and 100 g of water for 60 seconds and then in an aqueous solution of 6 g of potassium iodide, 7.5 g of boric acid, and 100 g of water at 68° C., rinsing and drying the film, whereby a polarizing film was prepared.

Next, in accordance with the following processes 1 through 5, the polarizing film, the antireflection layer-provided optical films 1 to 36 produced in Example 1 and cellulose film as a back surface side protective film of the polarizing plate were pasted, whereby polarizing plates were prepared. As the back surface side protective film of the polarizing plate, a cellulose ester film having retardation (Konica Minolta TAC KC8UCR-5: manufactured by Konica Minolta Opt. Inc.) was used to make polarizing plates.

Process 1: The antireflection layer-provided optical films were immersed in an aqueous solution containing 2 mol/L of sodium hydroxide at 60° C. for 90 seconds, rinsing and dying the film, and then saponifying the surface to be bonded to the polarizing film, whereby the saponified-antireflection layer-provided optical films were prepared.

Process 2: The aforementioned polarizing film was immersed in a polyvinyl alcohol adhesive tank containing 2% by weight of solids for 1 to 2 seconds.

Process 3: The excessive adhesive attached to the polarizing film in the process 2 was gently wiped, and the polarizing film was put and laminated on the antireflection layer-provided optical film having been treated in the process 1.

Process 4: The antireflection layer-provided optical film, the polarizing film and the cellulose film at the back side which were laminated in the process 3, were pasted at a pressure of 20 through 30 N/cm², and a conveying speed of about 2 m/min.

Process 5: The samples in which the antireflection layer-provided optical film, the polarizing film and the cellulose film at the back side were pasted in the process 4 were dried for 2 minutes in a dryer of 80° C., whereby polarizing plates were prepared. Namely, by the use of the antireflection layer-provided optical films 1 to 40, the polarizing plates 1 to 40 were produced.

<Preparation of Liquid Crystal Display Apparatus>>

The liquid crystal panel to conduct view angle measurement was prepared in accordance to the following procedure and the characteristics as a liquid crystal display apparatus were evaluated.

The pre-bonded polarizing plate was separated from both surfaces of the Fujitu-made 15 type display VL-150SD, and the above prepared polarizing plates 1 through 36 were bonded onto the glass surfaces of the liquid crystal cells, respectively.

In this case, the polarizing plates were bonded in such a way that the surfaces of the aforementioned polarizing plates were oriented to the liquid crystal cell side, and absorption axis was located in the same direction of the pre-bonded polarizing plate, whereby liquid crystal display apparatuses 1 through 36 were produced.

The liquid crystal display apparatuses 1 through 36 prepared in the above ways were evaluated as follows.

### (Evaluation)

### (Evaluation of Visibility)

Each of the liquid crystal display apparatuses, prepared as above, was allowed to stand at 60° C. and 90% RH for 100 hours. Thereafter, the ambience was returned to 23° C. and 559 RH. When the surfaces of the display devices were observed, it was noted that those employing the antireflection layer-provided optical films 4 to 36 with respective antireflection films of the present invention exhibited excellent flatness, while comparative display devices exhibited wavy unevenness, whereby eyes tended to get tired when viewed over a long period of time.

A: no wavy unevenness was noted on the surface
B: slight wavy unevenness was noted on the surface
C: fine wavy unevenness was noted somewhat on the surface
D: fine wavy unevenness was clearly noted on the surface

1-26. (canceled)

27. An optical film treating method, comprising the steps of:
wetting a surface of a lengthy film with liquid while continuously conveying the lengthy film;
rubbing the wetted surface of the lengthy film with an elastic member; and
removing the liquid adhering on the surface of the lengthy film,
wherein the static friction coefficient of the surface of the elastic member is 0.2 to 0.9.

28. The optical film treating method described in claim 27, wherein the elastic member is a surface modified rubber.

29. The optical film treating method described in claim 28, wherein the surface modified rubber is a rubber whose surface is subjected to an organic halogen compound treatment.

30. The optical film treating method described in claim 27, wherein the elastic member is a rotatable rubber roller.

31. The optical film treating method described in claim 30, wherein the contact angle of the rubber roller with the lengthy film is 10 or more and less than 135°.

32. The optical film treating method described in claim 27, wherein the time period of the lengthy film rubbed with the elastic member is 0.05 seconds to 3 seconds.

33. The optical film treating method described in claim 27, wherein the surface pressure of the lengthy film rubbed with the elastic member is 500 N/m² to 5000 N/m².

34. The optical film treating method described in claim 27, further comprising a step of removing liquid adhering to the surface of the elastic member.

35. The optical film treating method described in claim 27, further comprising a step of detecting widthwise end positions of the lengthy film and adjusting a conveyance position.

36. The optical film treating method described in claim 27, wherein when the lengthy film is rubbed with the elastic member, the lengthy film is rubbed with the elastic member while air is being sent to the back of the lengthy film.

37. The optical film treating method described in claim 27, wherein the liquid is supplied to the surface of the lengthy film by a supplying section so as to wet the surface of the lengthy film.

38. The optical film treating method described in claim 37, wherein the supplying section is a spray nozzle.

39. The optical film treating method described in claim 38, wherein when the liquid supplied from the spray nozzle adheres to the lengthy film, the average diameter of droplets of the liquid is 10 μm to 5000 μm.

40. The optical film treating method described in claim 37, wherein the amount of the liquid supplied to the lengthy film is 3 g/m² to 100 g/m².

41. The optical film treating method described in claim 37, wherein the temperature of the liquid is 30° C. to 100° C. and the temperature of the elastic member is 30° C. to 100° C.

42. The optical film treating method described in claim 37, wherein the lengthy film is a cellulose ester film and the liquid is water.

43. An optical film producing method, comprising the steps of:
treating a surface of the lengthy film with the optical film treating method described in claim 27, and thereafter
providing an optical functional layer on the treated surface of the lengthy film.

44. The optical film producing method described in claim 43, wherein the optical functional layer is at least one of a hard coat layer and an antireflection layer.

45. The optical film producing method described in claim 44, wherein the hard coat layer is formed by a process of coating a hard coat layer coating solution containing an acrylate type ultraviolet ray curable resin and an organic solvent on the lengthy film, and at least one layer of the antireflection layer is formed by a process of coating an antireflection layer coating solution containing a low surface tension substance and an organic solvent on the lengthy film.

46. An optical film treating apparatus for treating a surface of a lengthy film being conveyed continuously, comprising:
a film wetting section for wetting the surface of the lengthy film with liquid;
a rubbing section for rubbing the lengthy film with an elastic member, wherein the static friction coefficients of the surface of the elastic member is 0.2 to 0.9;
a first liquid removing section for removing liquid from the surface of the elastic member; and
a second liquid removing section for removing liquid on the surface of the lengthy film after the rubbing section rubs the lengthy film.

47. The optical film treating apparatus described in claim 46, further comprising a position adjusting section for detecting widthwise end positions of the lengthy film and adjusting the position of the lengthy film being conveyed.

48. The optical film treating apparatus described in claim 46, further comprising a liquid temperature control section for controlling the temperature of the liquid to be 30° C. to 100° C.

49. The optical film treating apparatus described in claim 46, further comprising an air sending section for sending air to the back of the lengthy film.

50. The optical film treating apparatus described in claim 46, wherein the film wetting section is a liquid supplying section for supplying liquid onto the surface of lengthy film.

51. The optical film treating apparatus described in claim 46, wherein the second liquid removing section comprises a suction nozzle and an air nozzle.

52. The optical film treating apparatus described in claim 46, wherein a treating time period from the film wetting section and the second liquid removing section is 2 seconds to 60 seconds.
